(19) United States
(12) Patent Application Publication
(10) Pub. No.: US 2013/0270838 A1
(43) Pub. Date: Oct. 17, 2013

(54) APPARATUS AND METHOD FOR GENERATING ELECTRICITY

(71) Applicant: Edgar Enrique DIAZ RAMIREZ, La Pomona (VE)

(72) Inventor: Edgar Enrique DIAZ RAMIREZ, La Pomona (VE)

(21) Appl. No.: 13/444,362

(22) Filed: Apr. 11, 2012

(51) Int. Cl. H02K 7/18

(52) U.S. Cl. 290/1 R

(57) ABSTRACT

An apparatus for generating electricity has basically three main parts: a supply system, a power generating system, and a feedback system. The supply system comprises a container into which solid material is stored, and to which a downpipe duct is attached. At the end of this duct a guillotine valve is provided. The power generating system comprises a rotor rotatably mounted to a shaft supported by a casing. To the outer surface of said rotor a set of rotor buckets are assembled to receive the material from the supply system. Said shaft is coupled to the shaft of a generator responsible for generating electricity. The feedback system comprises a chain conveyor assembly including sprockets to which a chain is mounted, and to said chain a set of elongated buckets are installed. These buckets receive the material from the power generating system and lift it back to the storage container.

### BACKGROUND OF THE INVENTION

1. Field of the Invention

The present invention relates generally to a mechanical device with which it is possible to generate electricity through an ecological and high-efficiency device comprising simple and easy-to-maintain parts with low production and reliable mechanisms. The invention is, however, more particularly directed to an apparatus for generating electricity using an economical and environmentally-friendly source and gravity.

2. Description of the Prior Art

Pollution, is a well-known worldwide problem. Specifically on the electricity-production arena, different fuels are used to generate electricity, but all of them have some impact on the environment. Fossil fuel power plants release air pollution, require large amounts of cooling water, and can mar large tracts of land during the mining process. Nuclear power plants are generating and accumulating copious quantities of radioactive waste that currently lack any repository. Even renewable-energy facilities can affect wildlife (fish and birds), involve hazardous wastes, or require cooling water.

The generation of electric power produces more pollution than any other single industry in the United States. The energy sources most commonly used for electricity production—fossil fuels such as coal, oil and natural gas—are known as non-renewable resources. They take millions of years to be formed in the crust of the earth by natural processes. Once burned to produce electricity, they are gone forever. Burning fossil fuels such as coal or oil creates unwelcome by-products that pollute when released into our environment, changing the planet's climate and harming ecosystems.

The traditional use of renewable energies such as wind, water, and solar power are widespread in developed and developing countries, but the mass production of electricity using renewable energy sources has become more commonplace only recently. Many countries and organizations promote renewable energies through taxes and subsidies.

Hydroelectric power plants use water flowing directly through turbines to power generators. Currently, rotating turbines attached to electric generators produce commercially available electricity.

It is known to use flowing water, the wind, solar energy and other forms of power for generating electricity. In various systems, these forms of power may be combined. Generally, saving energy and the earth's resources is encouraged. Therefore, there is a need for systems which take advantage of available energy in new, environmentally friendly ways to make electricity available to users.

Between the by-products of electricity production, nitrous oxide emissions and elevated ozone levels can be mentioned. Nitrous oxide emissions contribute to ground-level ozone, particulate matter pollution, haze pollution in national parks and wilderness areas, brown clouds in major western cities, acid deposition in sensitive ecosystems across the country, and the eutrophication of coastal waters. Elevated ozone levels persisting throughout the country have also led to the adverse health effects of smog and millions of dollars in agricultural damage. A compelling body of scientific evidence links fine particle concentrations with illness and thousands of premature, deaths each year. Children and the elderly are particularly at risk.

Like coal, nuclear power causes some of the most serious environmental impacts, albeit indirectly. While nuclear power plants do not release toxic chemicals like traditional power generation plants, nuclear fuel systems create hazards that may threaten people and the environment now and for generations to come, as well as pose risks of catastrophic accident. Mining, processing and transporting nuclear fuel produce significant pollution, including air pollution. After decades of nuclear power plant operation, our nation has not yet decided how to solve the problem of safely storing hazardous nuclear wastes for centuries to come.

In the prior art, there are many devices for producing electricity without using polluting fuels. For example, US patent application Serial No. 20100253080 describes an apparatus for generating electricity. The apparatus comprises a first reservoir having a fluid, a second reservoir located below the first reservoir and receiving fluid from the first reservoir, a turbine connected to the first reservoir by a first tube, a second tube connecting the turbine to the second reservoir, a third tube connecting the first reservoir to the second reservoir, and a power source located adjacent to the second reservoir. The power source pumps fluid from the second reservoir to the first reservoir, and the fluid travels through the first tube into the turbine, thereby generating electricity.

U.S. Pat. No. 7,944,072 describes a method and a device that are capable of collecting water at a high point of a high-rise building. The water can be stored until used. The water is allowed to run down by gravity past a hydroelectric generator to generate electricity for the occupants of the building, or for some other use. The water after use is discarded to the public drain.

U.S. Pat. No. 5,221,868 describes an electrically assisted gravity powered motor, that has a plurality of hexagonal arms with two opposing shorter sides describing a circle as the arms are rotated by an interrupted axle running between arms but leaving room inside the hexagon for weights on tracks between the two opposing sides to be moved by a fixed motor at one end of each track so as to go along the track through an axis in an unrestricted manner from one end to the other end and back while the arm is electrically rotated continuously in a 360° circle to generate mechanical energy that may be used to run a vane pump or the like or to generate more electricity.

U.S. Pat. No. 5,905,312 describes a system generating electricity by gravity. This system includes a plurality of tanks mounted on a circulating device. When the tanks receive the working medium descending from a higher place by gravity, the circulating device is driven to circulate along a guiding device so as to drive a working shaft of a generator for generating electricity. A transmission mechanism is added between the circulating device and the working shaft to increase the rotational speed of the working shaft.

U.S. Pat. No. 4,718,232 describes an apparatus that generates electrical power from a combination of gravity forces and the inherent buoyancy of a hollow body immersed in a fluid. The apparatus includes a long chain having a plurality of hollow buoyant elements attached thereto. The chain extends around a pair of sprockets and the buoyant elements are immersed in a fluid along the portion of the chain moving against gravity and the buoyant elements pass through an airspace along the portion of the chain moving with gravity. The combination of buoyancy and gravitational forces cause movement of the chain to thereby rotate the sprocket gears which are used to drive an electrical power generator. Also disclosed is a housing including a hatch assembly for the apparatus and a valve unit and an insulator for use with the apparatus.

All the above cited devices comprise systems and methods for generating electricity without using fuels. Some of them also use gravity as a main factor for putting the parts in motion and generating electricity. However the common problem of these devices is efficiency. Even though these patent documents do not include efficiency analysis, from the analysis of the parts involved, it is obvious for those experts in the art that the average efficiency of these devices is very low, which makes the whole solution not viable.

Besides the above mentioned solutions, there are several known systems for producing electricity, including but not limited to:

Wind Power: is the conversion of wind energy into a useful form of energy, such as using wind turbines to make electricity, windmills for mechanical power, wind-pumps for water pumping or drainage, or sails to propel ships. It is a very well-known and clean system in which the energy of the wind is used to rotate a generator. It is highly dependent on the atmospheric conditions and the cost of each generator is extremely expensive.

Tidal Power: is a form of hydropower that converts the energy of tides into useful forms of power, mainly electricity. The power is taken from the changing tides. Tidal power plants may have different forms and features. One of the most common one comprises tidal turbines that rotate with the high and low tides. It stores sea water which increases or decreases with the high or low tides respectively. This change in water elevation causes the turbines to rotate. Tides are more predictable than wind energy and solar power. Among sources of renewable energy, tidal power has traditionally suffered from relatively high cost and limited availability of sites with sufficiently high tidal ranges or flow velocities, thus constricting its total availability. It also depends on the lunar phase and geographic location.

Solar Power: is the conversion of sunlight into electricity, either directly using photovoltaics (PV) for converting light into electric current using the photoelectric effect, or indirectly, using concentrating solar power (CSP) that uses lenses or mirrors and tracking systems to focus a large area of sunlight into a small beam. There are several types of applications: solar panels, geothermal energy, hydroelectric energy, internal combustion engine, and thermoelectric fusion of fossil fuels and nuclear plant among others.

Solar panels use the solar rays to produce a chemical reaction in the solar cells. This chemical reaction is what produces the heat which is channeled in a glass tube and used to heat water and vapor. This vapor makes a turbine and thus the generator to rotate. Geothermal energy is a type of energy produced during ground perforation at depths of approximately 3000 meters which is proximate to the magma layer. The heat generated at these depths is used to heat water and produce vapor which in turn is used to rotate a turbine which also rotates a generator. This type of systems must be strategically situated where the magma layer can be reached and where there is body of water nearby to continuously pump water into the well in order to produce the vapor. There is a constant risk if the magma layer cools down and there is not enough heat to produce vapor.

Hydroelectric energy is a system based on the free fall of water from a river. To achieve this a large dam is built on a large river that has a large drop in elevation. The dam stores lots of water behind it in the reservoir. Near the bottom of the dam wall there is the water intake. Gravity causes it to fall through the penstock inside the dam. At the end of the penstock there is a turbine propeller, which is turned by the moving water. The shaft from the turbine goes up into the generator, which produces the power. The construction of a dam itself would lead to major deforestation of the surrounding area, and what is worse, the alteration of the natural flow of rivers that impacts the balance of the ecosystem altering our environment. Although this system uses a clean energy source, it produces methan gas from the decomposition of the vegetation found at the bottom of the river. This happens every time the water levels drop and surge back again.

Even though the above cited systems and devices for generating electricity of the prior art address some of the needs of the market, a new, improved, economical and environmentally-friendly electricity generating system is still desired.

### SUMMARY OF THE INVENTION

This invention is directed to an apparatus for generating electricity without generating pollution, without using non-renewable resources (like fossil fuels that produce toxic gases including but not limited to carbon dioxide, carbon monoxide, methane, sulfuric gas, nitrogen oxide and other residues like solid residues).

in one general aspect of the present invention, it is an apparatus for generating electricity that does not use atomic or nuclear energy in any form, avoiding any possible ecological disasters.

Accordingly, it is a primary object of the present invention to provide an apparatus for generating electricity

Another aspect of the present invention provides an apparatus for generating electricity that does not require the force of enormous mass of water (hydroelectric) altering the free flow of rivers and unbalancing the fragile ecosystems.

Yet another aspect of the purposed invention comprises an apparatus for generating electricity that does not depend on the constant winds or tides, or on solar power which is highly dependent on the geographic location and weather conditions.

Also another aspect of this invention comprises ah apparatus for generating electricity that generates electricity using solid, naturally abundant, easy to exploit and recyclable materials.

Also another aspect of this invention comprises an apparatus for generating electricity that is cost-effective and can improve the quality of life of the user.

Also another aspect of this invention comprises an apparatus for generating electricity than can be deployed on-site in each community without the dependency of a centralized electric distribution system.

The advantages of the invention may be summarized as:
There are no geographical limitations for its installation.
Because of its compact design, large spaces are not required.
The source of energy (the spheres) last a long time and later can be reconditioned.
The maintenance costs are kept at a minimum.
The manufacturing and assembly of the proposed apparatus is easy and economical.
The material used is recyclable, and may include steel or Teflon® spheres.
It does not require any source of water for its operation, since it does not need any cooling system.
It does not generate any type of pollution.
The dependency on central electric distribution systems is reduced. It can be deployed next to a household, a neighborhood.
It is easy to tend and expand.
It generates electricity at an affordable cost.
Its application would eliminate the electric line distribution systems between cities, states, etc.
It can easily be added to additional lines of electric production.
Its design allows for great flexibility to accommodate customers' needs.

In summary, the present invention is related to an apparatus for generating electricity, comprising three interrelated systems: a supply system, a power generating system, and a feedback system; the supply system comprises a silo arranged at a high elevated position into which a solid particulate material is stored, the power generating system comprises a rotor located at ground level; a downpipe duct puts in fluid communication the interior of said silo with the interior of said power generating system to the outer surface of said rotor a set of buckets are affixed; to said rotor a generator responsible of generating the electricity of the system is coupled; the feedback system comprises a chain conveyor assembly in fluid communication with the power generating system.

More specifically, the invention comprises basically three main parts: a supply system, a power generating system, and a feedback system. The supply system comprises a silo into which a solid material is stored, and to which a downpipe duct is attached. At the end of this duct a guillotine valve is provided. The power generating system comprises a rotor rotatably mounted to a shaft supported by a casing. To the outer surface of said rotor a set of rotor buckets are assembled to receive the material coming from the supply system. Said shaft is mechanically coupled to the shaft of a generator responsible for generating the electricity of the system. Filially the feedback system comprises a chain conveyor assembly including, sprockets to which a chain is mounted, and to said chain a set of elongated buckets are installed. These buckets receive the material from the power generating system and lift it back to the storage silo of the supply system.

Also the present invention comprises a method for generating electricity, comprising the steps of:
a) a mass “M” of solid particulate material that is placed into a silo at an elevated place separated at a distance “H” from ground level [so that the potential energy of this material equals M*H*g (gravity)];
b) a free fall of this particulate material until it tangentially impacts the radial buckets of a rotor installed at ground level [so as to transform the potential energy into kinetic energy equal to ½*M V² (V being the final velocity of the particulate material when it impacts the buckets];
c) the kinetic energy of said impact makes the rotor rotate and drives a generator coupled thereto;
d) the particulate material is collected and returned to the silo by a feedback system.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a general side-elevational view of the apparatus for generating electricity in accordance with the present invention.

FIG. 2 is a side elevational view of the silo used to store the material use to move the mechanisms of the present apparatus, as will be explained in detail below.

FIG. 3 is a bottom plan view of the silo of FIG. 2.

FIG. 4 is another side elevational view of the silo.

FIG. 5 is another bottom-plan view of the silo of FIG. 2.

FIG. 6 is a general perspective view of the silo's cylinder.

FIG. 7 is a side elevational view of the cylinder of FIG. 6.

FIG. 8 is a bottom plan view of the cylinder of FIG. 6.

FIG. 9 is a general perspective view of the silo's cone.

FIG. 10 is a side elevational view of the cone of FIG. 9.

FIG. 11 is a bottom plan view of the cone of FIG. 9.

FIG. 12 is a general perspective view of the guillotine valve outlet of the silo of FIG. 2.

FIG. 13 is a side elevational view of the guillotine valve outlet of FIG. 12.

FIG. 14 is a top plan view of the guillotine valve outlet of FIG. 12.

FIG. 15 is a frontal view of the shaft of the rotors used in the apparatus of FIG. 1.

FIG. 16 is an end elevational view of the shaft of FIG. 15 showing in detail the sprocket.

FIG. 17 is another frontal-view of the shaft of the rotors used in the apparatus of FIG. 1.

FIG. 18 is an end elevational view of the shaft of FIG. 17 showing in detail the sprocket.

FIG. 19 is a general perspective view of the rotor assembly of the apparatus of FIG. 1.

FIG. 20 is a front elevational view of the rotor of FIG. 19.

FIG. 21 is a front elevational view of the core of the rotor of FIG. 19.

FIGS. 22 to 24 are respective side, front and top plan view of rotor's bucket of the rotor assembly of the apparatus of FIG. 1.

FIG. 25 is a general perspective view of the chain assembly and the buckets system attached thereto.

FIG. 26 is a front elevational view of the sprocket used in the assembly of FIG. 25.

FIG. 27 is a side elevational-view of the sprocket of FIG. 25.

FIG. 28 is a front elevational view of the buckets used in the assembly of FIG. 25.

FIG. 29 is an end elevational view of the bucket of FIG. 28.

FIG. 30 is a general perspective view of the sprocket-casing of the apparatus of FIG. 1.

FIG. 31 is a front elevational view of the casing of FIG. 30.

FIG. 32 is a side elevational view of the casing of FIG. 30.

FIG. 33 is a bottom plan view of the casing of FIG. 30.

FIG. 34 is a top plan view of the casing of FIG. 30.

FIG. 35 is a general perspective view of the upper sprocket to cover lift system.

FIG. 36 is a side elevational view of the upper sprocket top cover lift system of FIG. 35.

FIG. 37 is a bottom plan view of the upper sprocket top cover lift system of FIG. 35; and:

FIG. 38 is a side elevational view of the upper sprocket top cover lift system of FIG. 35.

FIG. 39 is a general perspective view of the rotor showing a diagram of the rotor forces.

FIG. 40 shows a geometrical mesh of the rotor assembly.

FIG. 41 shows the rotor's Von Mises stress analysis.

FIG. 42 shows the rotor's total displacement analysis.

FIG. 43 shows the rotor's safety factor analysis.

FIG. 44 is a general perspective view showing the rotor's bucket force.

FIG. 45 shows the rotor's bucket geometrical mesh

FIG. 46 is a rotor's bucket Von Mises stress analysis.

FIG. 47 shows the rotor's bucket total displacement analysis.

FIG. 48 shows the rotor's bucket safely factor analysis.

FIG. 49 if a graph of shear forces at the rotor's shaft.

FIG. 50 is another graph showing the bending moment at the rotor shaft.

FIG. 51 is another graph showing the deflection angle of the rotor shaft.

FIG. 52 is another graph showing the deflection at the rotor shaft.

FIG. 53 is another graph showing the bending stress in the rotor shaft.

FIG. 54 is another graph showing the shear stress in the rotor shaft.

FIG. 55 is a general perspective view showing the forces applied to rotor's shaft.

FIG. 56 shows the rotor's shaft Von Mises stress analysis.

FIG. 57 shows the total deformation analysis.

FIG. 58 shows the rotor's shaft safely factor analysis.

FIG. 59 is a general perspective view of the cylindrical roller bearings used for the rotor's shaft.

FIG. 60 is a general perspective view showing the diagram of forces in the chain conveyor system.

FIG. 61 shows the analysis of Von Mises stress of the chain conveyor system.

FIG. 62 shows the total strain analysis of the chain conveyor system.

FIG. 63 shows the chain conveyor system safely factor analysis.

FIG. 64 shows a front and side elevational views of the chain used in the feedback system of the invention.

FIG. 65 shows respective detailed front and lateral views of the teeth of the sprocket and a front elevational view of the sprocket itself used in the feedback system of the present invention.

FIG. 66 shows the chain power rating.

FIG. 67 is a graph showing the shear forces at the shaft of the chain conveyor system.

FIG. 68 shows the graph of the bending moment at the shaft of the chain conveyor system.

FIG. 69 is another graph showing the deflection angle of the shaft of the chain conveyor system.

FIG. 70 is another graph showing, the deflection in the shaft of the chain conveyor system.

FIG. 71 is another graph showing the bending stress in the shaft of the chain conveyer system.

FIG. 72 is another graph showing the shear stress analysis along the shaft of the chain conveyor system; and finally:

FIG. 73 is another graph showing the torsional stress in the shaft of the chain conveyor system.

### DETAILED DESCRIPTION OF REPRESENTATIVE EMBODIMENTS

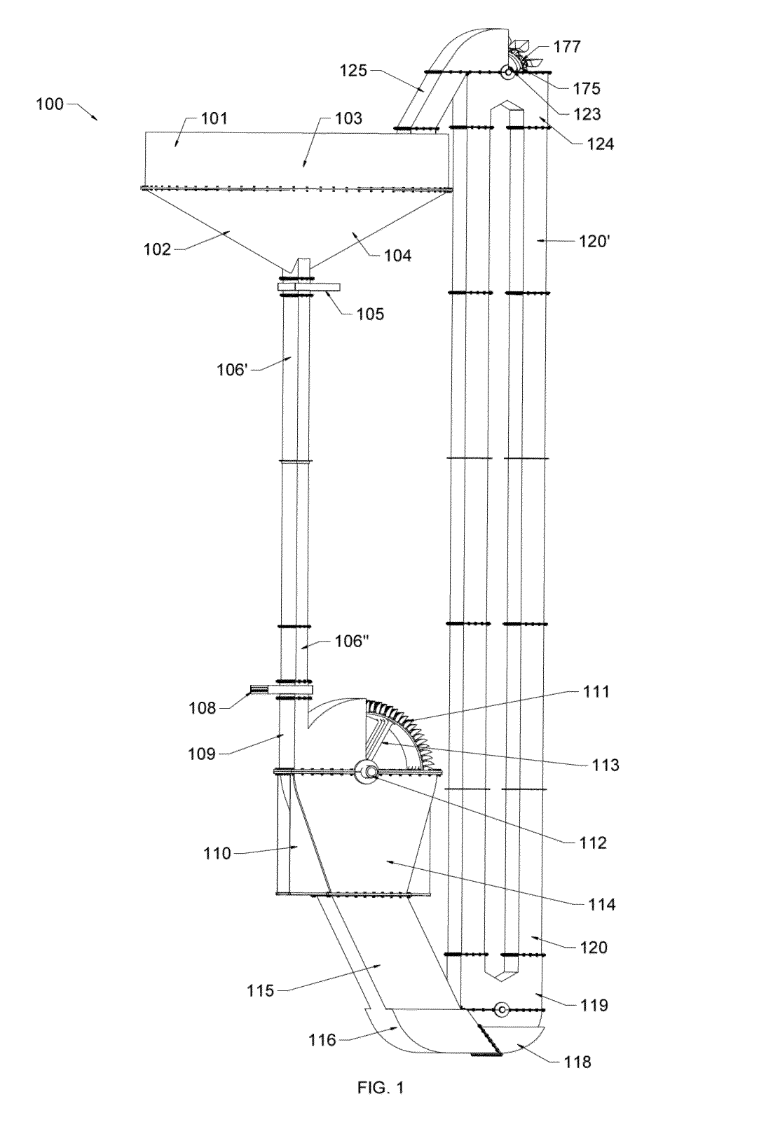

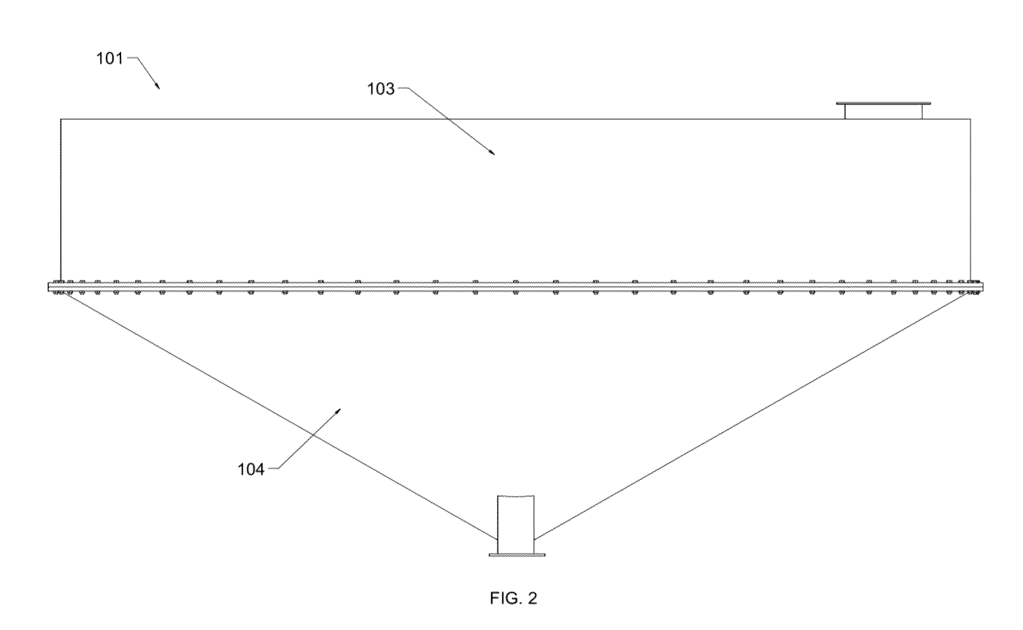

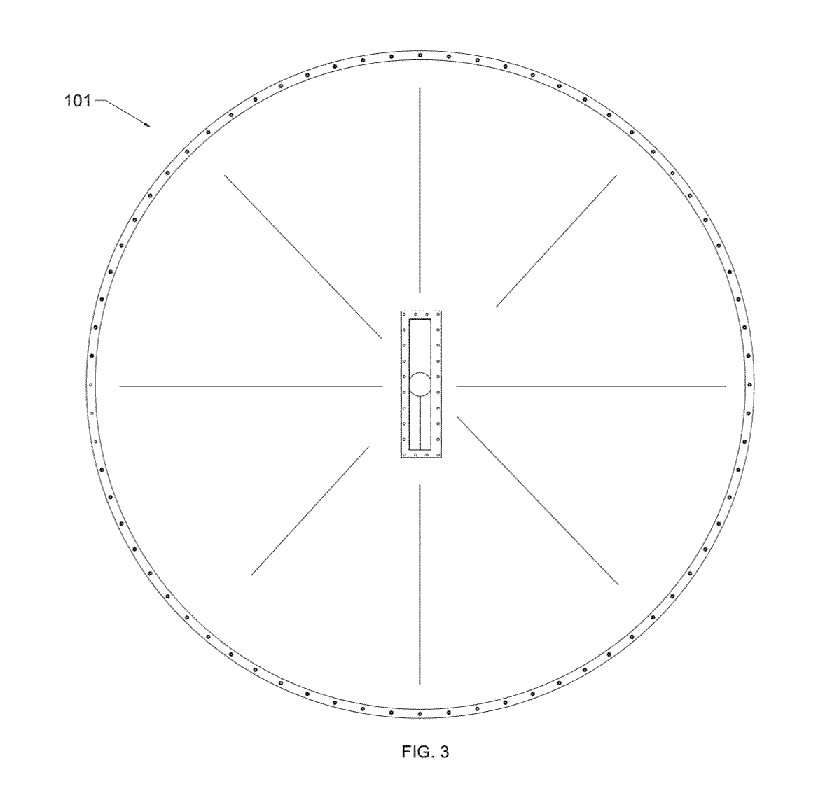

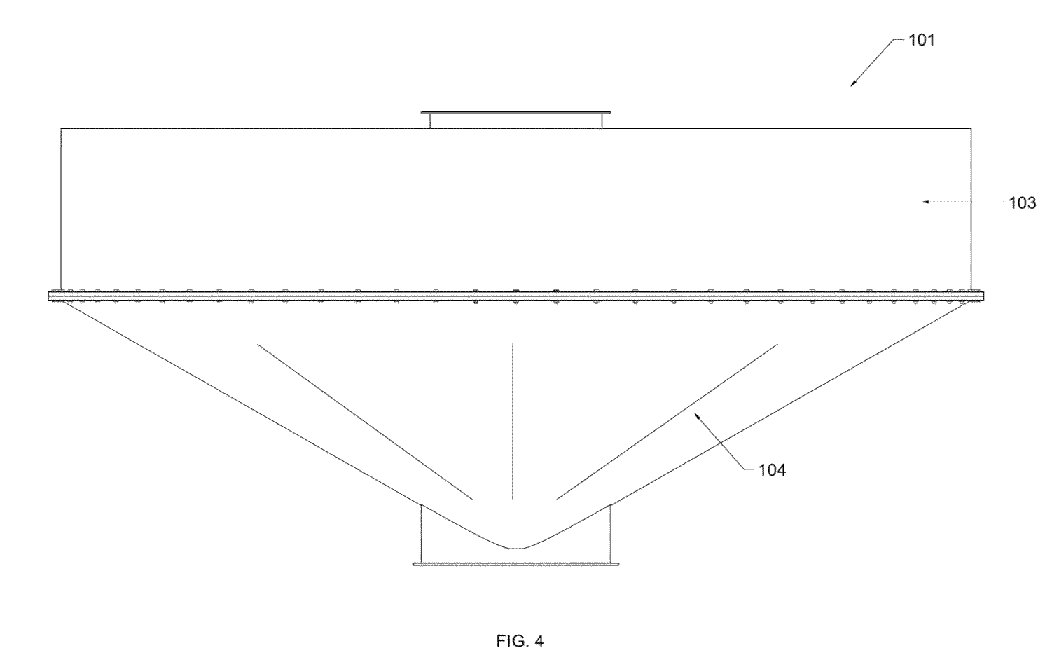

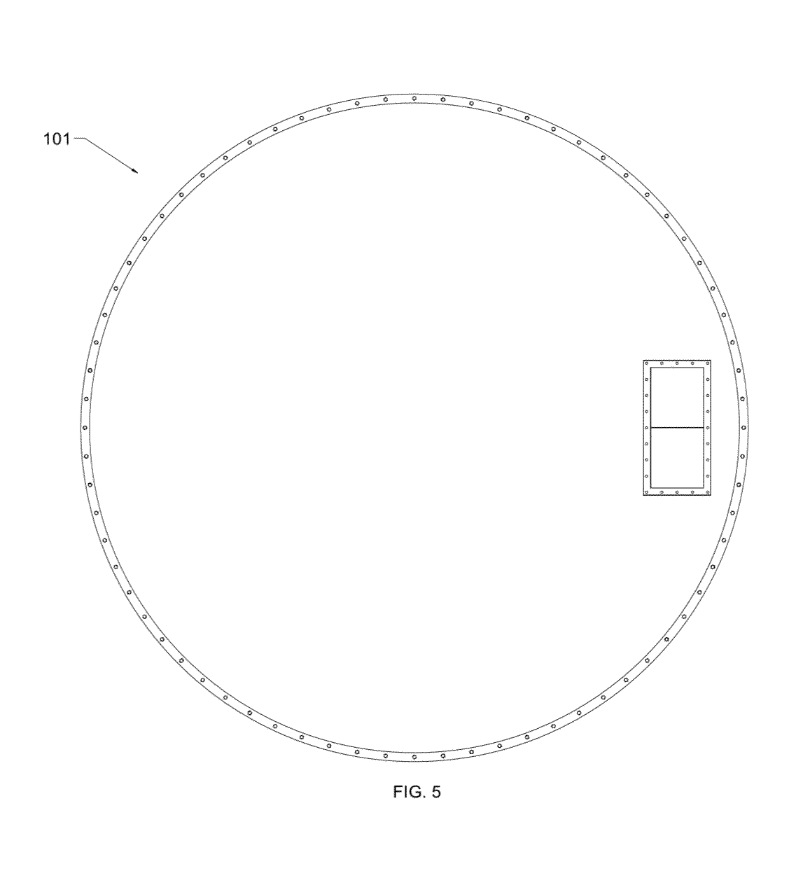

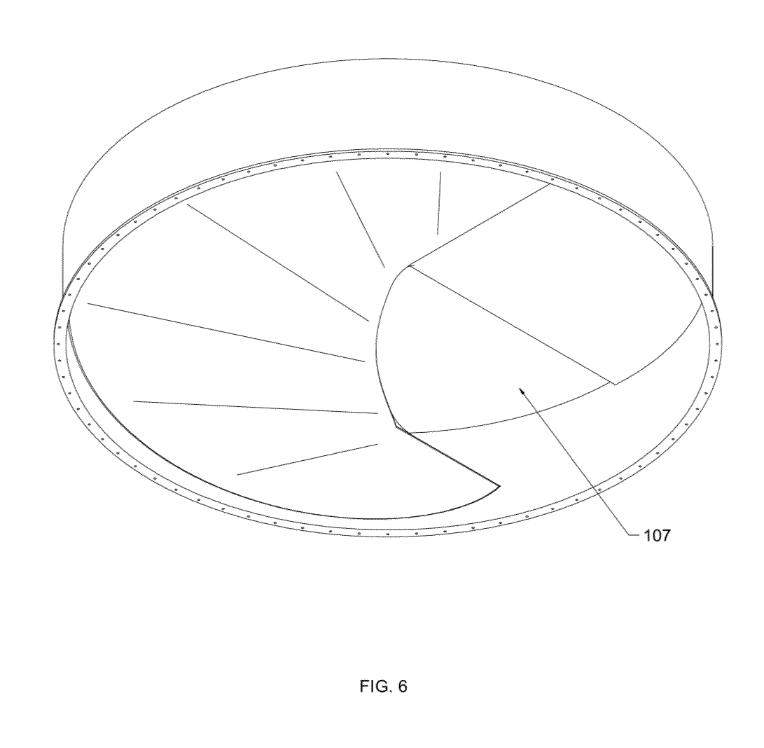

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices illustrated in the attached drawings, and described in the following specification, are simply exemplary embodiments of the inventive concepts defined in the appended claim. Hence, specific dimensions and other physical characteristics relating to the embodiments disclosed herein are not to be considered as limiting, unless the claims expressly state otherwise.

The main objective of the present invention is to rotate a shaft that is coupled to a generator, responsible for generating electricity. In order to do that, the apparatus illustrated in general terms in FIG. 1 is presented. This apparatus 100 comprises a silo 101 into which a solid material is stored. This silo 101 is always located in an elevated high position separated from ground level at a distance “H”. As will be explained later, this distance H represents the potential energy the material contains when it is stored in the silo. This potential energy is calculated as M (mass of particulate material)*H*g (gravity). This potential energy is converted into kinetic energy by the free fall of this material from the silo to the ground level in which the electricity generating system is installed.

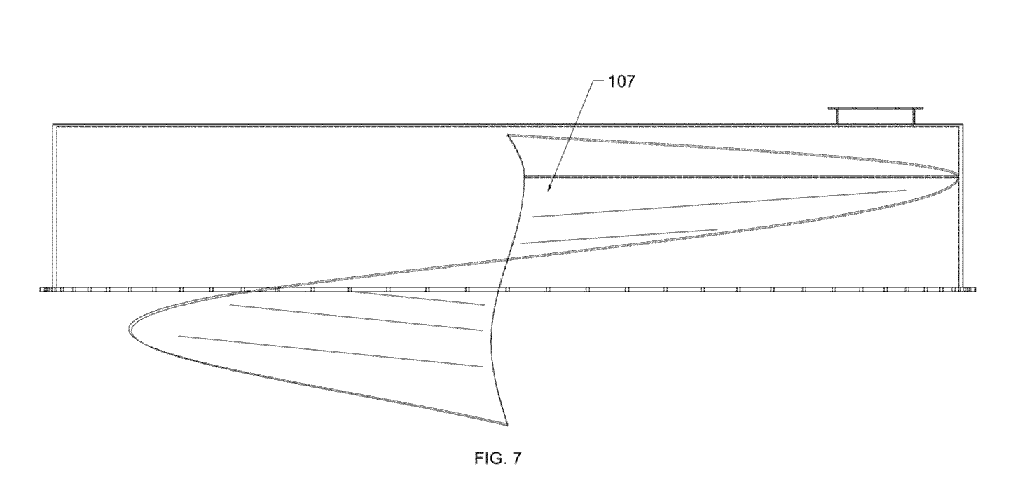

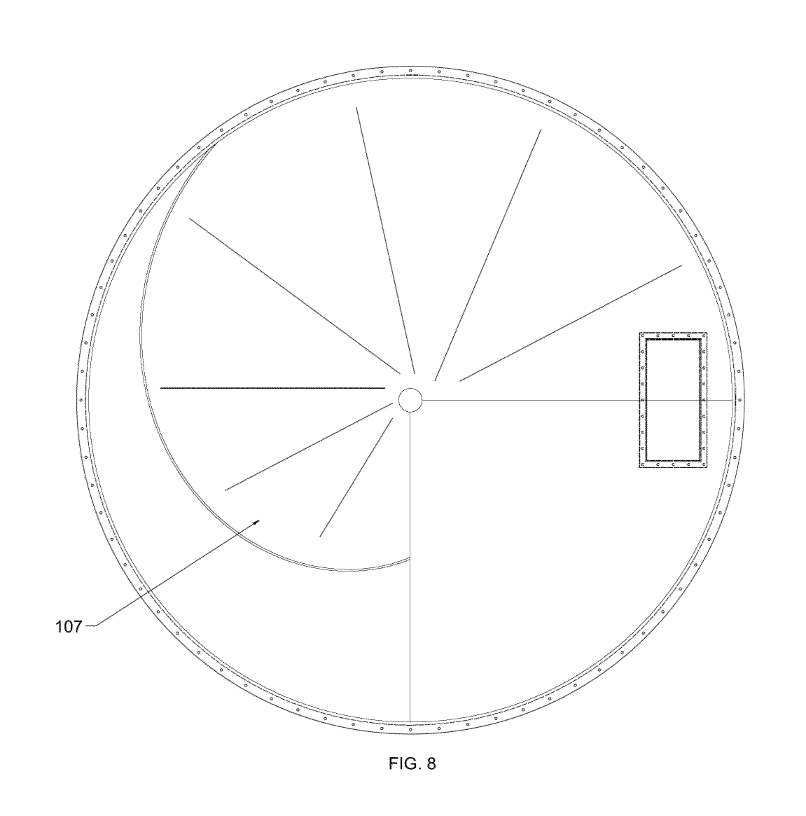

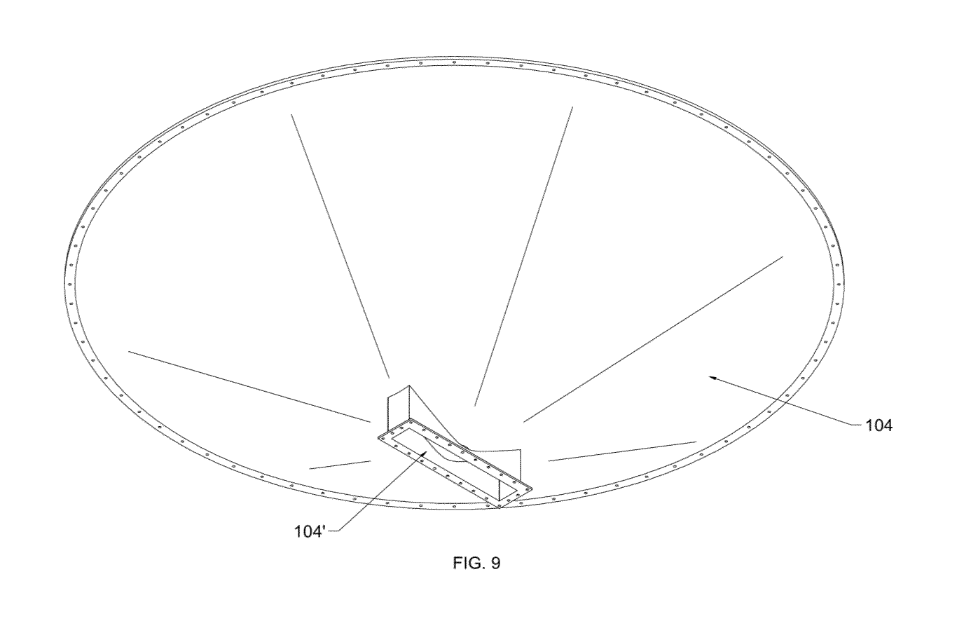

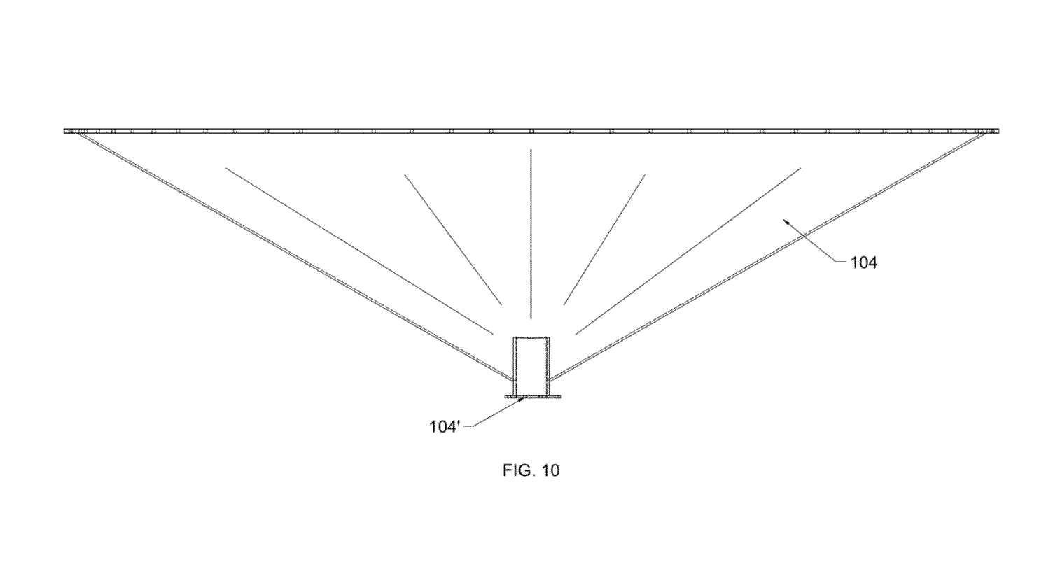

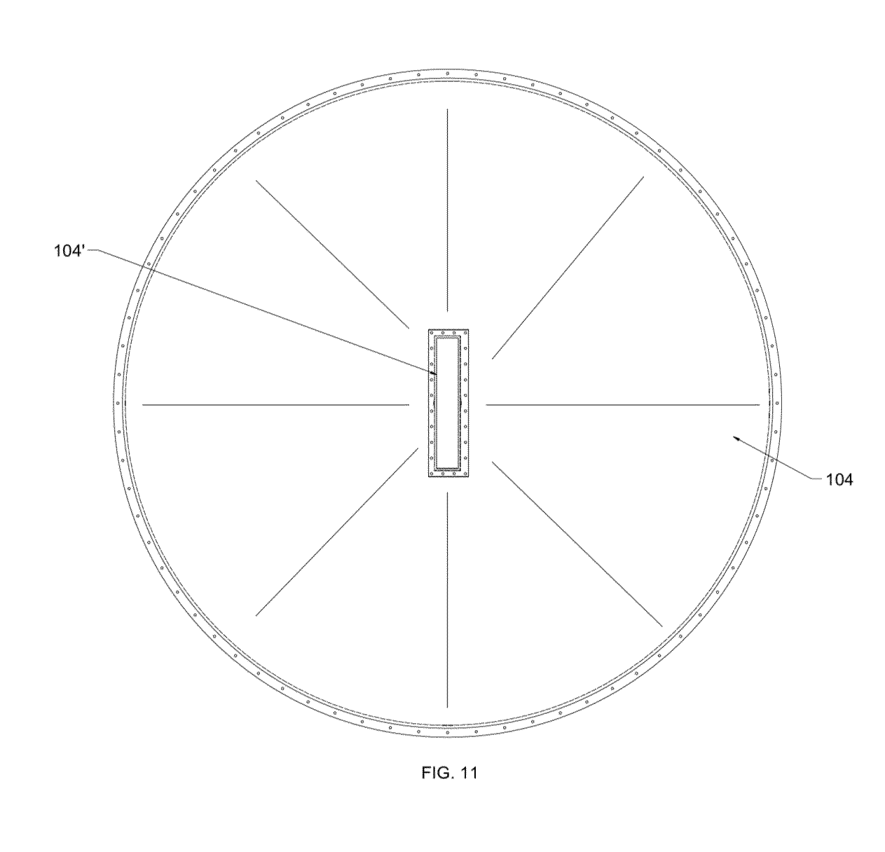

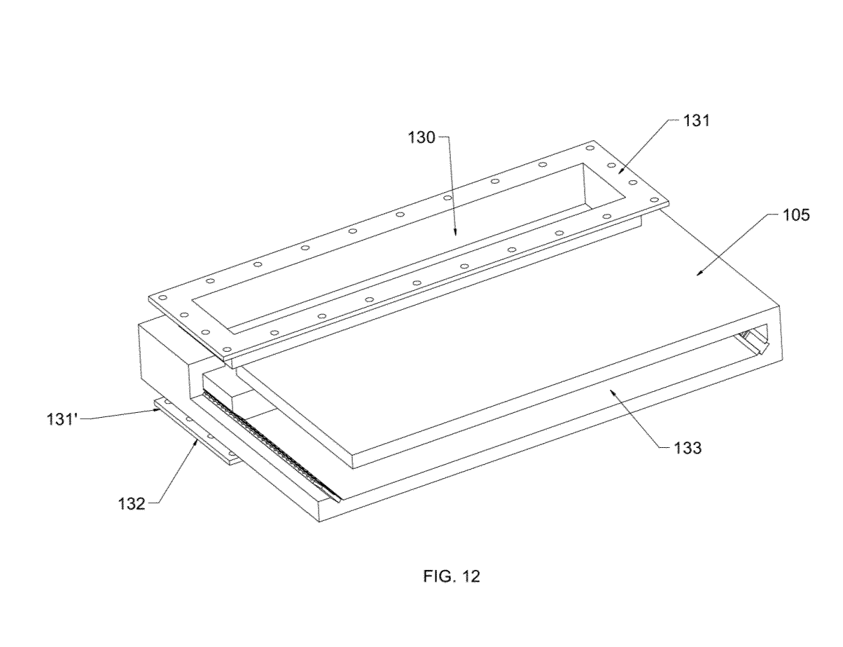

In the exemplary embodiment the silo comprises a funnel-like body 102 with an upper cylindrical portion 103 and a conical portion 104. Into this silo 101 a spiral shaped platform 107 is included (see FIGS. 6-8) to minimize the impact from the spheres falling from the feedback system, as will be explained in detail below.

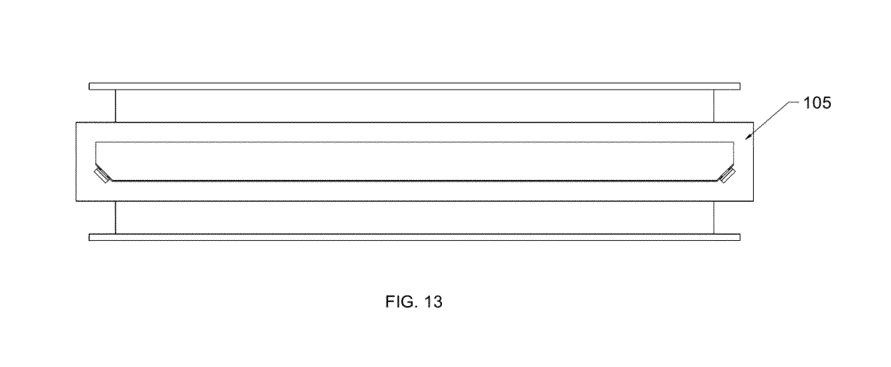

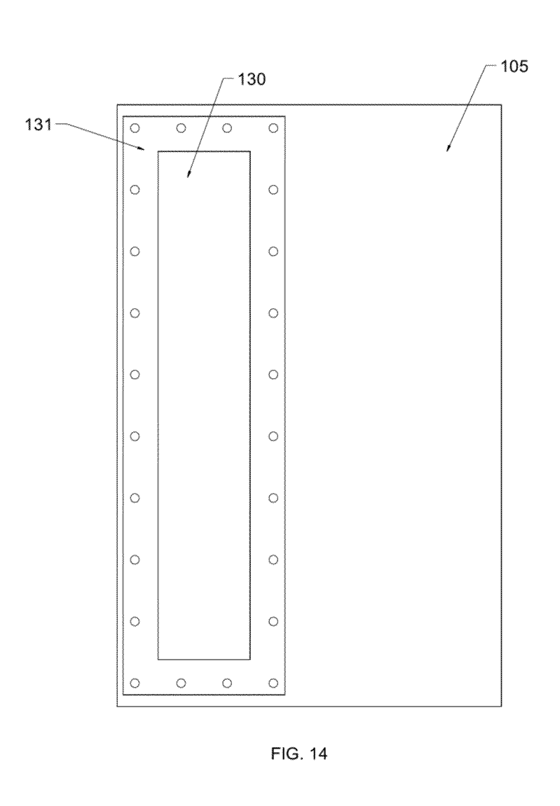

The structure of this silo 101 includes a contention guillotine valve 105. This valve, illustrated in FIGS. 12-14 includes an inlet 130 in fluid communication with the silo 101 and an outlet 132 in fluid communication with a down pipe duct 106. This duct is a group of rectangular shaped ducts and dimensions adapted to each system, to transport the material (spheres) in vertical descending direction towards the power system.

This valve 105 consists of a casing 133 and a steel plate that serves as a sluice gate. It is used to regulate the silo's exit flow, and the entry flow to the power system.

After the material passes through said valve 105 it falls into ah elongated straight duct 106 with an upper end 106′ attached to said valve 105 and a lower end 106″ attached to the another valve 108. The upper coupling edge 131 is attached to the silo 101 and the lower coupling edge 131′ is attached to the duct 106. The energy of this free fall of this material in the duct 106 is the energy the system will use to move the rotor, as will be explained later below.

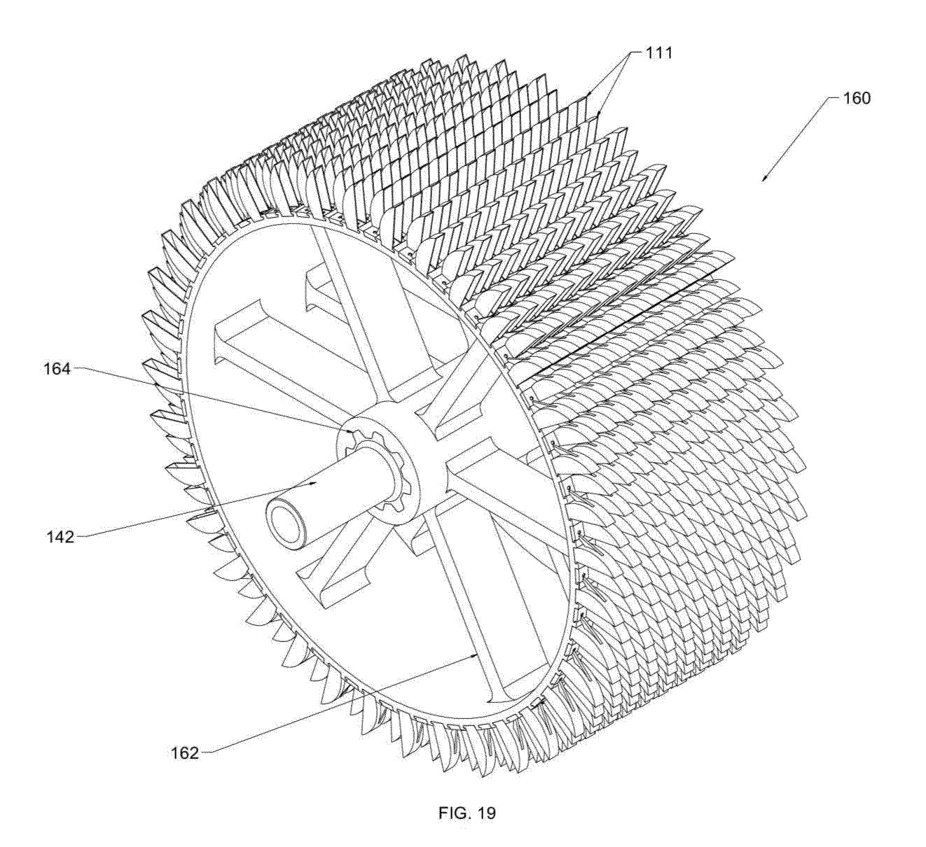

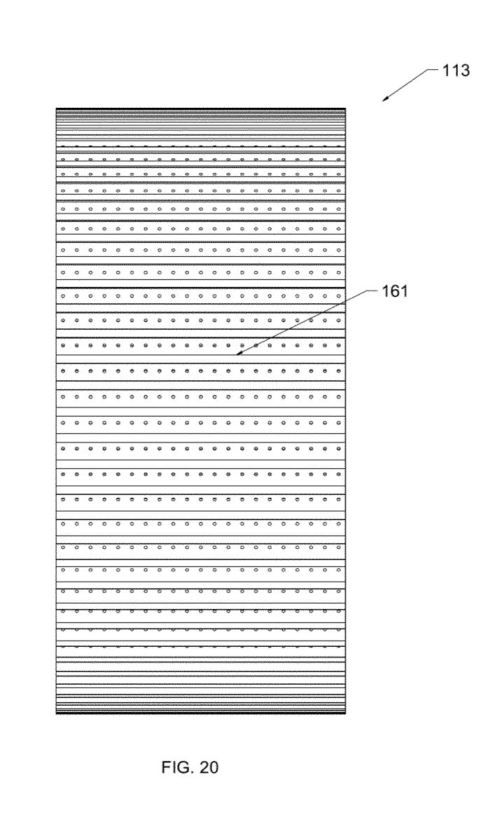

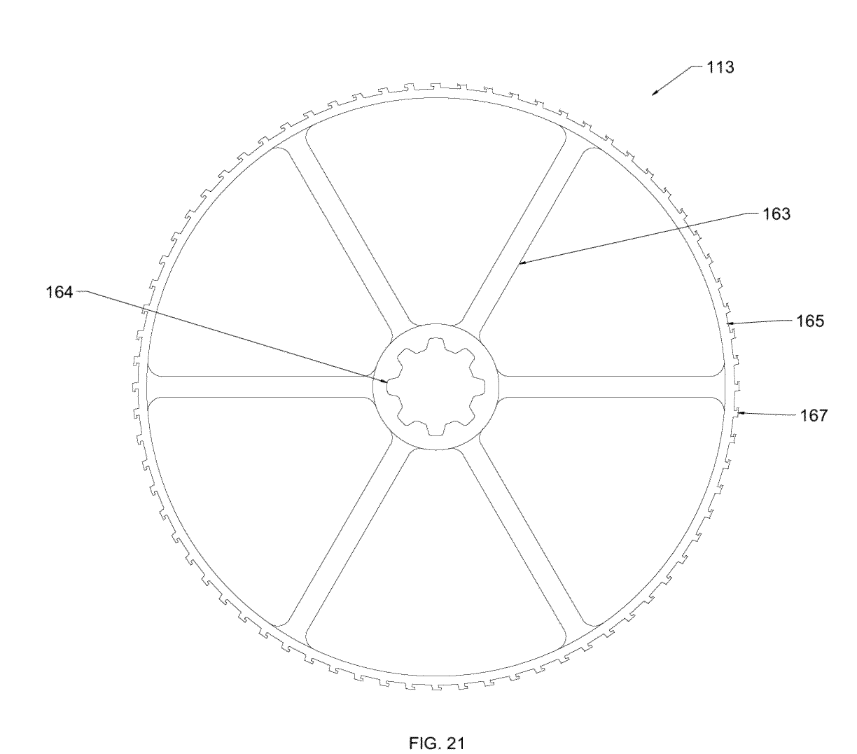

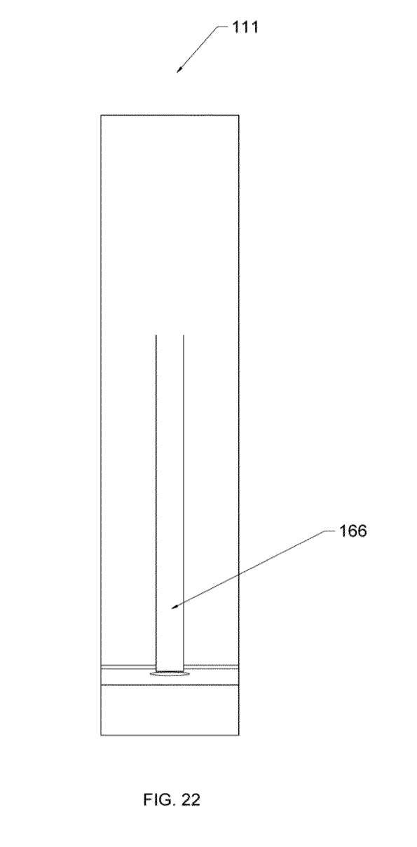

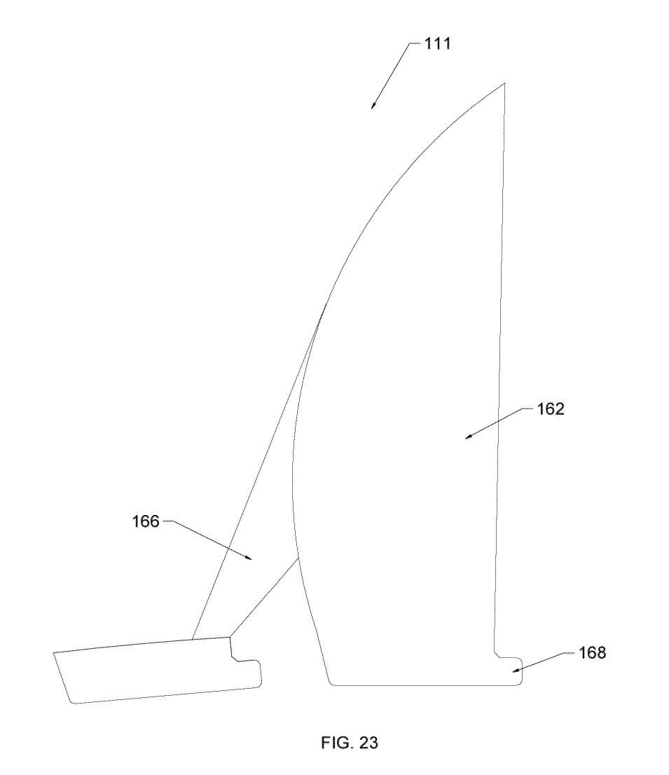

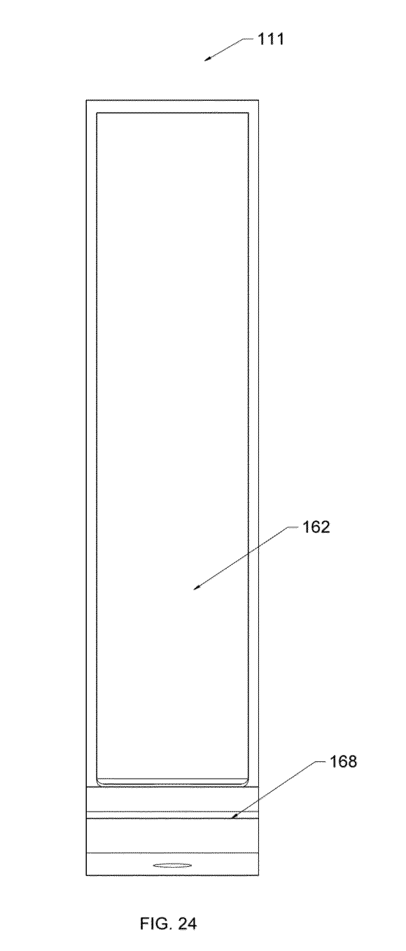

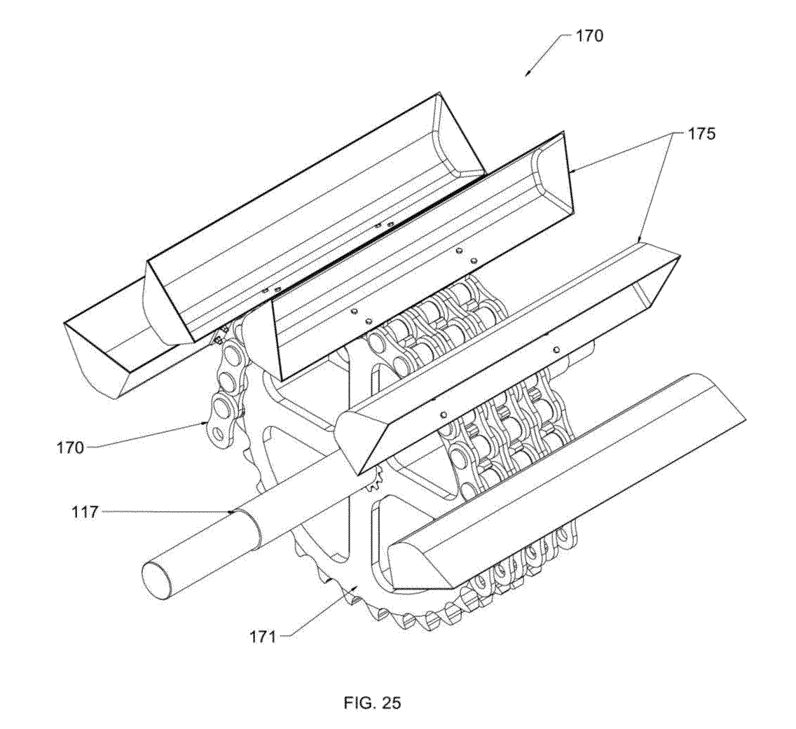

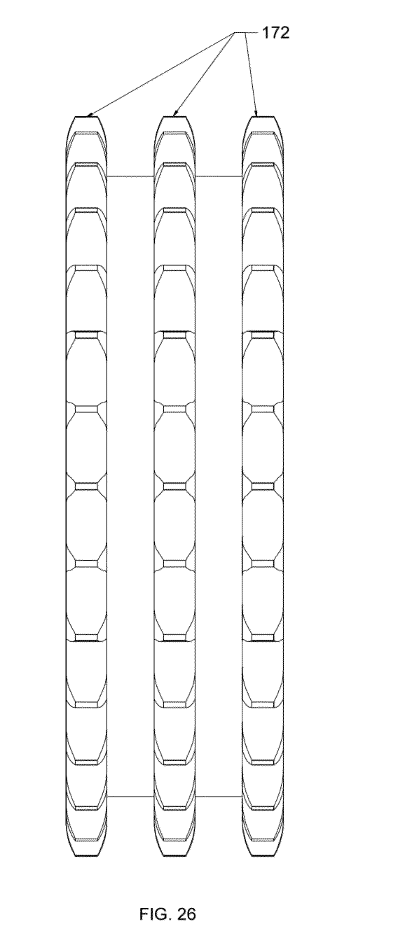

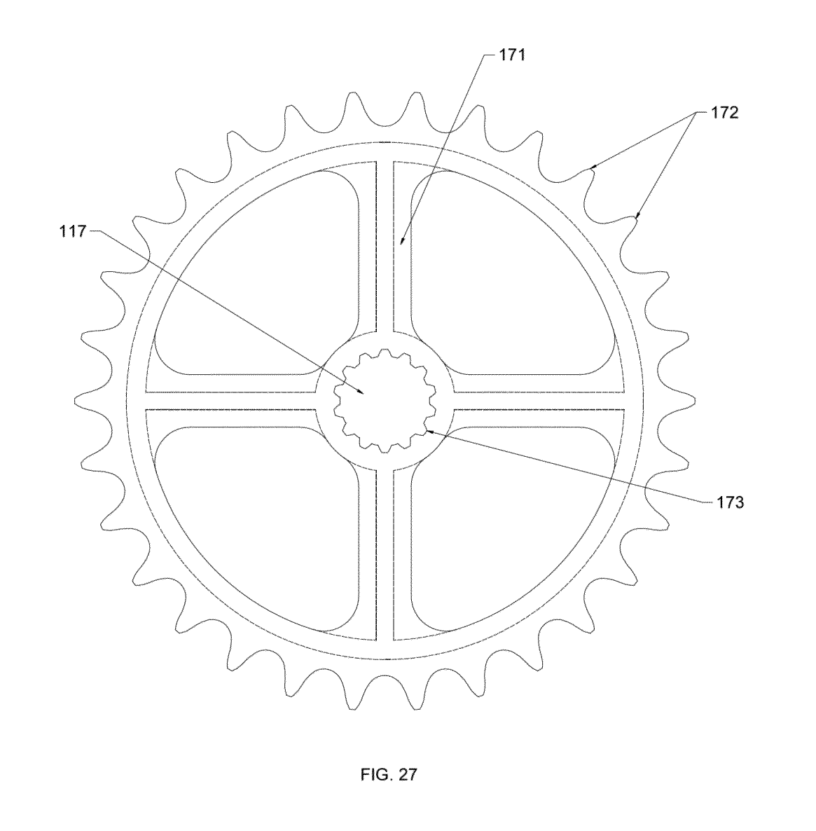

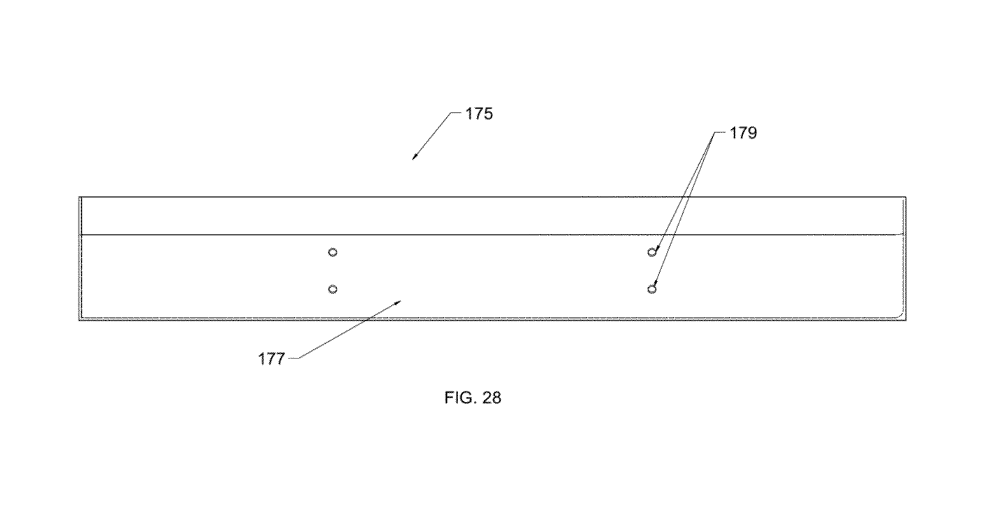

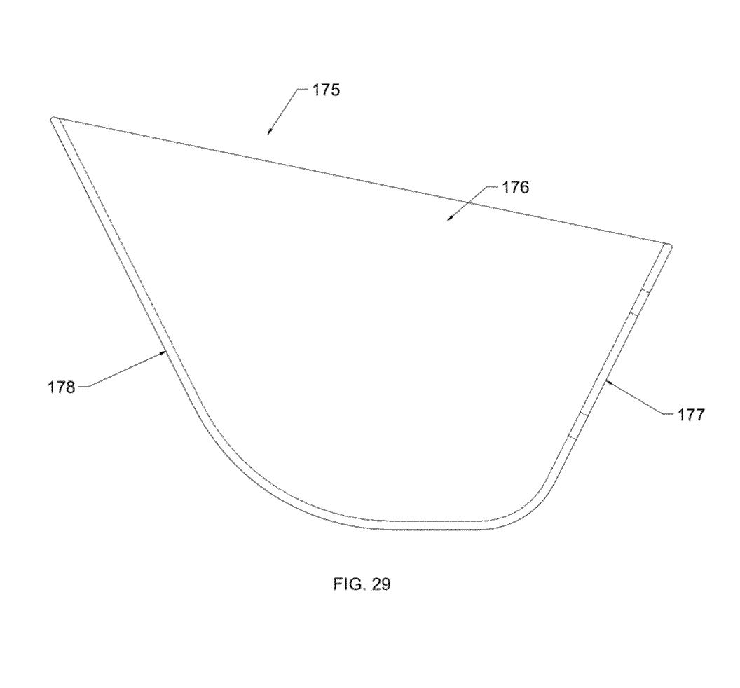

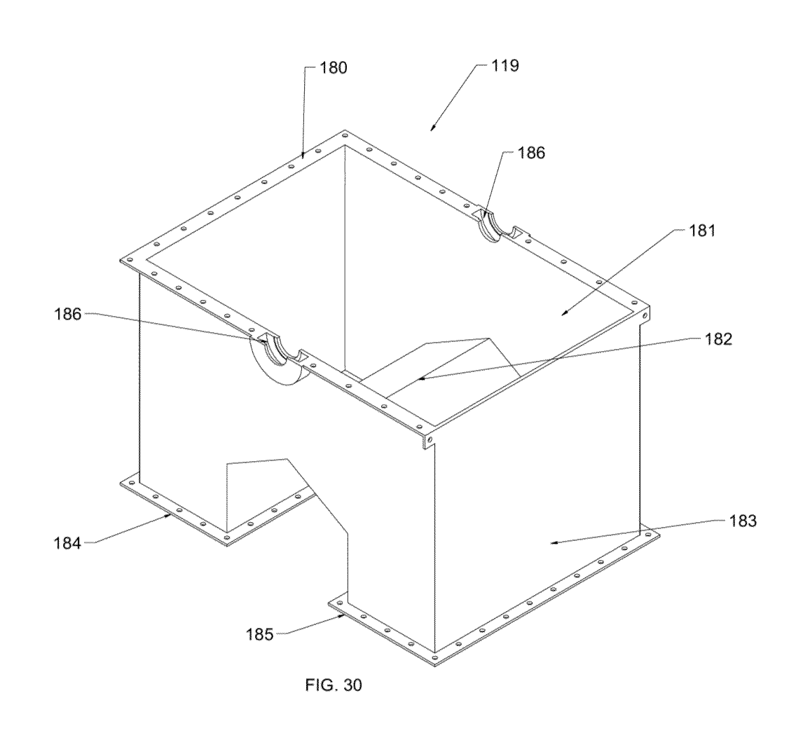

When the material from the silo 101 reaches the lower end 106″ of the duct 106 it passes through a guillotine valve 108 and impacts on the power system, particularly the rotor 160, in the portion 109 of said duct 106. As illustrated in FIGS. 19-24 said rotor 160 comprises a rotor core 113 to which a set of radial recipient 111 is attached. Said rotor core 113 defines a spoked gear wheel with a central mounting 164, a set of radial spokes 163 and if peripheral mounting surface 165. Said peripheral mounting surface 165 includes on the outer surface thereof parallel hook-like entries 167. Each recipient 111 comprises a spoon-like piece defining a receptacle 162 to receive the material coming from the silo 101, and an attaching bracket 166. Said bracket 166 includes a tooth-like projection 168 that is inserted into the groove 167 defined by said entries 167.

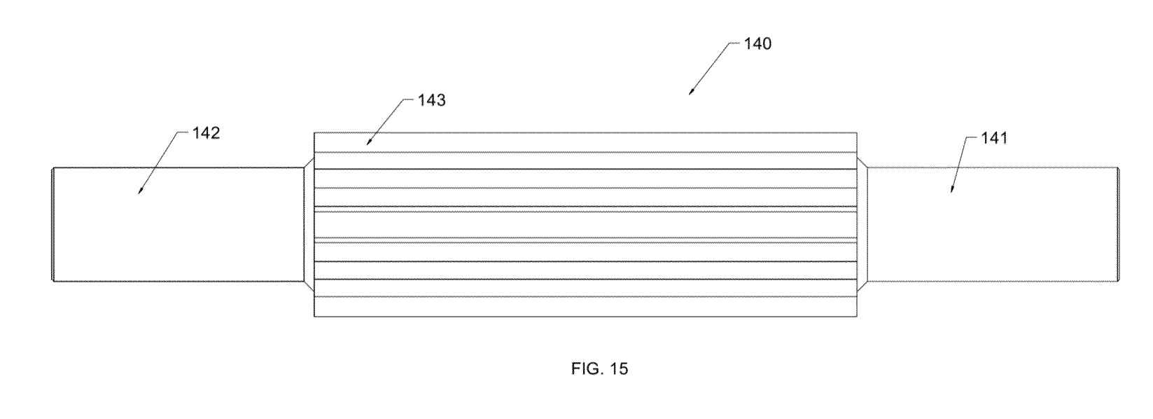

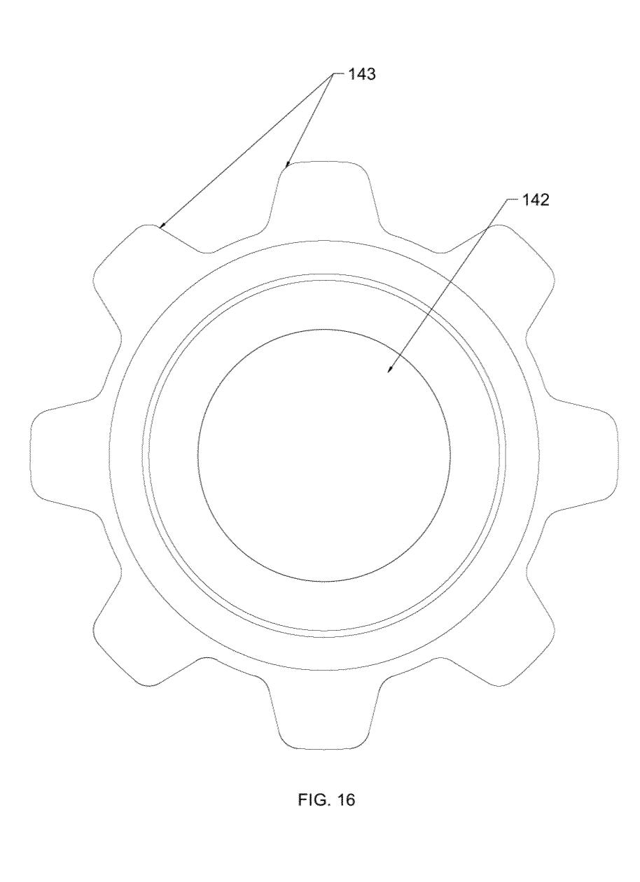

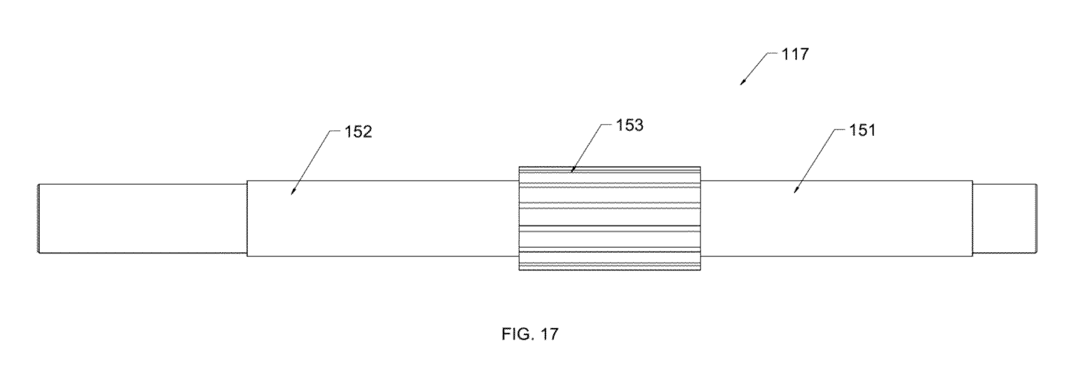

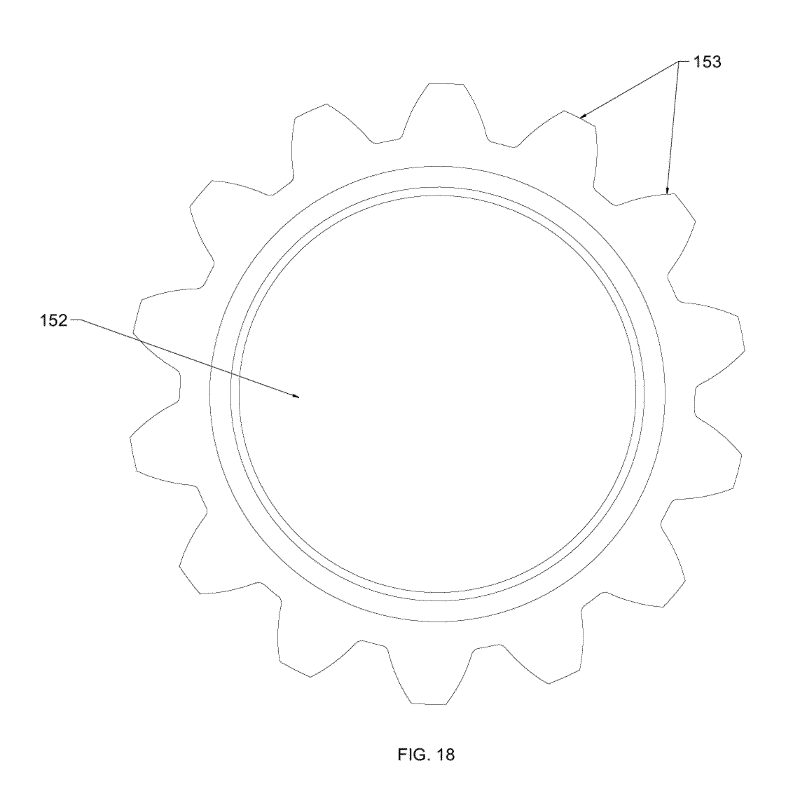

Said rotor's core 113 is mounted on a rotor shaft 14 (see FIGS. 15-16). This shaft is mounted into the central mounting 164. Teeth 143 are designed to fit into the complementary shape of said mounting 164. The central portion of this shaft 140 remains in the central mounting 164, and the external portions 141-142 are supported on respective bearings 112 of the rotor casing 110. This is the part where the rotor 160 is located, and consists of a base casing 110′ in the bottom part, and a top casing 110″ on the superior part. This is, where the shaft's bearings 112 are placed, particularly onto the U-shaped recess 110a.

When the material from silo 101 impacts on the spoon-like recipient 111 the kinetic energy is transmitted to the rotor through the buckets to rotate it. In the embodiment illustrated in FIG. 1 the material impacts on the recipients 111 and makes the rotor 160 rotate counterclockwise. The movement of this rotor 160 drives a generator (not illustrated) with which the system generates the required electricity.

Once the material impacts on the rotor 160 it is discharged through a discharge duct 115 whose lower portion 116 is in fluid communication with the lower portion 118 of the lifting system 170. This duct 115 collects the material (spheres) that exits the rotor 160 and takes it to the inferior part 116 of the lift system 170.

This lift system 170 comprises two sprockets 171 each with a set of peripheral teeth 172 on which a chain 177 is mounted. Each sprocket 171 is a traction element of the chain conveyor system used to relocate the material in the silo 101. In the illustrated embodiment there are two sprockets, one at the bottom of the system to collect the material and the other one at the opposite side, to drop it off into the silo 101. Said sprockets 171 are mounted to a shaft 117 including a teethed portion 153 and respective extended portions 151-152 with which these shafts are mounted to the casing 119.

To said chain 177 a set of buckets 175 are attached. Said chain 177 may be a mono-track or multi-track chain. In the illustrated case it is a multi-track chain, made of steel including several links that have 90° extensions 178 on both sides to which the buckets 175 are attached.

Each bucket 175 defines a receptacle 176 with a back wall 177 and a front charging portion 178 that faces the material and charges it into said receptacle 176. Using the orifices 179 each bucket 175 is attached to the extension 178 of said chain 177.

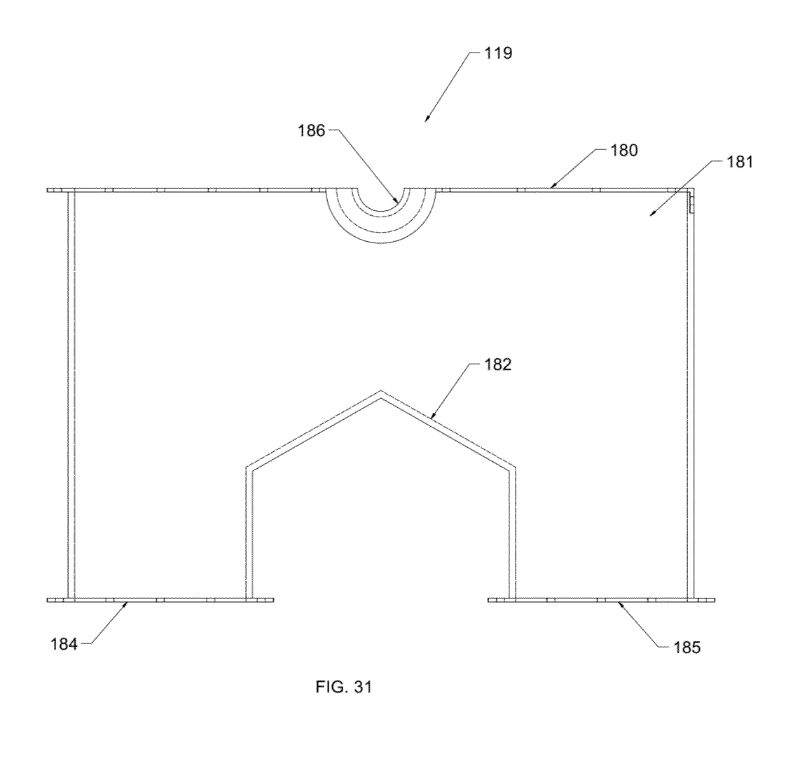

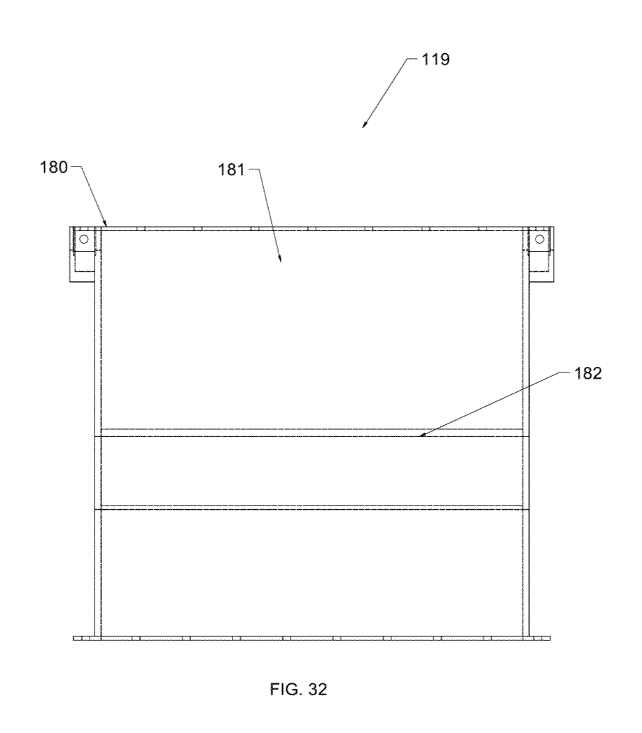

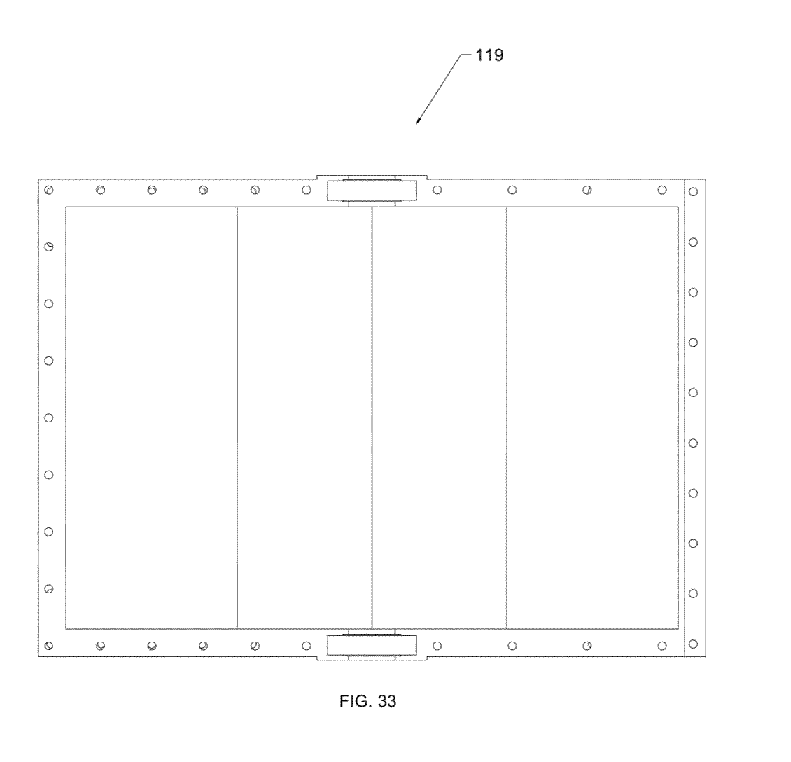

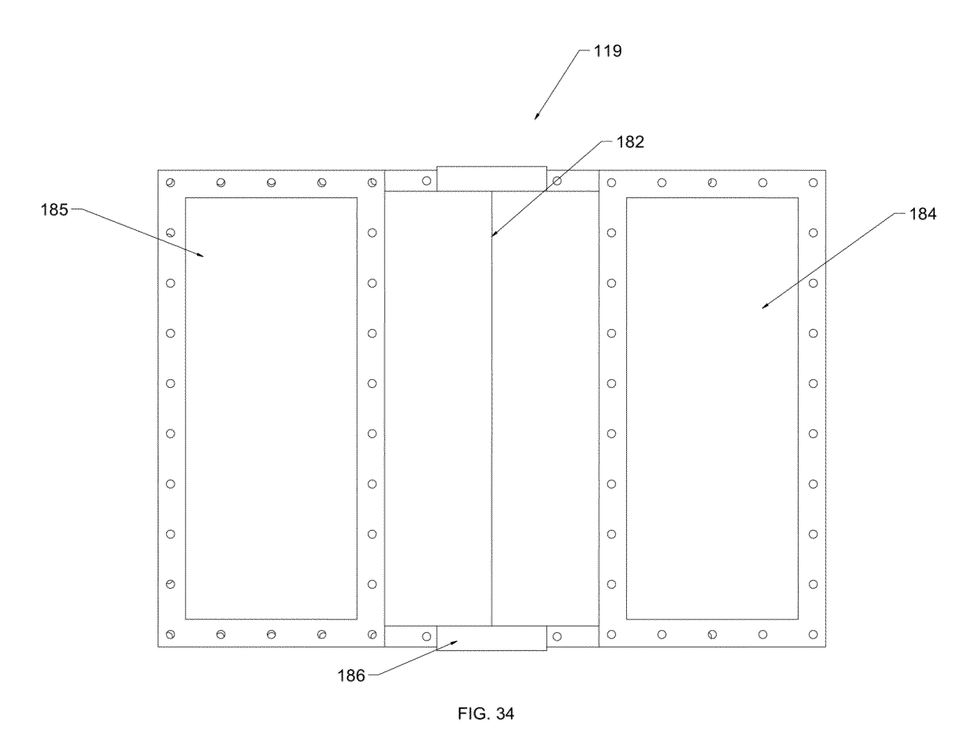

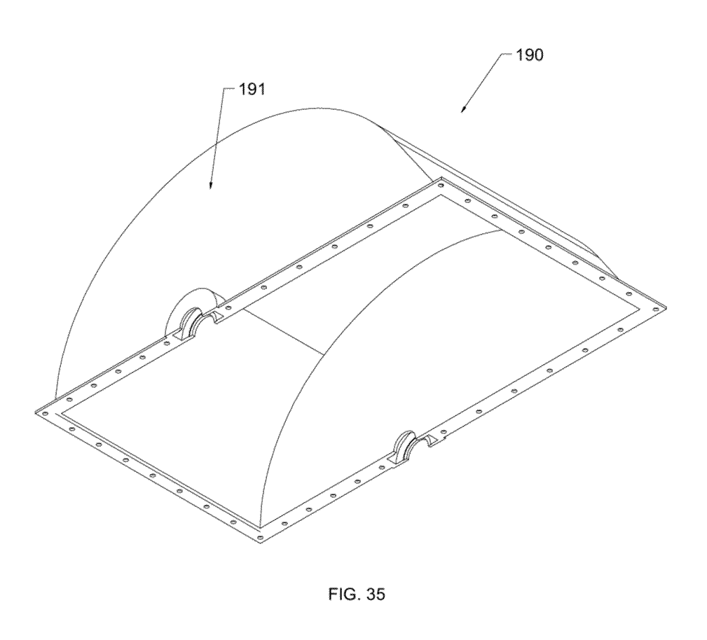

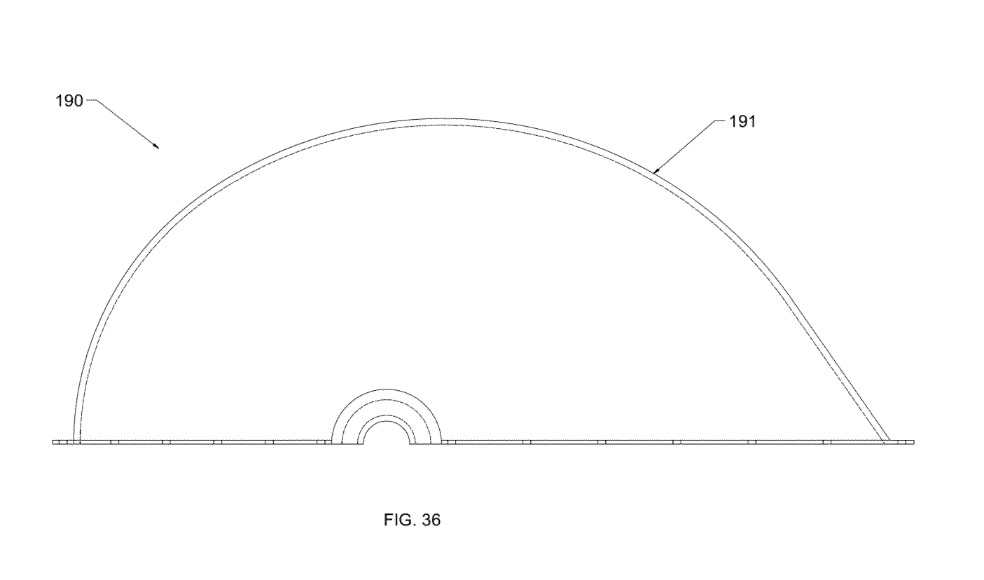

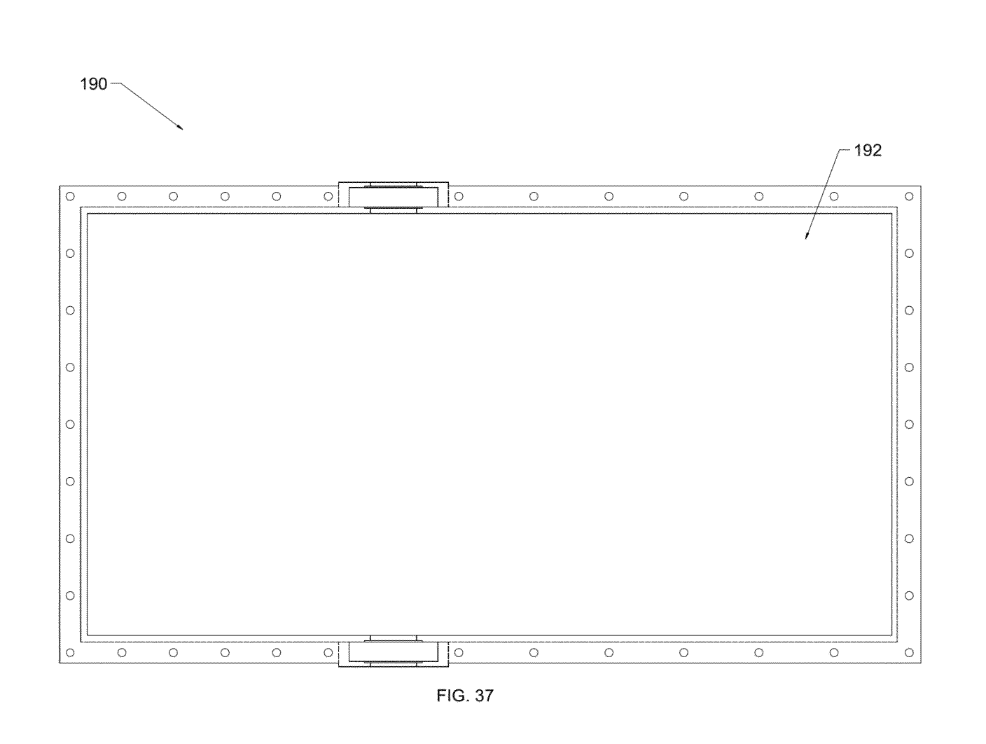

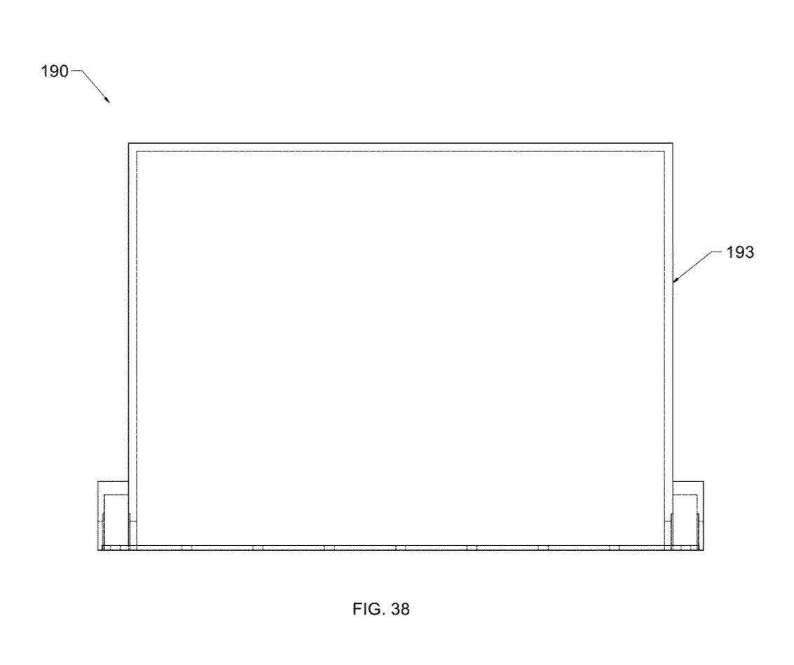

Said casing 119 (see FIGS. 30-34) defines a receptacle into which the above described sprocket is lodged. It includes an opening 181, an internal partition 182 and two ducts 184-185. The peripheral edge 180 includes two recesses 186 onto which bearings 112 are installed and onto which the shaft 117 is mounted. To each duct 184-185 respective elongated lifting ducts 120 are installed. Into said ducts 120 said chain 177 with the buckets 175 travels. In the upward direction said buckets are full of material (spheres) and when they go down the buckets are emptied. The upper portion of these ducts 120′ is in fluid communication with another casing 124 similar to the above described casing 119, into which the other sprocket 171 is installed. This casing 124 includes a discharging duct 125 with which the material returns to the silo 101 to reinitiate the process.

The material used to drive the present apparatus 100 may be spheres made of steel and covered with Teflon®, but this cannot be considered a limitation in the scope of protection of the present invention.

### Detail Engineering

The purpose of this section is to demonstrate under scientific terms that the present invention is not only viable but also high efficient. At the end of the present chapter, it will be demonstrated that the global efficiency of the systems is above 70%.

### Power System

The present invention is a completely ecological self-sustainable mechanical system 100 for generating electricity that uses a flow of steel spheres coated with a thin film of high resistance Teflon as its power source. These spheres can be of different diameters depending on the casing. To design an approximate 1.7 MW system 0.005 m diameter steel spheres were used obtaining a 69% of actual space.

Calculation of the Volume of the Spheres

To determine the force exercised upon the rotor, various volume calculations must be done. First the volume of a 5 mm sphere is calculated, and then the volume that these spheres occupy in the down ducts 106 that goes from the silo 101 to the rotor 160.

Parameters of a Sphere:

with the following starting parameters, the volume of the sphere is calculated: Ø=5 mm=0.005 m, r=0.0025 m. Steel specific weight=7850 Kg/m³. Sphere Vol.=4/3πr³

$$Sphere Vol . = \frac{4}{3} * 3.1416 * {0.0025}^{3}$$

$$Sphere Vol . = \frac{4}{3} * 3.1416 * {0.0025}^{3}$$

$$Sphere Vol . = 4.1888 * 0.000000015625$$

$$Sphere Vol . = 0.00000006545 {m}^{3}$$

Calculation of the Mass of a Sphere:

Mass of a sphere=Volume of a sphere×specific weight of steel.

Mass of a sphere=0.00000006545 m³×7850 Kg/m³.

Mass of a sphere=0.0005137825 Kg.

Calculation of number of spheres in 1 m³: For 5 mm spheres the following exercise will be done, 1 meter will be divided in 5 mm (0.005 m), with 115 lines of 200 circles each+115 lines of 198.8 circles each as a result. Using the (CAD/CAE) program, a 1 meter horizontal line is drown (X axis) and 200 5 mm circles are consecutively positioned until they are exactly aligned. Then 198.8 circles are put over the 200 circles making contact with the inferior circles, repeating the process until a 1 meter high vertical line is completed. (Y axis). This arrangement results in 115 lines of 200 circles each and 115.8 lines of 198 circles each resulting in a total of e 45928.4 circles in a square meter. These circles will be converted into Ø5 mm spheres with a V=0.00000006545 m³ volume, as demonstrated in the calculation above. To calculate the number of 5 mm spheres contained in 1 m³, the number of spheres contained in 1 m² is multiplied times 230.8 lines along an (Z axis) obtaining as a result that 1 m³ contains 10600274.72 5 mm spheres.

Demonstration of the Calculation of the Number of Spheres/m³

No of spheres in lines of 200=115×200=23000 spheres

No of spheres in lines of 198.8=115×198.8=22928.4 spheres

Total of spheres in 1 m²=23000+22770=45928.4 spheres

Total of spheres in 1 m³=45928.4×230.8=10600274.72 spheres.

Calculation of the Actual Volume and Weight of the Number of Spheres/m³

Assumed volume: 1 m³.

Volume of a sphere: 0.00000006545 m³.

Mass of a sphere: 0.0005137825 Kg.

$$Actual volume in 1 {m}^{3} = N ° spheres in 1 {m}^{3} \times Volume of 1 sphere$$

$$Actual volume in 1 {m}^{3} = 10600274.72 \times 0.00000006545$$

$$Actual volume in 1 {m}^{3} = 0.6937879797695 {m}^{3}$$

$$\% actual volume efectivo in 1 {m}^{3} = \frac{actual volume \times 100}{1}$$

$$\% actual volume in 1 {m}^{3} = \frac{0.6937879797695 \times 100}{1}$$

$$\% actual volume in 1 {m}^{3} = 69.37879797695 \%$$

Mass Calculation of Spheres/m³: Method No 1

$$Actual volume of the spheres in 1 {m}^{3} = N ° of spheres in 1 {m}^{3} \times Volume of 1 sphere$$

$$Actual volume of the spheres in 1 {m}^{3} = 10600274.72 \times 0.0005137825 Kg$$

$$Actual volume of the spheres in 1 {m}^{3} = 0.69378797 {m}^{3}$$

$$\% of actual volume of the speheres in 1 {m}^{3} = \frac{actual volume \times 100}{1}$$

$$\% of actual volume of the spheres in 1 {m}^{3} = \frac{0.69378797 \times 100}{1} \\ \% of actual volume of the spheres in 1 {m}^{3} = 69.378797 \% \\ Mass of the spheres in 1 {m}^{3} = 69.378797 \% * 7850 \\ Mass of the spheres in 1 {m}^{3} = 5446.23 Kg$$

Calculation Method No 2

Actual weight of spheres in 1 m³=No spheres in 1 m³×Mass of 1 sphere

Actual weight of spheres in 1 m³=10600214.72×0.0005137825 Kg

Actual weight of spheres in 1 m³=5446.23 Kg

Actual weight of spheres in 1 m³=Specific weight of steel×actual volume

Actual weight of spheres in 1 m³=7850 Kg/m³×06937879797695 m³

Actual weight of spheres in 1 m³=5446.2356 Kg

Both methods demonstrate the calculations.

Mass Calculation of Spheres in Downpipe 106:

### Parameters:

No of spheres/m³=10600274.72 spheres
Volume of the downpipe in m³: 5.06548 m³
Actual volume of the downpipe in m³:3.495 m³ Dimensions of the downpipe: Length: 1

Calculation of the Volume of the Downpipe 106 (Silo−Rotor)

Downpipe Volume (Silo−Rotor)=Length×Width×Height

Downpipe Volume (Silo−Rotor)=1.106 m×0.20 m×22.90 m

Downpipe Volume (Silo−Rotor)=5.06548 m³

Mass Calculation of Spheres in Downpipe (Method 1)

$$Spheres column weight = N ° of \frac{spheres}{{m}^{3}} \times sphere mass * downpipe Vol . \\ Spheres column weight = 10600274.72 \times 0.0005137825 \times 5.06548$$

$$Spheres column weight = 27587.79 Kg$$

Mass Calculation of Spheres in Downpipe (Method 2)

Spheres column weight=V downpipe×actual %×steel specific weight

Spheres column weight=5.06548 m³×0.69378797×7.850 Kg/m³

Spheres column weight=27587.79 Kg

Calculation of the Force Exercised by the Spheres Upon the Rotor

### Parameters:

No of spheres/m³=10600274.72 spheres
Volume of the downpipe in m³: 5.06548 m³
Actual volume of the downpipe in m³: 3.495 m³
Dimensions of the downpipe: Length: 1.106 m×Width: 0.20 m×Height(h): 22.90 m

Calculation of the Volume of the Downpipe (Silo−Rotor).

Downpipe Volume (Silo−Rotor)=Length×Width×Height

Downpipe Volume (Silo−Rotor)=1.106 m×0.20 m×22.90 m

Downpipe Volume (Silo−Rotor)=5.06548 m³

Method 1:

$$Spheres column weight = N ° of \frac{spheres}{{m}^{3}} \times sphere mass * downpipe Vol . \\ Spheres column weight = 10600274.72 \times 0.0005137825 \times 5.06548$$

$$Spheres column weight = 27587.79 Kg$$

Method 2:

Spheres column weight=V downpipe×actual %×steel specific weight

Spheres column weight=5.06548 m³×0.69378797×7.850 Kg/m³

Spheres column weight=27587.79 Kg

Calculation of Force

F=m*g

### Where:

F: Spheres column force upon the rotor
m: Downpipe spheres mass
g: Gravity 9.81 m/s²
F=27587.79 Kg*9.81 m/s²

### F=270636.29 Kg*m/s²

### F=270636.29 N

Calculations Report

In the design of the present invention, a series of parameters were taken into account, which allowed the design of each one of the components, these parameters can vary depending on the energy demand needed by the consumer.

After studying and calculating various systems which are shown in the calculations spreadsheets, based on the formulas indicated before, a system with a downpipe height of 22.90 m, was selected for being the first in the spreadsheet that surpassed 1 MW, with a gross production of 1.7 MW and an actual production of 1.24 MW, like it is demonstrated in the attached calculations spreadsheets.

Although these parameters have been chosen, the present invention can be designed to produce any amount of power changing and adapting the dimensions of the main components like height and downpipe volume, as well as the diameter and width of the rotor, so that it can perform according to the needs of each consumer.

In the following example, calculations were made to create the a 1.7 MW system

### Parameters:

Silo's actual capacity: 30 m³.
Downpipe height: 22.90 m.
Rotor's dimensions: Ø2.6 m×1.05 m
Rotor's speed: 48.60 rpm.
Lift system height: 29.00 m.
Actual volume of the bucket: 0.00032 m³.
Rotor's actual sphere's reception volume: 0.2452 m³.
Lift system bucket actual volume: 0.0131 m³.
Downpipe volume: 5.065 m³
Downpipe actual volume: 3.495 m³

For the design of the present invention with an energy production capacity of 1.7 MW, the parameters mentioned above were taken into account and used to design each one of the components, using a Computer Assisted Design/Computer Assisted Engineering program (CAD/CAE).

Kinetic Energy Calculation:

The force that rotates the rotor is created by the kinetic energy of the spheres free falling down the downpipe 106 from a height of 22.90 m. These Calculation were made with the following equation:

Ec₁+Ep₁=Ec₂+Ep₂ (Equation 1)

Being Ec₁ y Ep₁ the kinetic energy and potential energy of the spheres in state 1 (spheres in state of rest inside the silo), and Ec₂ and Ep₂ the kinetic energy and potential energy for the state 2 (contact with rotor's receptor buckets).
In state 1 the potential energy is maximum and equals the following expression:

Ep₁=m*g*h₁ (Equation 2):

And the kinetic energy in state 1 equals the following expression and in this case it equals 0:

$$E {c}_{1} = \frac{1}{2} * m * {V}_{1}^{2} = 0 \qquad ( Equation 3 )$$

For the state 2 the potential energy equals 0, while the kinetic energy reaches its maximum, resulting in the following expressions:

$$\begin{matrix}{Ep}_{2} = m * g * {h}_{2} = 0 & ( Equation 4 ) \\ {Ec}_{2} = \frac{1}{2} * m * {V}_{2}^{2} & ( Equation 5 )\end{matrix}$$

Substituting the equations 2, 3, 4 y 5 in 1 the following expression is obtained:

$$0 + {Ep}_{1} = {Ec}_{2} + 0 \\ m * g * {h}_{1} = \frac{1}{2} * m * {V}_{2}^{2} \\ g * {h}_{1} = \frac{1}{2} * {V}_{2}^{2} \qquad ( Equation 6 )$$

Finding the velocity V₂ in the equation 6 it is obtained:

V₂=\sqrt{2*g*h₁}

### Where:

h₁=22.90 m
g=9.81 m/s²

V₂=\sqrt{2*9.81*22.90}

V₂=21.1967 m/s

Calculating the kinetic energy in the state 2 with the equation 5, the following result is obtained:

$$m = Pe * {Vol}_{actual downpipe}$$

$$m = 7850 kg \text{/} {m}^{3} * 3.514369 {m}^{3}$$

$$m = 27587.79 kg$$

$${Ec}_{2} = \frac{1}{2} * 27587.79 Kg * {( 21.1967 )}^{2} {s}^{2} = 6197571.08 Kg \text{/} {s}^{2}$$

### Where:

m: downpipe spheres mass
Pe: specific steel weight 7850 kg/m³

$${Ec}_{2} = \frac{1}{2} * m * {V}_{2}^{2} .$$

### Then:

F=m*g

### Where:

F: Spheres column force upon the rotor
m: Downpipe spheres mass
g: Gravity 9.81 m/s²
F=27587.79 Kg*9.81 m/s²

### F=270636.29 Kg*m/s²

### F=270636.29 N

Rotor Design

### Selected Dimensions:

Rotor's core Ø: 2.20 m
Receptor buckets length: 0.20 m
Rotor's total Ø: 2.20 m+(0.20*2) m=2.60 m
r=½Ø=1.30 m
With a force F of 269158.66 N then torque T can be calculated.

Tᵣₒₜₒᵣ=F*r

Tᵣₒₜₒᵣ=269158.66 N*1.3 m

Tᵣₒₜₒᵣ=349906.26 Nm

Then the power produced by the rotor is calculated. The rotor's revolutions per minute (rpm) and the mass formed by the rotor's mass plus the rotatory assembly of the generator and the rotatory elements of a gear box (to increase or decrease the speed depending on the case) are needed first. The total mass of the rotatory assembly has been estimated in 8000 Kg. Taking this value into account, the rpm are calculated

### Know Values:

### F=269158.66 N

Rotatory ensemble mass: 8000 Kg
rpm: 48.60 rpm
First, the tangential acceleration must be calculated (At)

$$F = {m}_{rotor} * At$$

$$At = F \text{/} {m}_{rotor}$$

$$At = \frac{269158.66 N}{8000 Kg}$$

$$At = 33.64 m \text{/} {s}^{2}$$

Then, having the At, the angular velocity of the rotor is calculated using the following expression:

Wᵣₒₜₒᵣ=\sqrt{At/rᵣₒₜₒᵣ}

Wᵣₒₜₒᵣ=\sqrt{(33.64 m/s²)/1.3} m

Wᵣₒₜₒᵣ=5.0873 rad/s

Having Wᵣₒₜₒᵣ, the conversion to rpm is done

$${W}_{rotor} = 5.0873 \frac{rad}{s} * \frac{1 rev}{2 π} * \frac{60 s}{1 min}$$

$${W}_{rotor} = 5.0873 \frac{rad}{s} * \frac{1 rev}{6.28} * \frac{60 s}{1 min}$$

$${W}_{rotor} = 48.60 rpm$$

The rotor power in hp is calculated:

$${P}_{rotor} = ( \frac{{T}_{rotor}}{0.1183177} ) * ( \frac{{W}_{rotor}}{63000} )$$

$${P}_{rotor} = ( \frac{349906.26 Nm}{0.1183177} ) * ( \frac{48.60}{63000} )$$

$${P}_{rotor} = 2281.61 hp$$

To convert the hp power to kW, it is said that 1 hp=0.746 kW

$$PkW = 2281.61 hp * \frac{0.746 kW}{1 hp}$$

$$PkW = 1702.08 kW$$

$$PMW = \frac{1702.08 kW}{1000}$$

$$PMW = 1.7 MW$$

Rotor Stress Analysis

After calculating the forces to which the rotor will be subject to during its operation, an analysis of the finite elements was done using the (CAD/CAE) programs, where the Von Mises stress, total displacement and safety for of the total ensemble were determined.

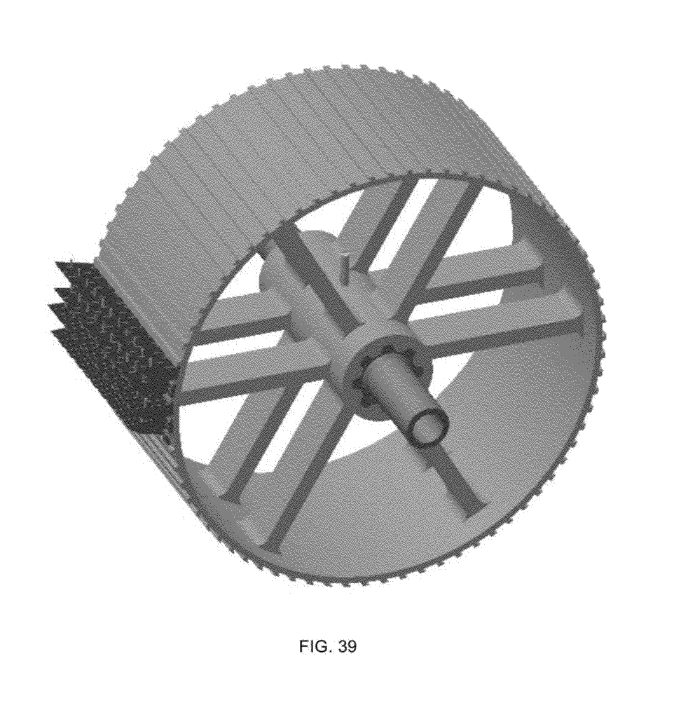

FIG. 39 shows the diagram of the rotor forces where the spheres column weight that descend in the downpipe equal to 27437.17 kg (269158.66N), which make contact with four (4) lines of buckets (42 buckets), in the same instant in time, the force of gravity=9.81 m/s² was also considered.

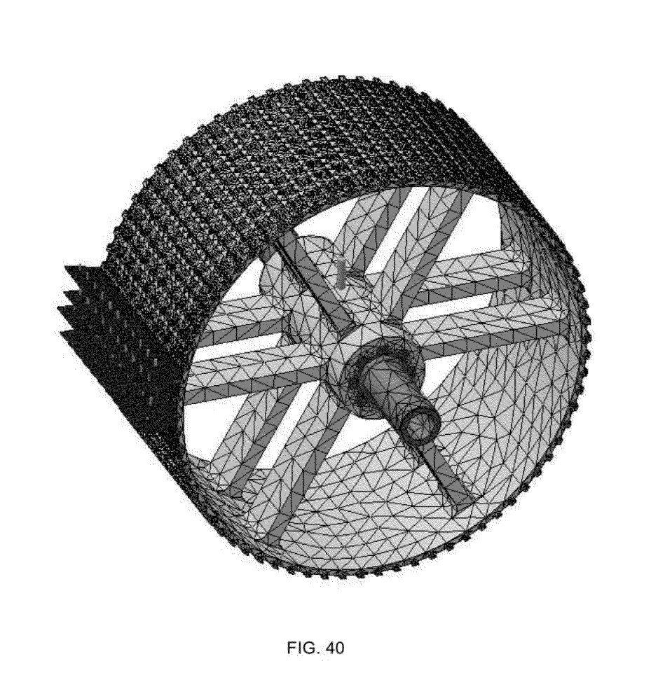

After applying the forces in the assembly of pieces that form the rotor, a geometrical mesh of the piece was done, where the piece is divided in elements and nodes for the local analysis (see FIG. 40).

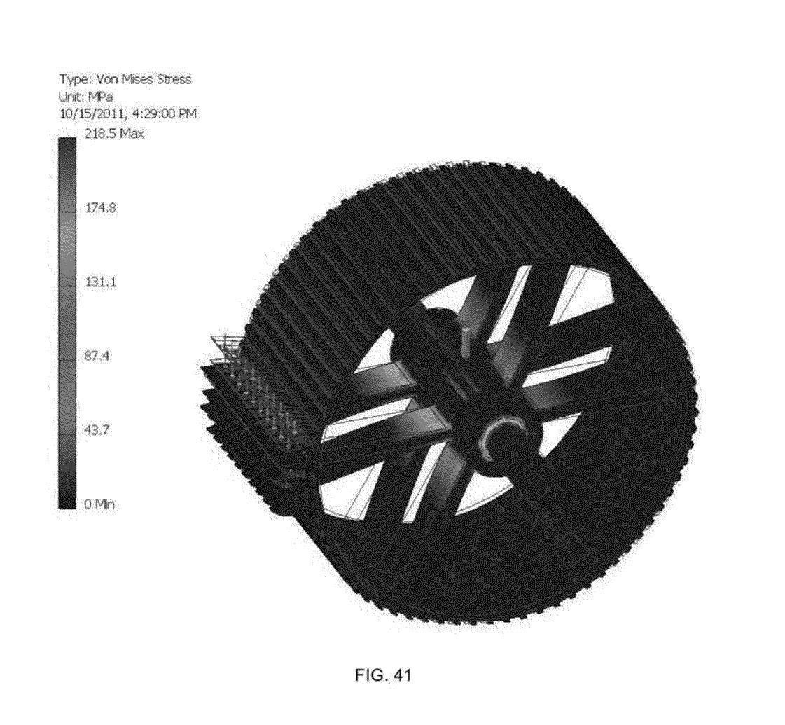

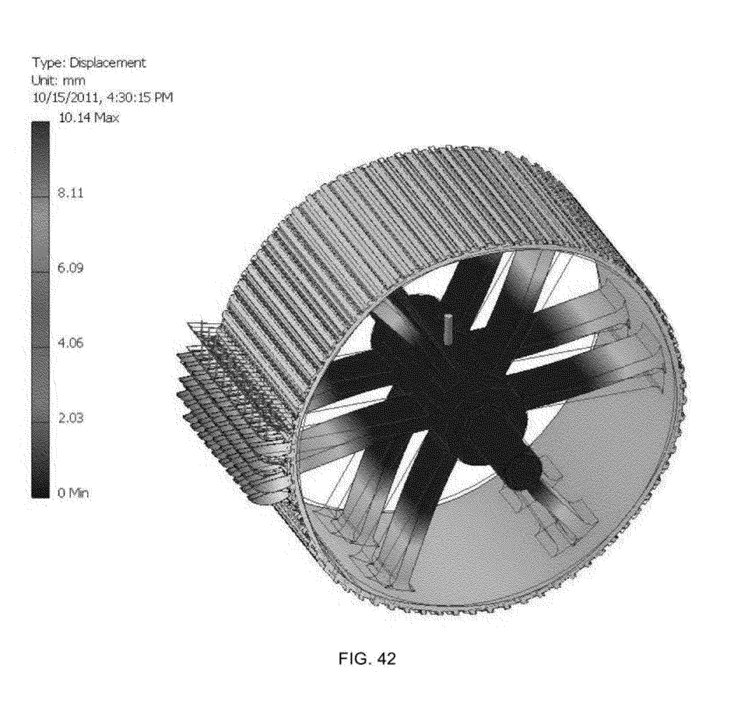

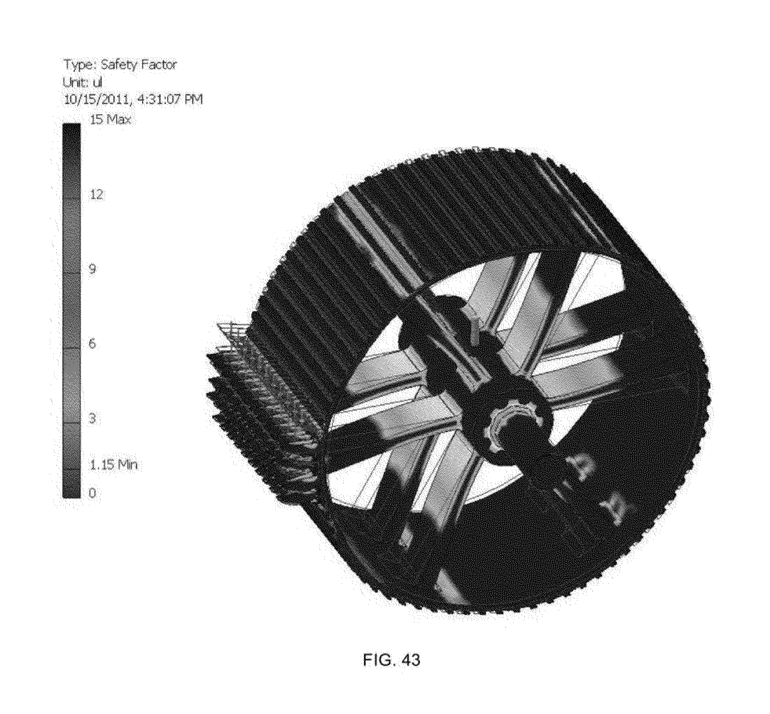

Once the geometrical mesh is finished, the movement restrictions to the system were placed, where it was considered as a critical condition that the rotor-locks and the buckets receive the force exercised by the column of descending spheres. From here, the rotor was analyzed and a Von Mises maximum stress of 218.45 MPa, a total displacement of 10.14 mm, located at the end of the buckets and a minimum safety factor was obtained, as it is shown in FIGS. 41 to 43.

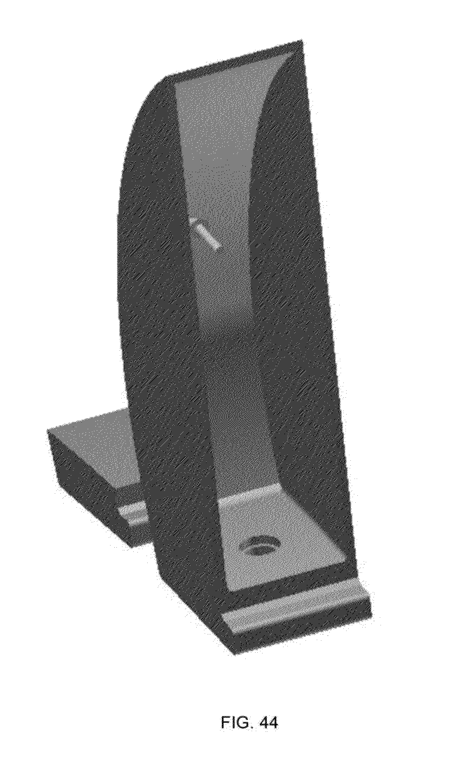

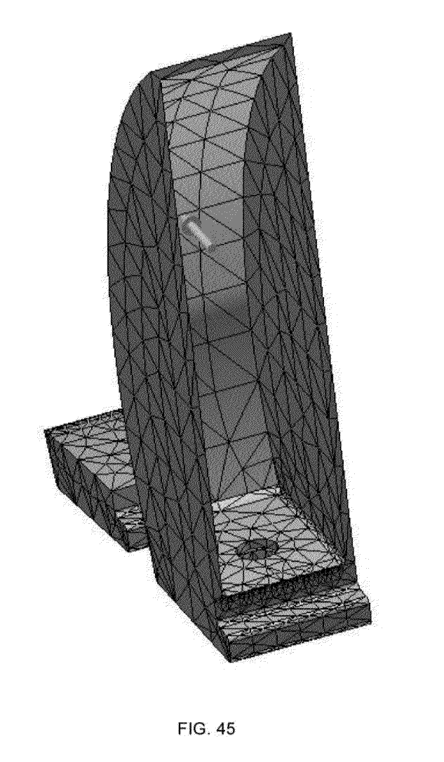

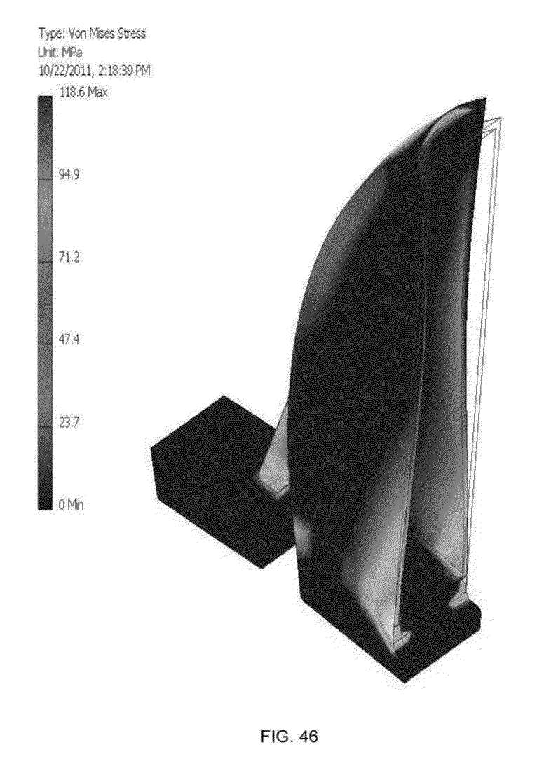

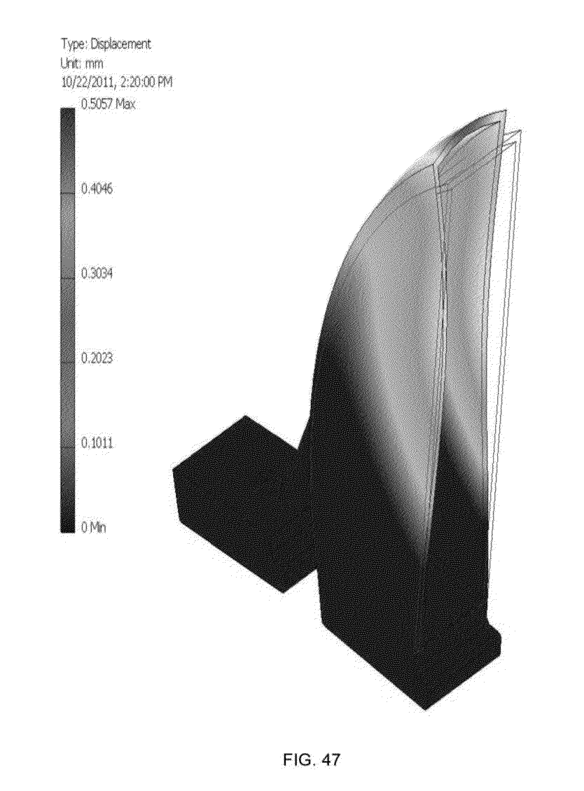

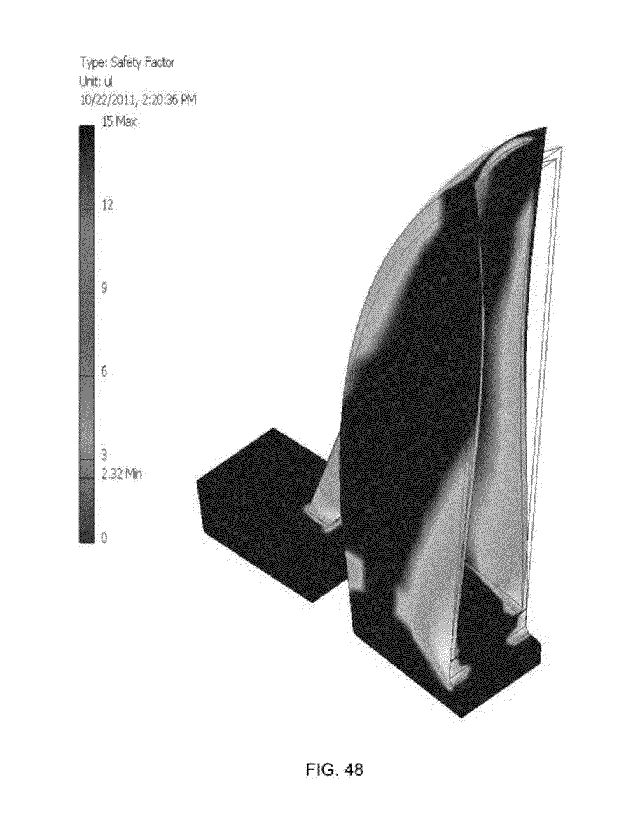

Besides the analysis of the complete ensemble that form the rotor, a bucket was analyzed considering the value of the force exercised by the column of spheres divided into the number of buckets equal to 6408.54N, a geometric mesh of the piece was done and subsequently the analysis of finite elements, where the maximum Von Mises stress of 118.601 MPa, a total displacement of 0.5057 mm at the bucket's end and a minimum safety factor was obtained (see FIGS. 44 to 48).

Design of the Rotor's Shaft

The shaft design was made with the calculation module of the CAD/CAE program, considering as load the torque equal to 349906.26N*m, produced by the spheres falling from the silo; assuming the critical condition in which the rotor-shaft ensemble locks, it was placed on both ends of it but in opposite directions. Besides the torque the shaft was fixed in the section change zone where the bearings will be located.

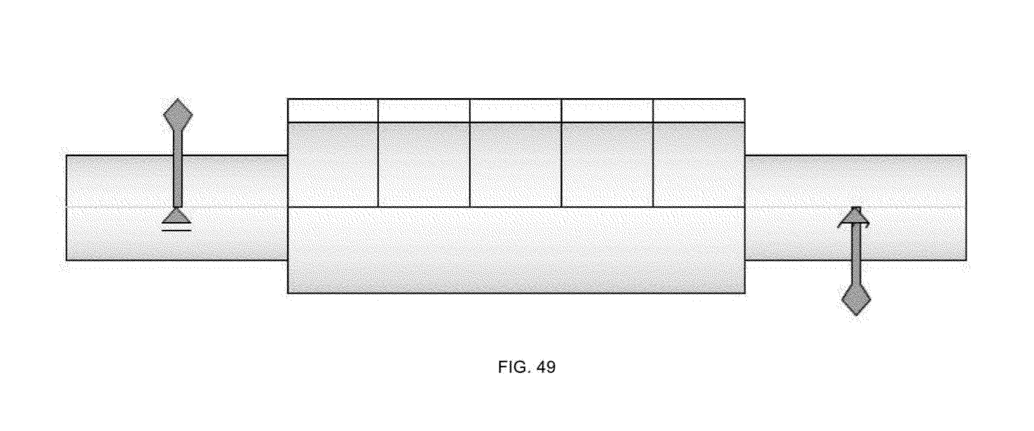

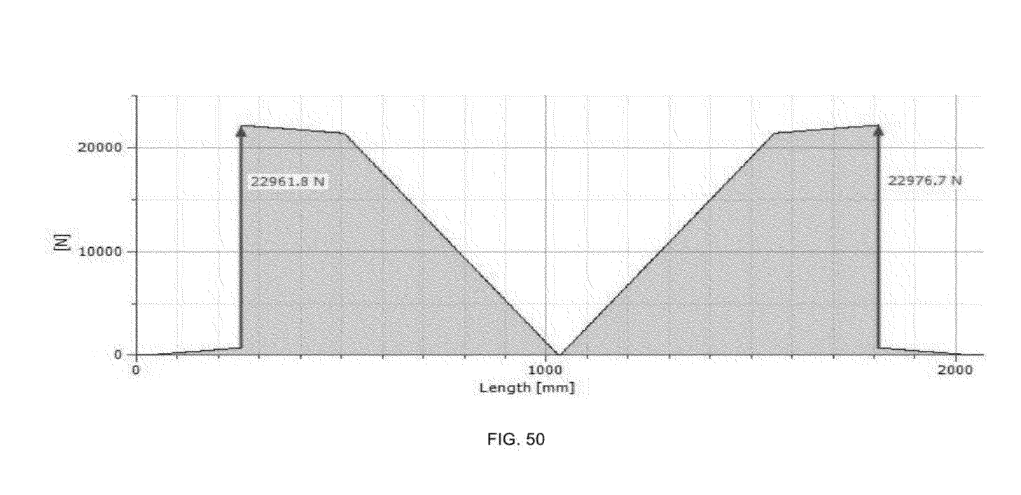

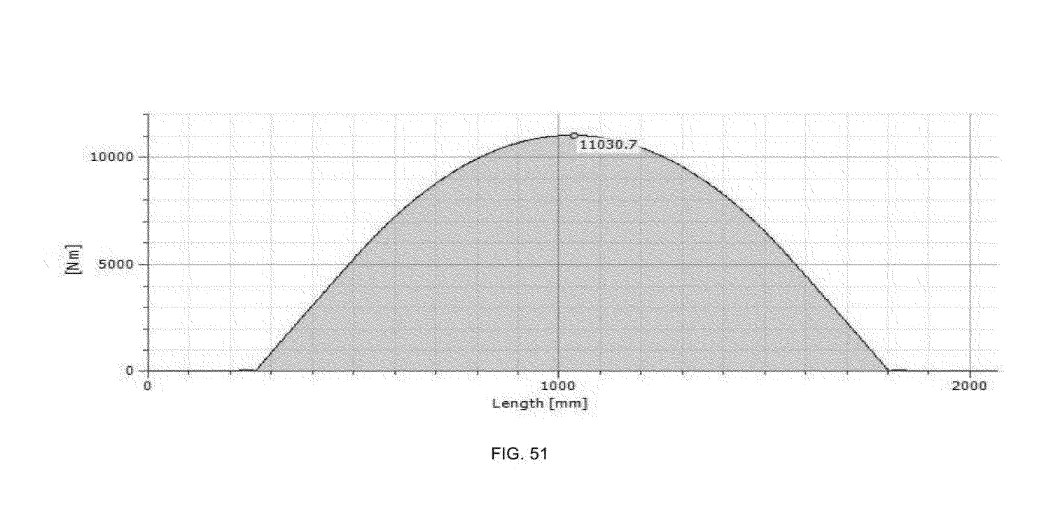

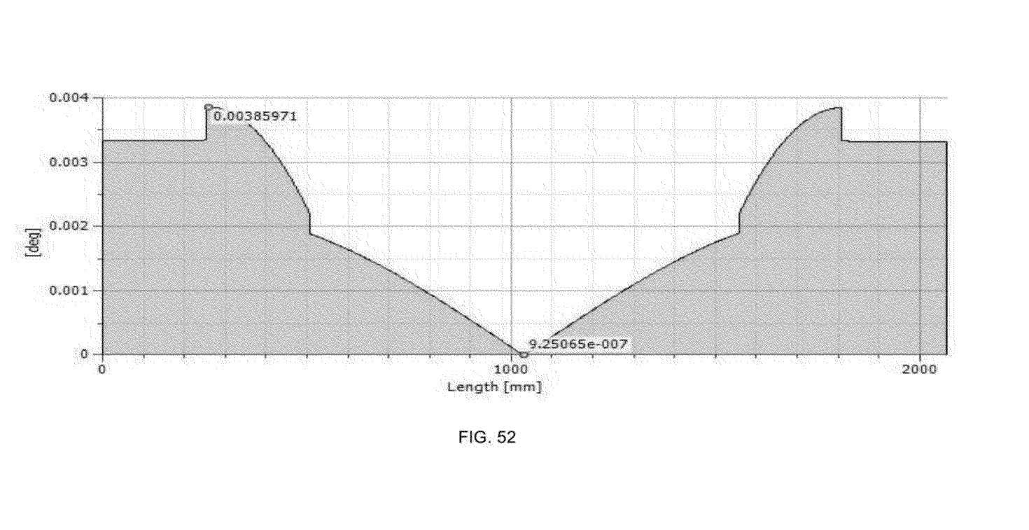

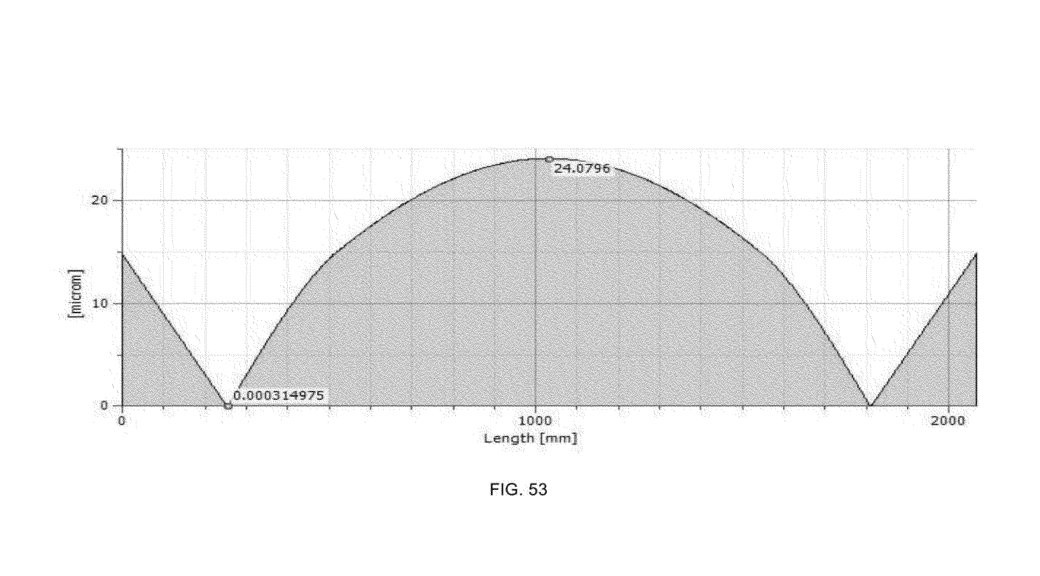

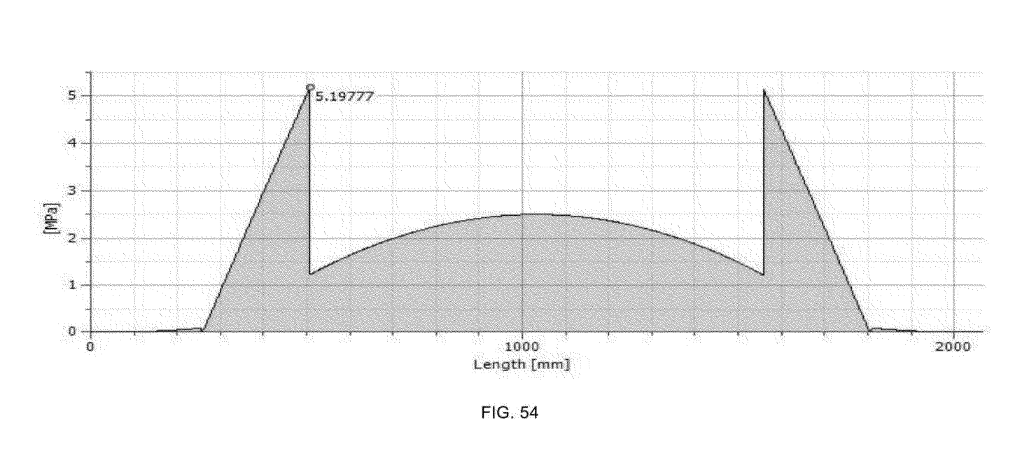

The obtained results of the analysis of the rotor's shaft are shown in table 1 and in FIGS. 49 to 54.

TABLE 1
Rotor's shaft design results.

| | | |
|---|---|---|
| Length | L | 2066.000 mm |
| Mass | Mass | 1183.228 kg |
| Maximal Bending Stress | σ_{B} | 5.198 MPa |
| Maximal Shear Stress | τ_{S} | 0.584 MPa |
| Maximal Torsional Stress | τ | 167.361 MPa |
| Maximal Tension Stress | σ_{T} | 0.000 MPa |
| Maximal Reduced Stress | σ_{red} | 289.926 MPa |
| Maximal Deflection | fₘₐₓ | 24.080 microm |
| Angle of Twist | φ | 0.72 deg |

Design of the Spline Connection of the Rotor's Shaft

The spline connection is a part of the geometry of the shaft; its purpose is to guarantee the greatest transmission of power through the traction that the shaft's teeth and the rotor's core exercise against each other, since they are distributed equidistantly. The spline connection's design was made using the CAD/CAE program, whose design parameters and results are shown below.

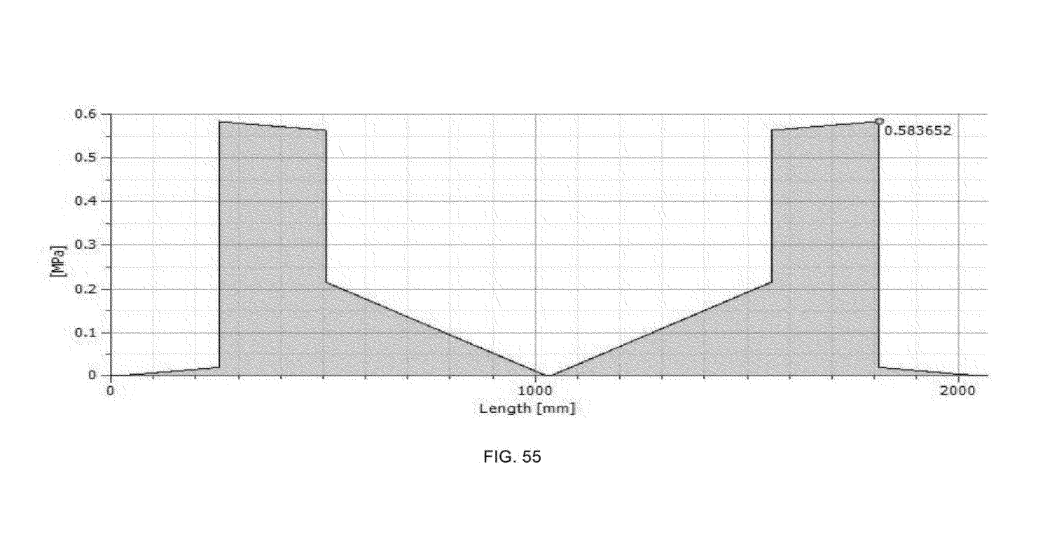

To design the spline connection the torque that is produced by the spheres column descending in the downpipe equal to 349906.26N*m was used. This value was distributed in the contact area of the 8 teeth that form the spline connection. Afterwards, the shaft's geometric mesh was made and the movement restrict ions at the shaft's ends where the bearings are located were placed, assuming as a critical condition the locking of the shaft. (See FIG. 55).

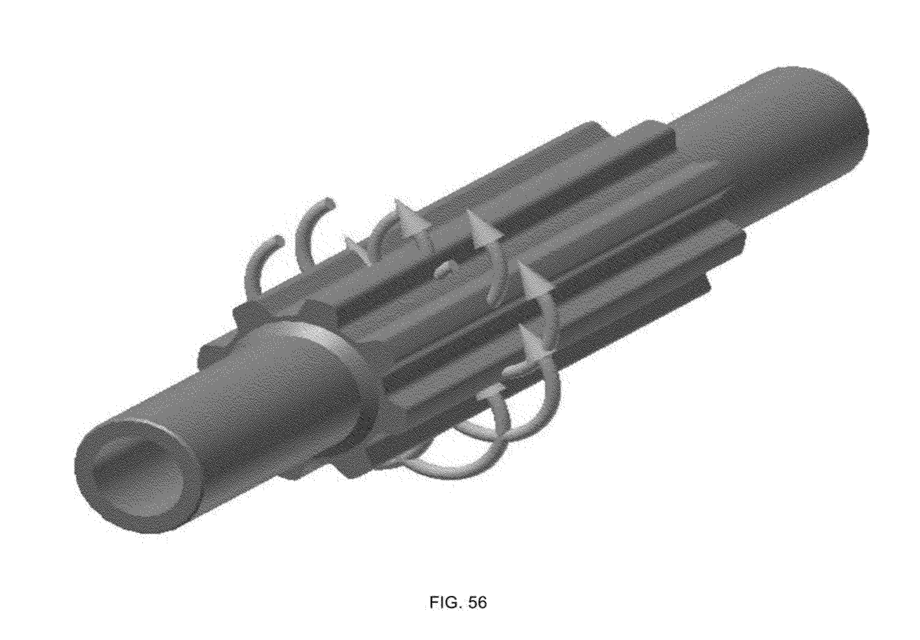

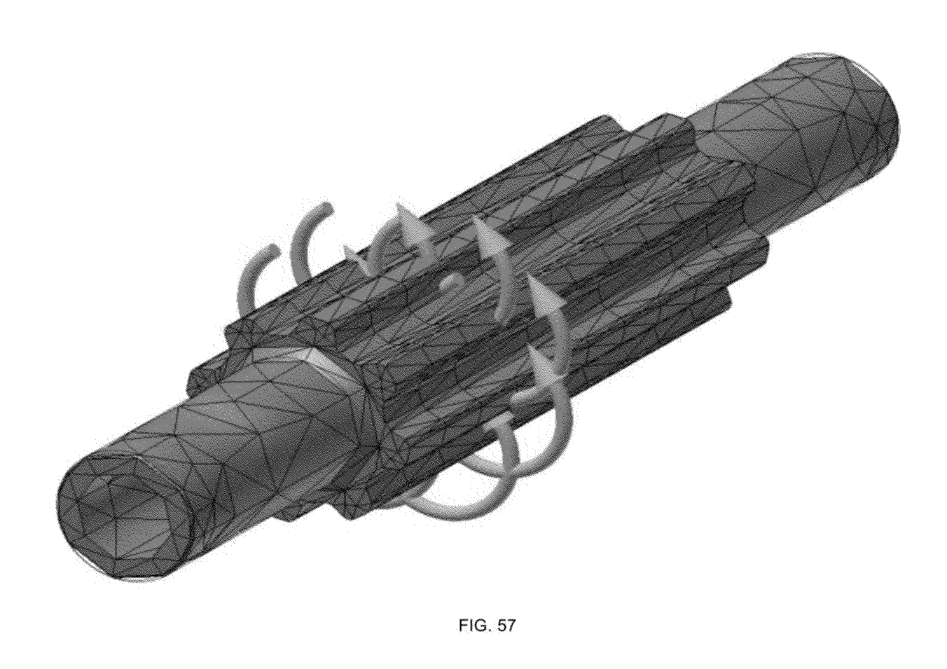

Lastly, the analysis of the finite elements under the conditions of the operation mentioned before, where the results obtained were a maximum Von Mises stress of 240.9 MPa, a total deformation equal to 0.21 mm and a minimum safety factor, as observed in FIGS. 56 to 58.

Design of the Rotor's Shaft Bearings

For the bearings design a radial load of 269159 N was used, which is equivalent to the rotor's weight, buckets, bolts and the force produced by the spheres as they make the rotor spin, and a 10% of this axial load equal to 26916 N, besides this a rotation velocity of 48.60 rpm, a shaft diameter of 220.000 mm, and a minimum safety factor.

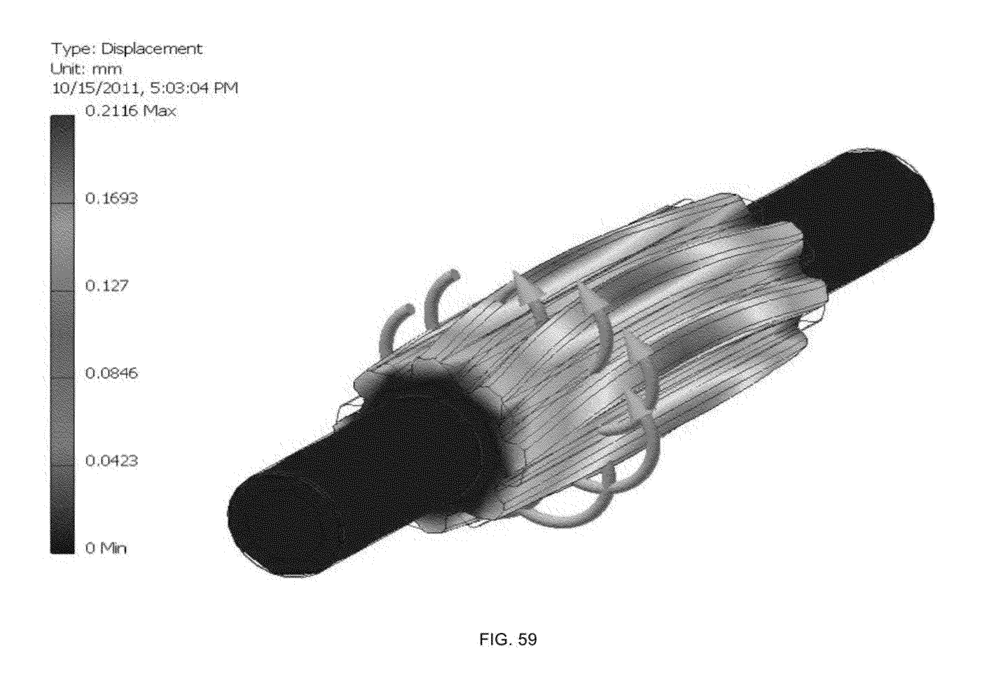

The results for the bearings calculations were based on the ANSI/AFBMA 9-1990 (ISO 281-1990) method, and were made in a calculations module of the CAD/CAE program, shown on tables 2 to 5 and in FIG. 59.

TABLE 2
Specifications of the bearing

| | | |
|---|---|---|
| Designation | | BS 292: Part 1 (V) (Metric) (N 244- |
| | | 220 × 400 × 65) |
| Bearing inside diameter | d | 220.000 mm |
| Bearing outside diameter | D | 400.000 mm |
| Bearing width | B | 65.000 mm |
| Nominal contact angle of the | α | 0 deg |
| bearing | | |
| Basic dynamic load rating | C | 765000 N |
| Basic static load rating | C₀ | 1080000 N |
| Dynamic radial load Factor | X | 0.60 ul/0.60 ul |
| Dynamic axial load Factor | Y | 0.50 ul/0.50 ul |
| Limit value of F a/Fr | e | 0.30 ul |
| Static radial load Factor | X₀ | 0.60 ul |
| Static axial load Factor | Y₀ | 0.50 ul |

TABLE 3
Calculation of bearing life

| | | |
|---|---|---|
| Calculation Method | | ANSI/AFBMA 9-1990 (ISO 281-1990) |
| Required rating life | L_{req} | 8760 hr |
| Required reliability | R_{req} | 90 ul |
| Life adjustment factor | a₂ | 1.00 ul |
| for special bearing | | |
| properties | | |
| Life adjustment factor | a₃ | 1.00 ul |
| for operating conditions | | |
| Working temperature | T | 35° C. |
| Factor of Additional | f_{d} | 1.00 ul |
| Forces | | |

TABLE 4
Type of lubrication for the bearing

| | | |
|---|---|---|
| Friction factor | μ | 0.0011 ul |
| Lubrication | | Oil |

TABLE 5
Bearing calculation results for the rotor shaft

| | | |
|---|---|---|
| Basic rating life | L₁₀ | 11153 hr |
| Adjusted rating life | Lₙₐ | 11153 hr |
| Calculated static safety factor | s_{0c} | 4.01250 ul |
| Power lost by friction | P_{z} | 165.75194 W |
| Necessary minimum load | Fₘᵢₙ | 21600 N |
| Static equivalent load | P₀ | 269159 N |
| Dynamic equivalent load | P | 269159 N |
| Over-revolving factor | kₙ | 0.000 ul |
| Life adjustment factor for reliability | a₁ | 1.00 ul |
| Temperature factor | fₜ | 1.00 ul |
| Equivalent speed | nₑ | 49 rpm |
| Minimum speed | nₘᵢₙ | 49 rpm |
| Maximum speed | nₘₐₓ | 49 rpm |

| | |
|---|---|
| Strength Check | Positive |

Design of the Chain Conveyor System (Lift System)

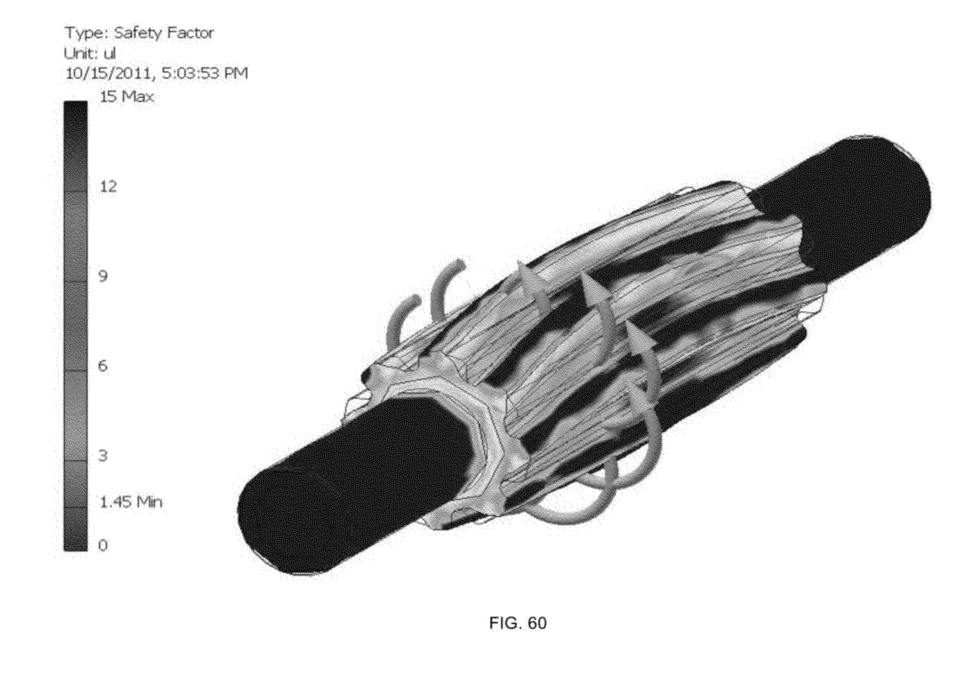

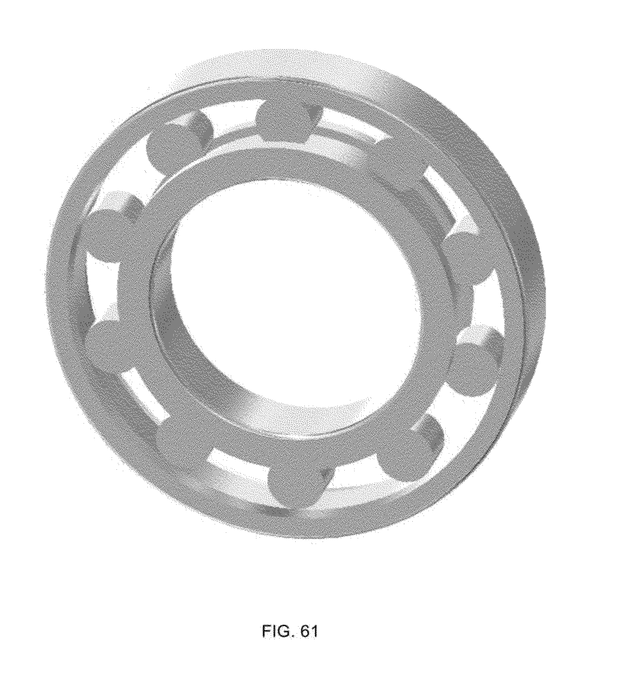

The conveyor system consists of the chain, sprockets and buckets. To elaborate the chain and sprockets, two types of links were designed, a standard one and one to hold the buckets, which is similar to the standard link with a pierced 90° support, added to it. The parameters considered for the stress, deformation and safety factor analysis were the height of the lift system equal to 29 m, the load to be transported including the bucket's weight and the chain's weight equal to 16733.46 kg (164155.23 N). In FIG. 49 the forces diagram of the chain-sprocket-Shaft-buckets ensemble is shown, where the tension force caused by the weight of the buckets loaded with spheres equals 101967.720 N, the forces of compression exerted by the spheres inside the buckets located in the top sprocket's equals 1008.988 N and the value of the gravity force equals 9.81 m/s². Then the geometrical mesh of the ensemble is done to make the analysis of the finite elements using the CAD/CAE programs (see FIG. 60).

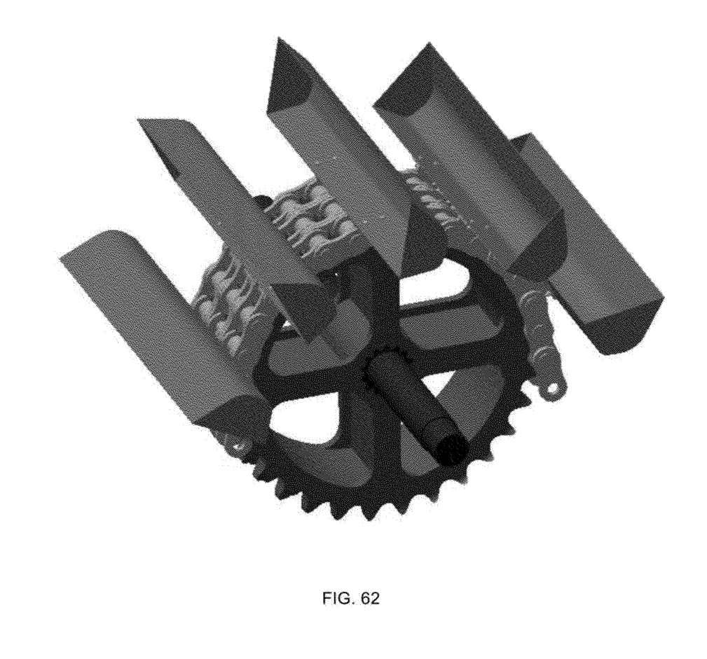

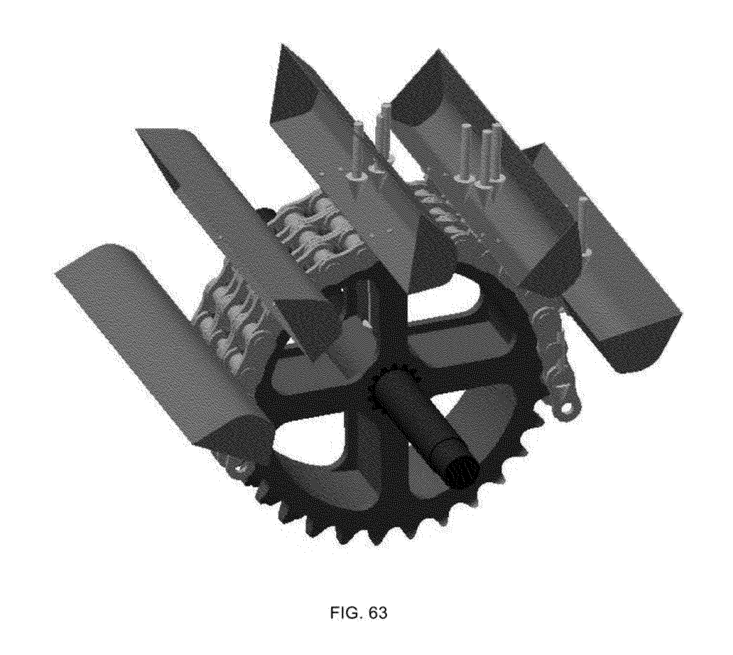

The results of the finite element analysis (Von Mises stress, total deformation and safety factor), for the sprockets-shaft-buckets ensemble is shown in table 6 and in FIGS. 61 to 63.

TABLE 6
Results of finite element analysis of the chain conveyor system
(Lift System).

| Name | Minimum | Maximum |
|---|---|---|
| Von Mises Stress | 0.0000000317789 MPa | 271.657 MPa |
| Displacement | 0 mm | 4.4141 mm |
| Safety Factor | 1.01451 ul | 15 ul |

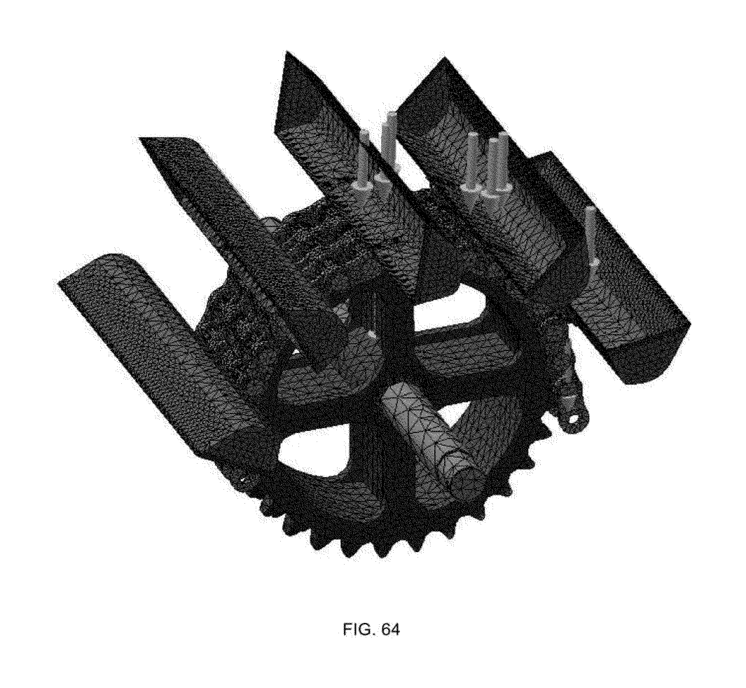

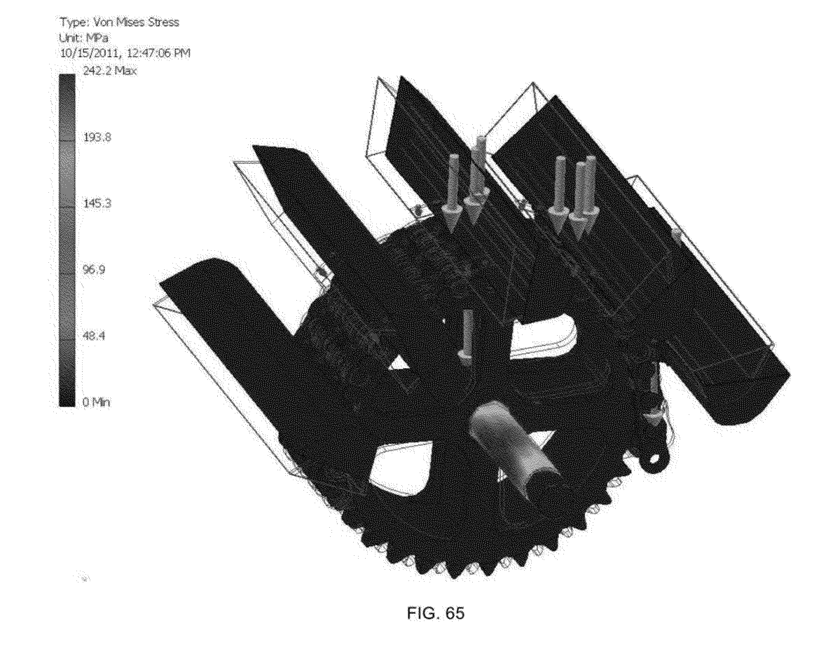

The design of the chain was made using the calculation module for power transmission of the CAD/CAE program, the chain was designed under the ISO 606:2004 regulations, the model 56B-3-673 with the properties shown of tables 7 to 11 and the FIGS. 64 to 65, where each one of the geometrical parameters are shown, including the links, pins and bushings as well as the sprockets and the chain power curve.

TABLE 7
Properties of the chain (Lift System)
Chain: ISO 606:2004 - Short-pitch transmission precision roller chains
(EU)

| | | |
|---|---|---|
| Chain size designation | | 56B-3-673 |
| Pitch | p | 88.900 mm |
| Number of Chain Links | X | 673.000 ul |
| Number of Chain Strands | k | 3.000 ul |
| Minimum width between inner | b₁ | 53.340 mm |
| plates | | |
| Maximum Roller Diameter | d₁ | 53.980 mm |
| Maximum pin body diameter | d₂ | 34.320 mm |
| Maximum inner plate depth | h₂ | 77.850 mm |
| Maximum outer or intermediate | h₃ | 77.850 mm |
| plate | | |
| depth | | |
| Maximum width over bearing pins | b | 327.800 mm |
| Maximum inner plate width | t₁ | 13.600 mm |
| Maximum outer or intermediate | t₂ | 12.300 mm |
| plate width | | |
| Transverse pitch | pt | 106.600 mm |
| Chain bearing area | A | 8371.000 mm² |
| Tensile Strength | Fᵤ | 2240000.000 N |
| Specific Chain Mass | m | 105.000 kg/m |
| Chain construction factor | φ | 1.000 ul |

TABLE 8
Working Conditions in the chain (lift system).

| | | |
|---|---|---|
| Power | P | 118.986 kW |
| Torque | T | 43701.420 Nm |
| Speed | n | 26.000 rpm |
| Efficiency | η | 0.980 ul |
| Required service life | Lₕ | 5000.000 hr |
| Maximum chain elongation | ΔLₘₐₓ | 0.030 ul |
| Application | | Heavy shocks |
| Environment | | Clean |
| Lubrication | | Recommended (see notes below) |

TABLE 9
Sprocket properties: Toothed Sprocket

| | |
|---|---|
| Type | Driver sprocket |

| | | | |
|---|---|---|---|
| Number of Teeth | z | 30.000 | ul |
| Number of Teeth in Contact | z_{c} | 15.000 | ul |
| Pitch Diameter | Dₚ | 850.486 | mm |
| Number of strands | k | 3.000 | ul |
| Transverse pitch | pₜ | 106.600 | mm |
| Seating clearance | SC | 0.270 | mm |
| Tooth width | b_{f} | 49.606 | mm |
| tooth side relief | bₐ | 11.557 | mm |
| Tooth side radius | rₓ | 88.900 | mm |
| Shroud diameter | Dₛ | 750.151 | mm |
| Sprocket shroud width | bₛ | 262.806 | mm |
| Height of tooth above pitch | hₐ | 26.670 | mm |
| polygon | | | |
| Roller-seating radius | rᵢ | 27.260 | mm |
| Tooth-flank radius | rₑ | 207.283 | mm |
| Roller-seating angle | α | 137.00 | deg |
| Shroud fillet radius | rₐ | 3.556 | mm |
| Sprocket tip diameter | Dₐ | 899.167 | mm |
| Sprocket root diameter | D_{f} | 795.966 | mm |
| Measuring pin diameter | D_{g} | 53.980 | mm |
| Measurement over pins | M_{R} | 904.466 | mm |
| X coordinate | x | 28589.892 | mm |
| Y coordinate | y | −31.470 | mm |
| Span Length | L_{f} | 28581.319 | mm |
| Power Ratio | Pₓ | 1.000 | ul |
| Power | P | 118.986 | kW |
| Torque | T | 43701.420 | N m |
| Speed | n | 26.000 | rpm |
| Moment of inertia | I | 0.000 | kg m² |
| Arc of contact | β | 180.00 | deg |

| | | |
|---|---|---|
| Force on input | F₁ | 102908.861N |
| Force on output | F₂ | 140.756N |
| Axle load | Fᵣ | 103049.618N |

TABLE 10
Power correction factors

| | | |
|---|---|---|
| Shock factor | Y | 2.500 ul |
| Service factor | f₁ | 1.700 ul |
| Sprocket size factor | f₂ | 1.000 ul |
| Strands factor | f₃ | 4.600 ul |
| Lubrication factor | f₄ | 0.600 ul |
| Center distance factor | f₅ | 0.690 ul |
| Ratio factor | f₆ | 0.870 ul |
| Service life factor | f₇ | 1.535 ul |

TABLE 11
Results

| Chain Speed | v | 1.158 | mps |
|---|---|---|---|
| Effective pull | Fₚ | 102768.105N | |
| Centrifugal force | F_{C} | 140.756N | |
| Maximum tension in chain span | F_{Tmax} | 102908.861N | |
| Static safety factor | S_{S} > S_{Smin} | 21.767 ul > 7.000 ul | |
| Dynamic safety factor | S_{D} > S_{Dmin} | 8.707 ul > 5.000 ul | |
| Bearing pressure | p_{B} < p₀ * λ | 12.293 | MPa |
| Design power | P_{D} < P_{R} | 186.409 | kW |
| Chain power rating | P_{R} | 320.417 | kW |
| Chain service life for specified | tₕ > Lₕ | 275363 | hr |
| elongation | | | |
| Chain link plates service life | t_{HI} > Lₕ | 5721 | hr |
| Roller and bushing service life | tₕᵣ > Lₕ | 2777778 | hr |

Design of the Shaft for the Chain Conveyor System

The design of the shaft for the chain conveyor system was made with the calculation module of the CAD/CAE program, considering as loads a torque equal to 43701.42N*m, which is the torque that must be applied to elevate to 29 m a weight of 10359.96 Kg equivalent to the total of spheres to be elevated, the weight of the chain and the weight of the buckets, assuming as the critical condition the locking of the sprocket-shaft ensemble, the torque was put on both ends of the shaft but in opposite direction. Besides the torque the shaft was fixed on the section change zone where the bearings will be placed.

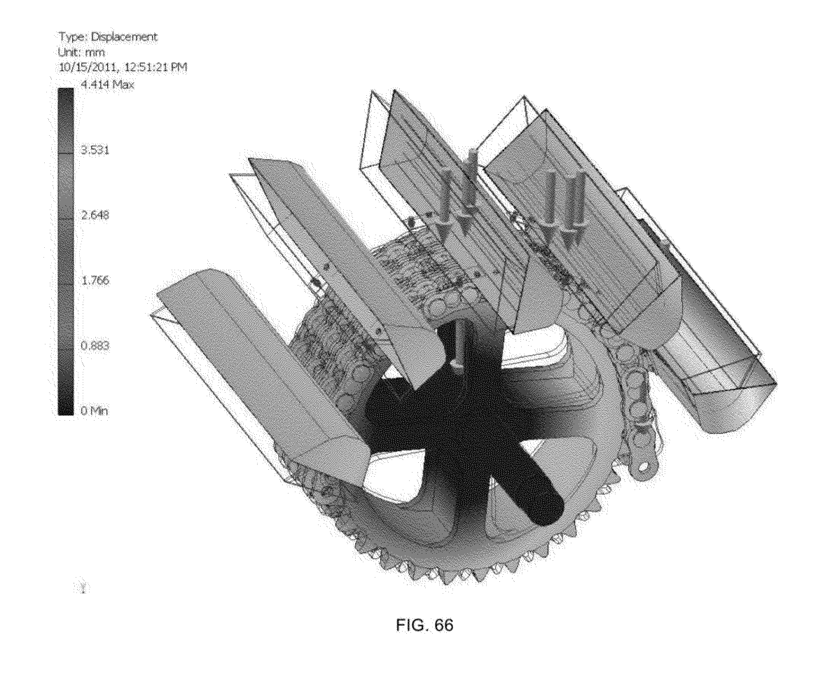

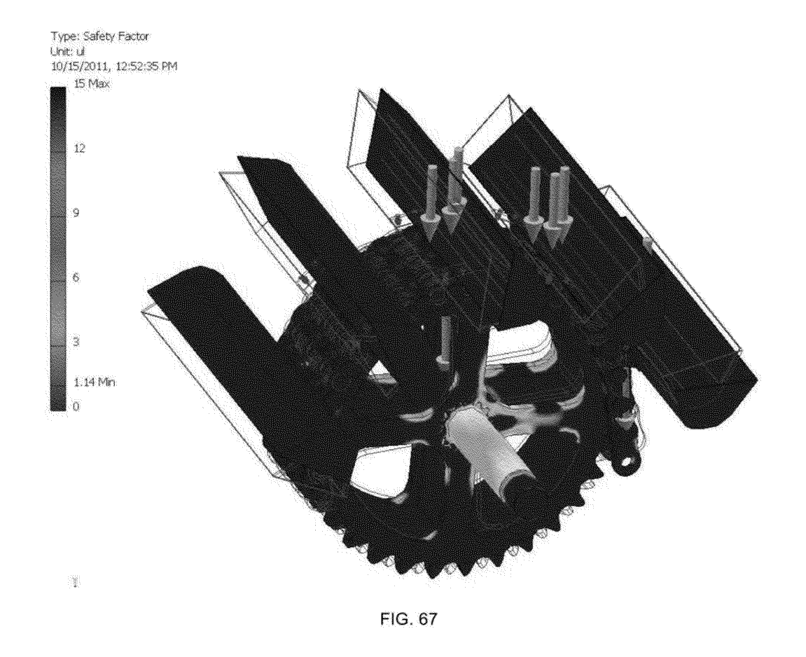

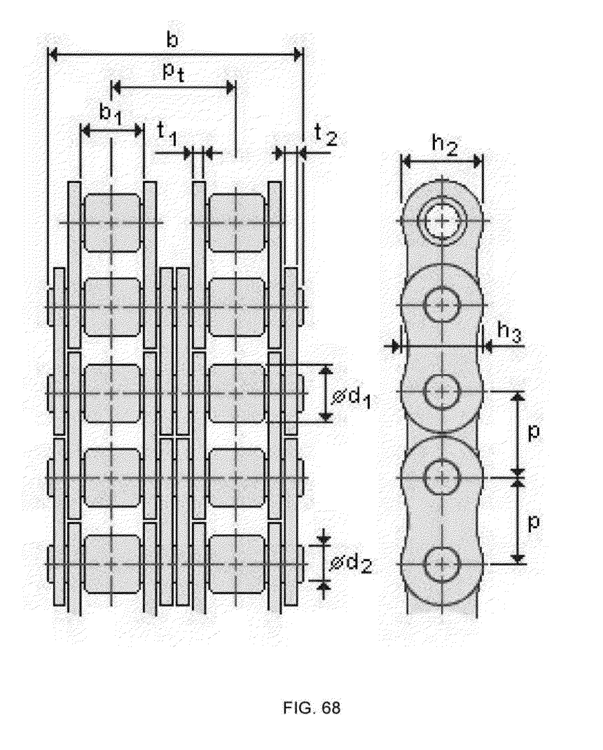

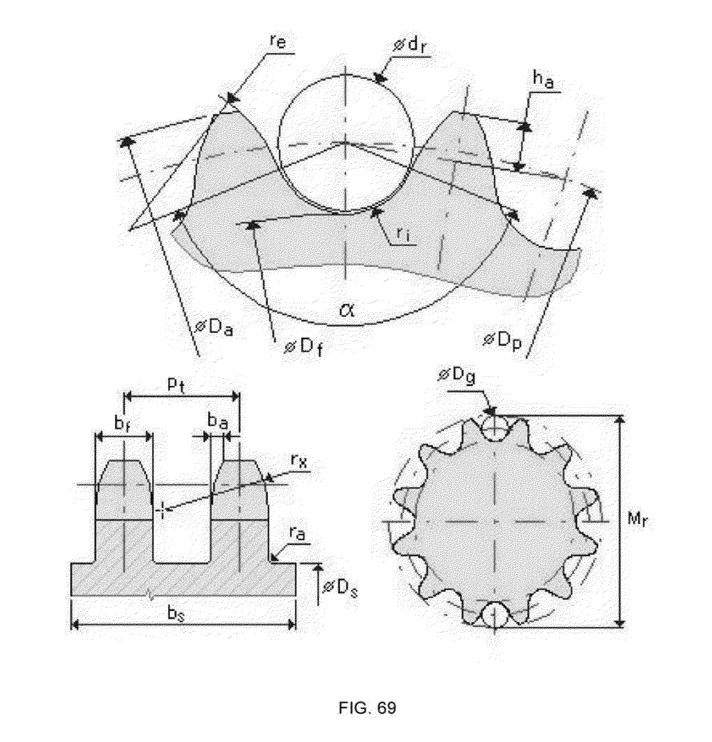

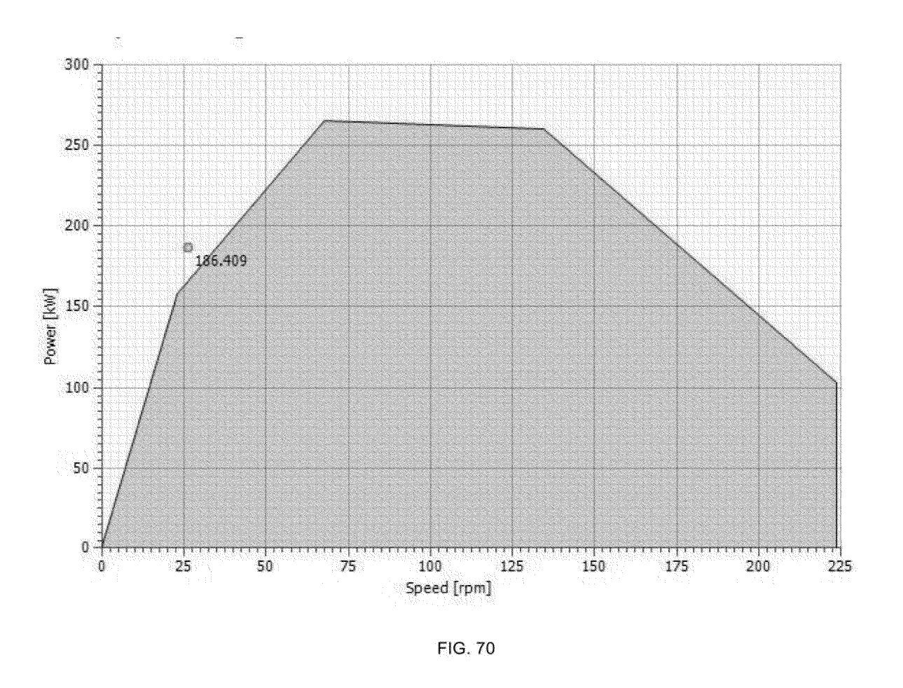

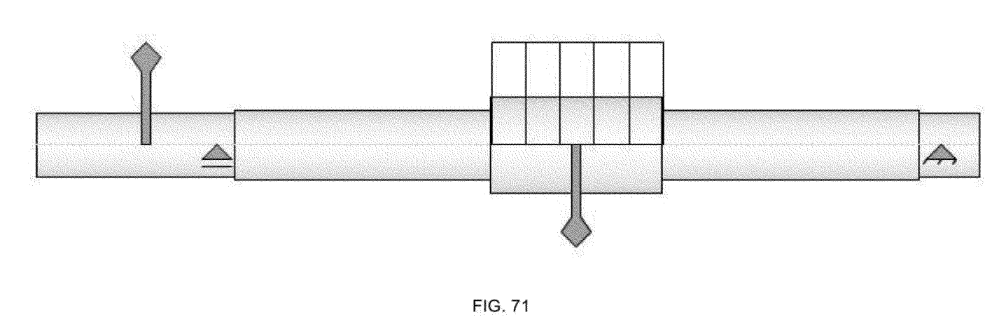

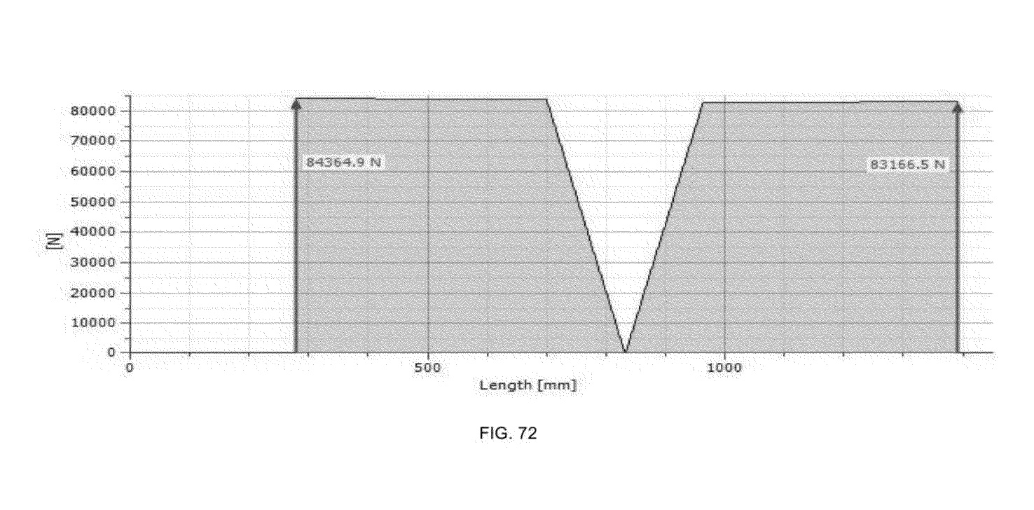

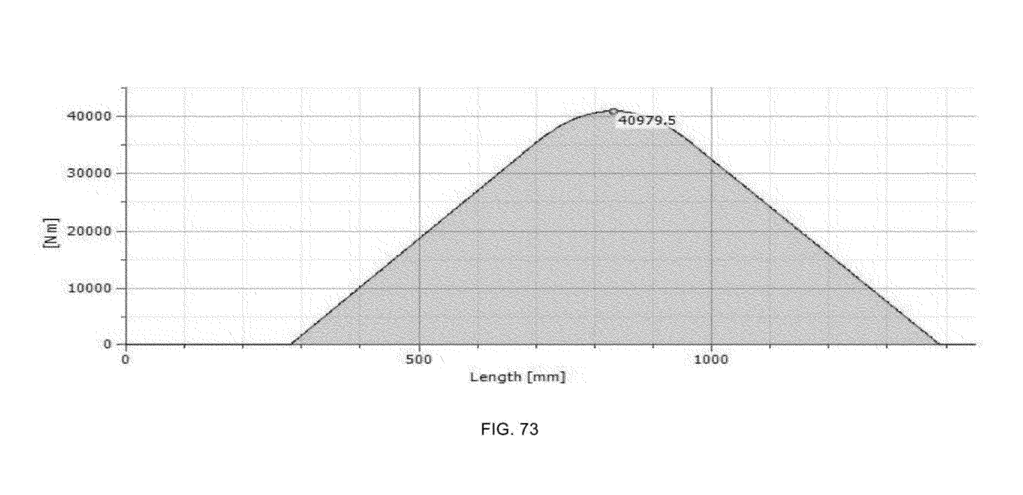

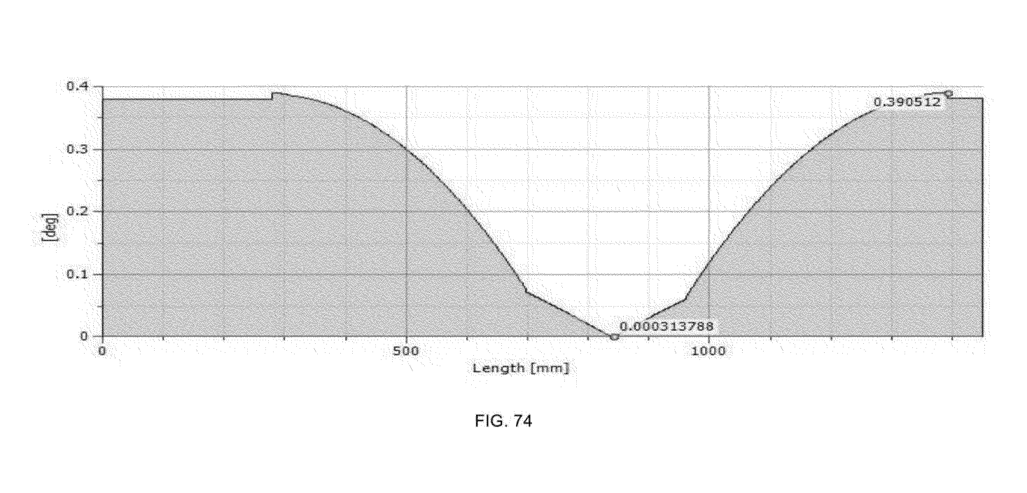

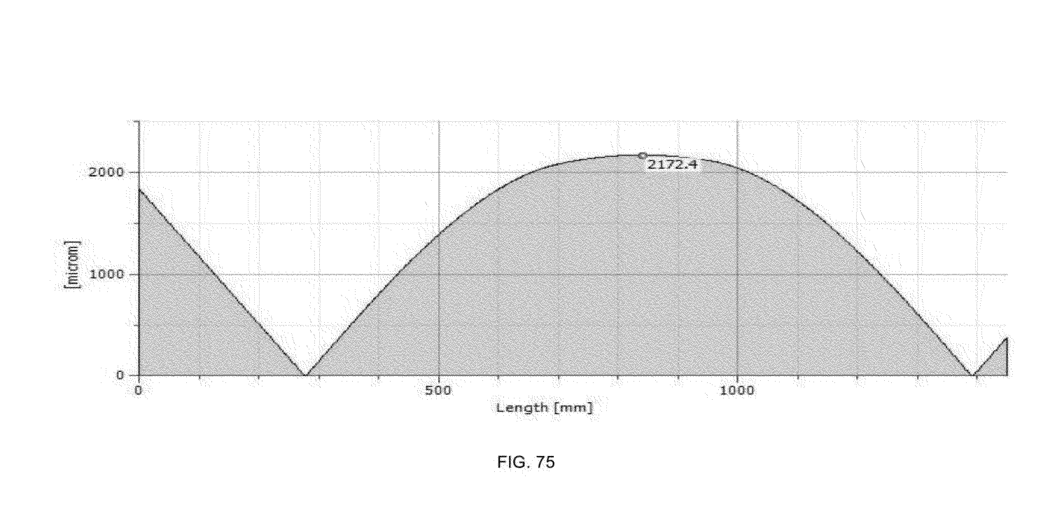

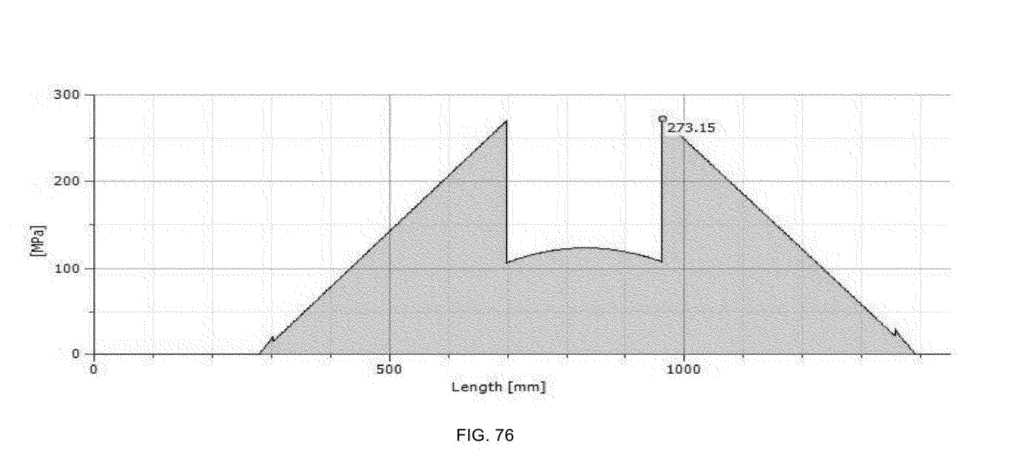

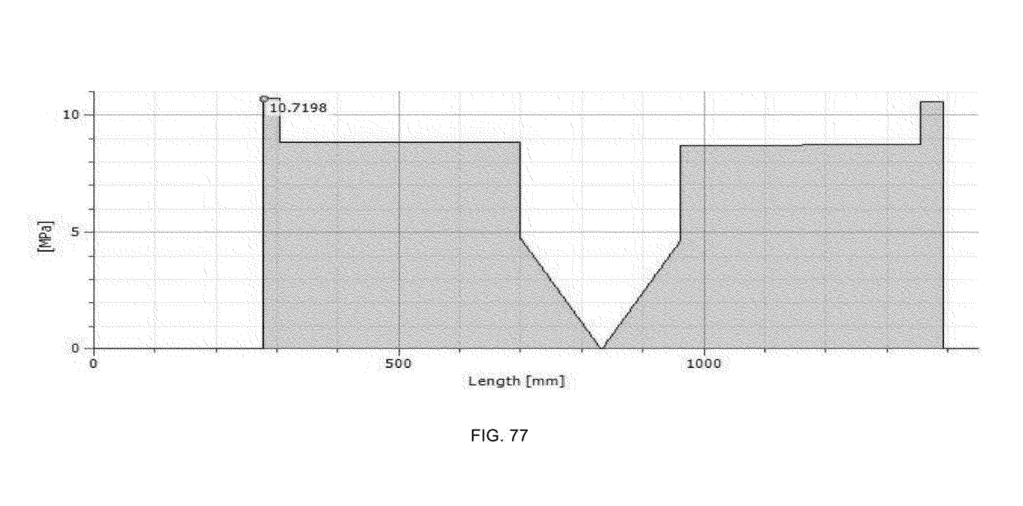

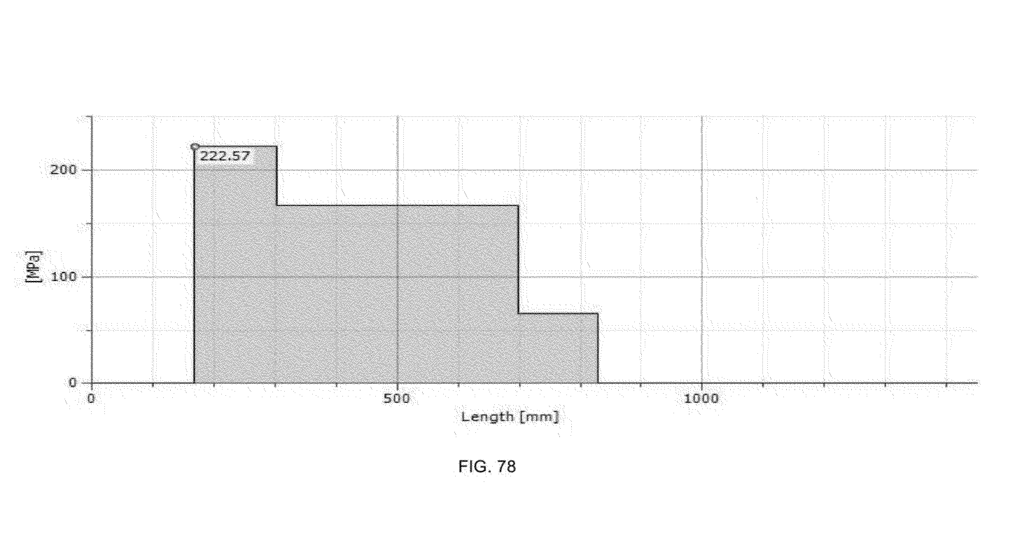

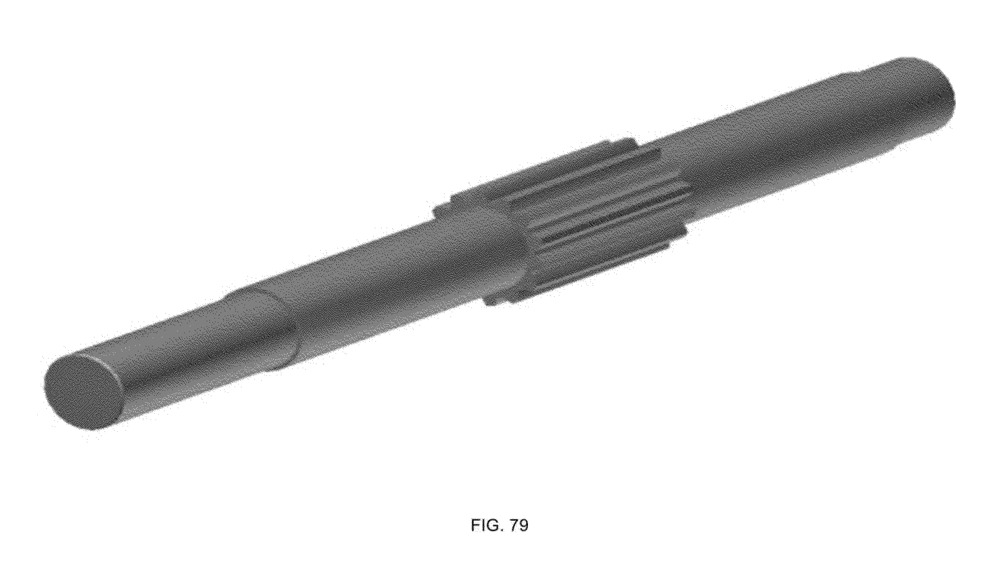

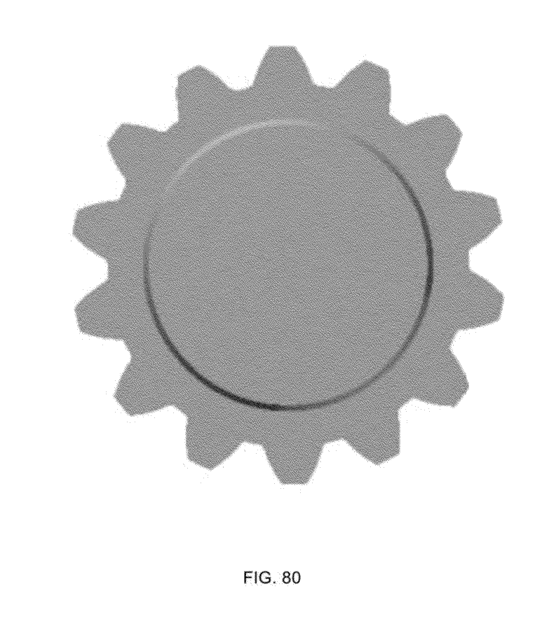

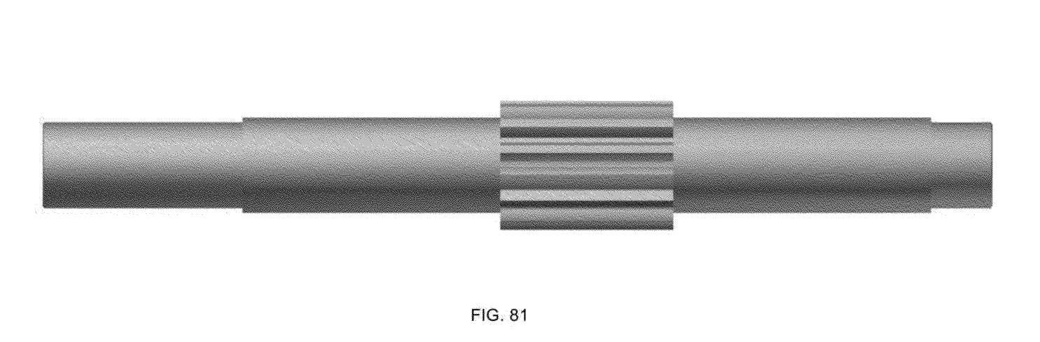

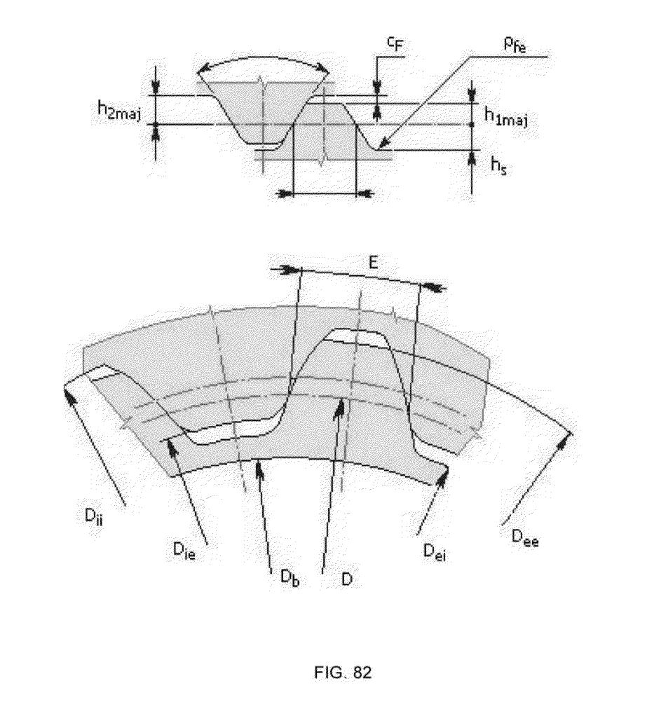

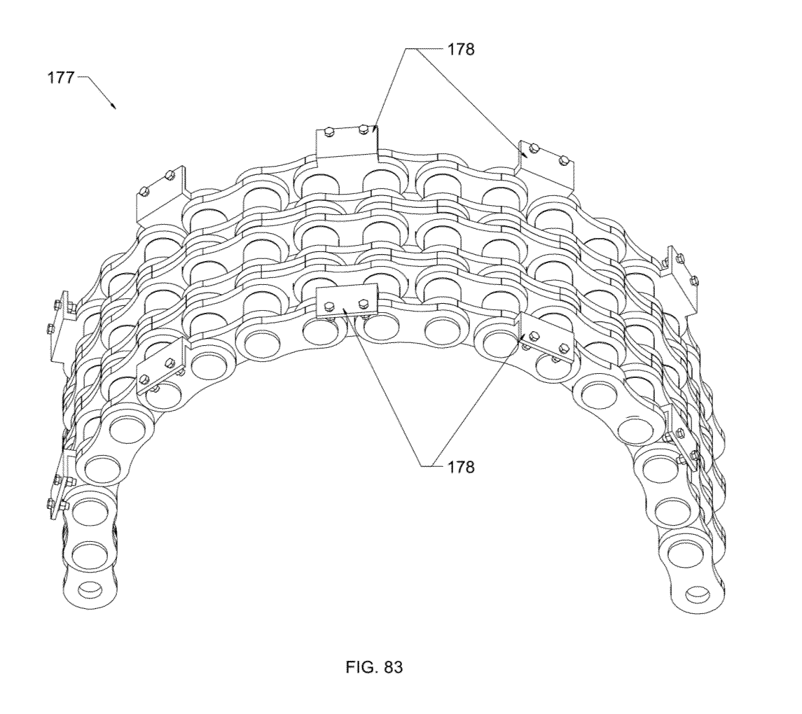

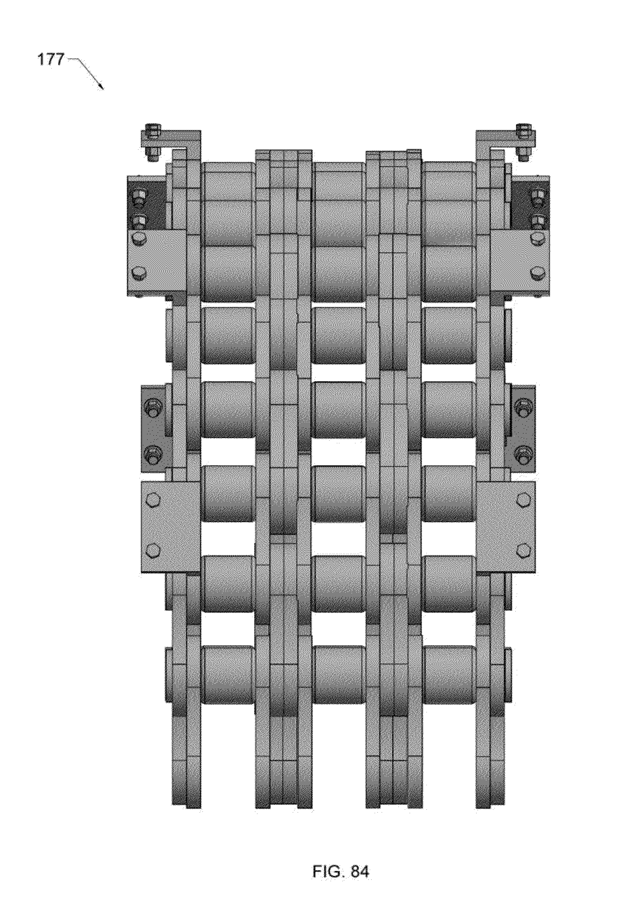

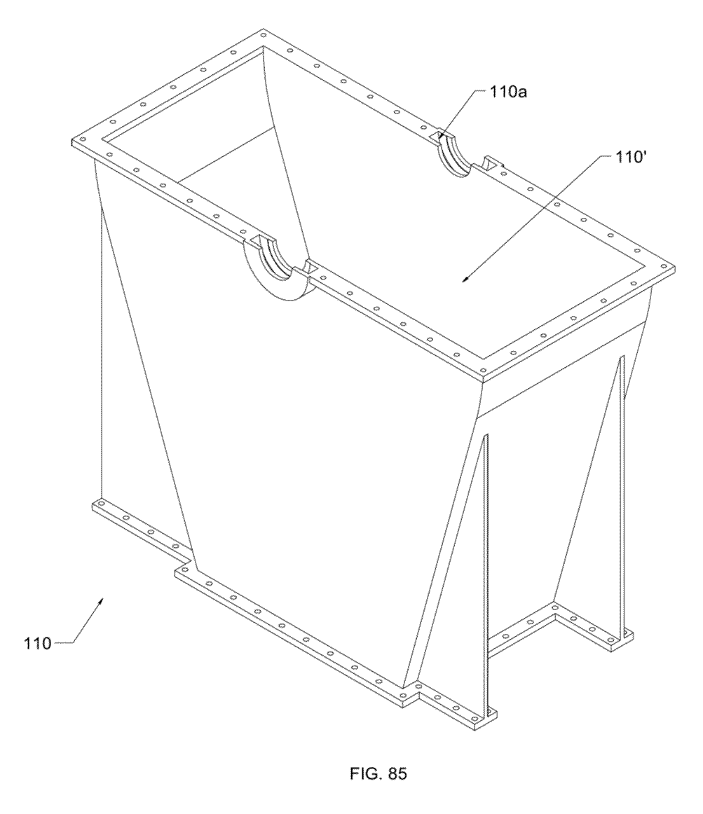

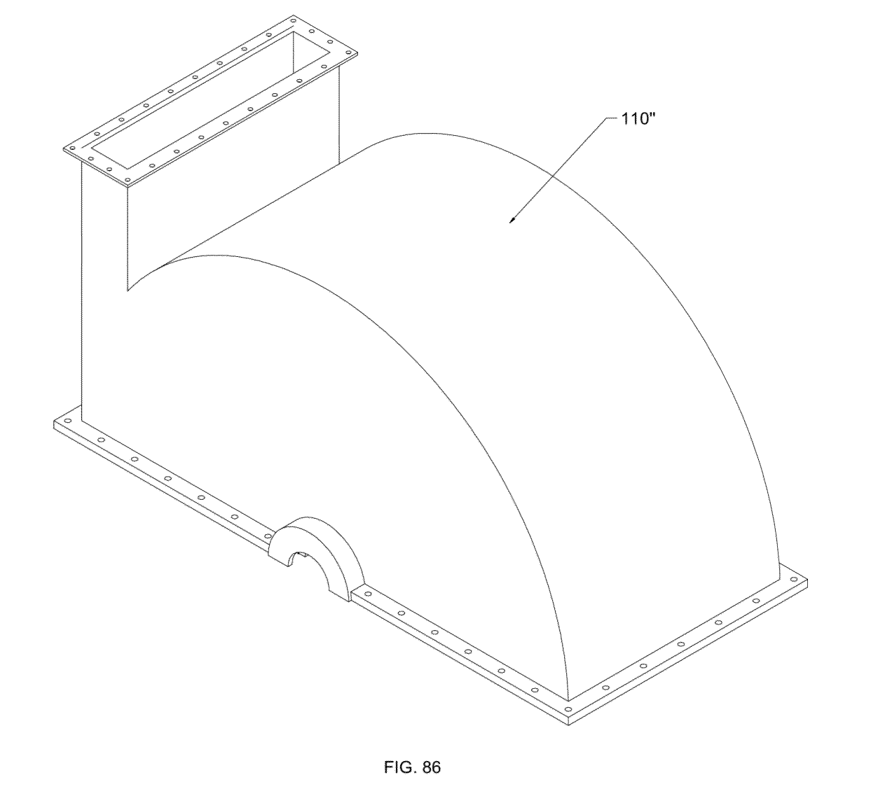

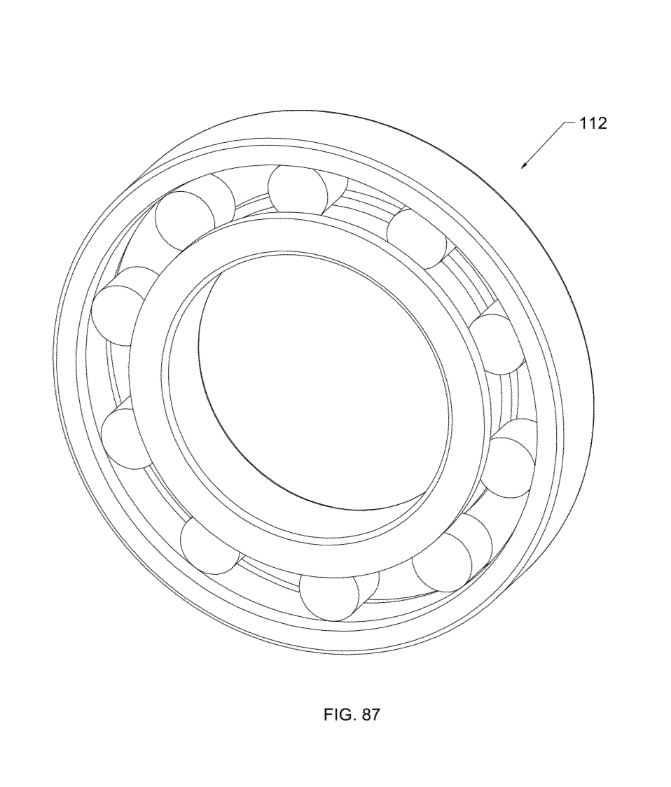

The results obtained from the analysis are shown in table 12 and in FIGS. 66 to 73.

TABLE 12
Results of the shaft of the chain conveyor system

| | | | |
|---|---|---|---|
| Length | L | 1449.573 | mm |
| Mass | Mass | 122.601 | kg |
| Maximal Bending Stress | σ_{B} | 273.150 | MPa |
| Maximal Shear Stress | τₛ | 10.720 | MPa |
| Maximal Torsional Stress | τ | 222.570 | MPa |
| Maximal Tension Stress | σ_{T} | 0.000 | MPa |
| Maximal Reduced Stress | σ_{red} | 396.369 | MPa |
| Maximal Deflection | fₘₐₓ | 2172.397 | microm |
| Angle of Twist | φ | 1.51 | deg |

Design of the Shaft's Spline Connection of the Chain Conveyor System

The spline connection is a part of the shaft's geometry for the chain conveyor system; its purpose is to guarantee the greatest transmission of power through the traction that the spline connection's teeth offer, given that they are distributed equidistantly. The design of the spline connection was made using the CAD/CAE program, whose design's results parameters are shown below.

In tables 13 to 19, the geometrical parameters are shown, the operational conditions and the results obtained from the spline connections for the shaft's sprockets, was done using the calculation module of the CAD/CAE program, the spline connection was designed under the ISO 4156 norm and the designation of the selected spline connection is ISO 4156-30 deg, Flat root, Side fit—INT/EXT 14z×10.00 m×30.0 P×5H/5 h.

TABLE 13
Design parameters for the shaft's spline connection of the chain
conveyor system.

| | | | |
|---|---|---|---|
| Power | P | 118.986 | kW |
| Speed | n | 26.000 | rpm |
| Torque | T | 43701.420 | N m |

TABLE 14
Required dimensions of the shaft of chain conveyor system

| | |
|---|---|
| Spline Designation | ISO 4156-30 deg, Flat root, |
| | Side fit-INT/EXT 14z × |
| | 10.00m × 30.0P × 5H/5h |

| | | |
|---|---|---|
| Hollow Shaft Inner | dₕ | 0.000 mm |
| Diameter | | |
| Outside Diameter of | Dₒᵢ | 250.000 mm |
| Spline Sleeve | | |
| Length | l | 263.000 mm |

TABLE 15
Results of the chain conveyor system's shaft's spline connection
Internal Spline ISO 4156

| Designation | INT 14z × m10.00 × | | |
|---|---|---|---|
| | 30.0P × 5H | | |
| Number of Teeth | z | 14.000 | ul |
| Module | m | 10.000 | mm |
| Pressure Angle | α | 30.00 | deg |
| Pitch Diameter | D | 140.000 | mm |
| Base Diameter | D_{b} | 121.244 | mm |
| Max Major Diameter, Internal | Dₑᵢₘₐₓ | 155.488 | mm |
| Min Form Diameter, Internal | D_{Fimin} | 152.000 | mm |
| Max Minor Diameter, Internal | Dᵢᵢₘₐₓ | 132.077 | mm |

Hub Space Width

| | | | |
|---|---|---|---|
| Max Actual Circular Space Width | Eₘₐₓ | 15.821 | mm |
| Max Effective Circular Space Width | Eᵥₘₐₓ | 15.774 | mm |
| Min Actual Circular Space Width | Eₘᵢₙ | 15.755 | mm |
| Min Effective Circular Space Width | Eᵥₘᵢₙ | 15.708 | mm |
| Max Measurement over Two Balls or Pins, | M_{Rimax} | 166.322 | mm |
| Internal | | | |
| Min Measurement over Two Balls or Pins, | M_{Rimin} | 166.223 | mm |
| Internal | | | |
| Diameter of Ball or Pin for Internal Spline | D_{Ri} | 18.000 | mm |
| Fillet Radius of the Basic Rack, Internal | ρ_{fi} | 2.000 | mm |

TABLE 16
Results of the spline connection of the sprocket
External Spline ISO 4156

| Designation | EXT 14z × m10.00 × | | |
|---|---|---|---|
| | 30.0P × 5h | | |
| Number of Teeth | z | 14.000 | ul |
| Module | m | 10.000 | mm |
| Pressure Angle | α | 30.00 | deg |
| Pitch Diameter | D | 140.000 | mm |
| Base Diameter | D_{b} | 121.244 | mm |
| Max Major Diameter, External | Dₑₑₘₐₓ | 150.000 | mm |
| Max Form Diameter, External | D_{Femax} | 129.677 | mm |
| MM Minor Diameter, External | Dᵢₑₘᵢₙ | 124.512 | mm |

Shaft Tooth Thickness

| | | | |
|---|---|---|---|
| Max Effective Tooth Width | S_{Vmax} | 15.708 | mm |
| Max Actual Tooth Width | Sₘₐₓ | 15.661 | mm |
| Min Effective Tooth Width | S_{Vmin} | 15.642 | mm |
| Min Actual Tooth width | Sₘᵢₙ | 15.595 | mm |
| Max Measurement over Two Balls or Pins, | M_{Remax} | 171.489 | mm |
| External | | | |
| Min Measurement over Two Balls or Pins, | M_{Remin} | 171.394 | mm |
| External | | | |
| Diameter of Ball or Pin for External Spline | D_{Re} | 20.000 | mm |
| Fillet Radius of the Basic Rack, External | ρ_{fe} | 2.000 | mm |

TABLE 17
Joint properties

| | | |
|---|---|---|
| Desired Safety | Sᵥ | 1.000 ul |

| | |
|---|---|
| Joint Type | Fixed |
| Working Conditions | Medium |
| Tooth Side | Unhardened |

| | | |
|---|---|---|
| Factor of Tooth Side Contact | Kₛ | 0.500 ul |

TABLE 18
Material
Shaft Material

| | |
|---|---|
| Material | Stainless steel |

| | | |
|---|---|---|
| Allowable Compressive Stress | S_{c} | 246.000 Mpa |
| Allowable Shear Stress | Sₛ | 344.000 Mpa |

Hub Material

| | |
|---|---|
| Material | Stainless steel |

| | | |
|---|---|---|
| Allowable Compressive Stress | S_{c} | 246.000 Mpa |
| Allowable Shear Stress | Sₛ | 344.000 Mpa |
| Allowable Tensile Stress | Sₜ | 246.000 Mpa |

TABLE 19
Results

| | |
|---|---|
| Strength Check | Positive |

| | | | |
|---|---|---|---|
| Min. Shaft Diameter | dₘᵢₙ | 86.491 | mm |
| Min. Spline Length | lₘᵢₙ | 50.584 | mm |

Deformation of Grooving Sides

| | | | |
|---|---|---|---|
| Calculated Pressure | p_{c} | 37.890 | MPa |
| Safety | S | 6.493 | ul |

Bending Stress on Sides of Spline Teeth

| | | | |
|---|---|---|---|
| Calculated Bending Stress | σ_{cAIB} | 47.314 | MPa |
| Safety | S | 5.199 | ul |

Design of the Shaft's Bearings for the Chain Conveyor System

For the design of the bearings a radial load of 164155.23 N was used, which is equivalent to the weight of the sprockets, buckets, elements of the chain and the force produced by the weight of the spheres being elevated, a 10% of this was considered for an axial load equal to 16415.523 N, besides this a rotation velocity of 26 rpm, shaft diameter of 100 mm, and a minimum safety factor was considered.

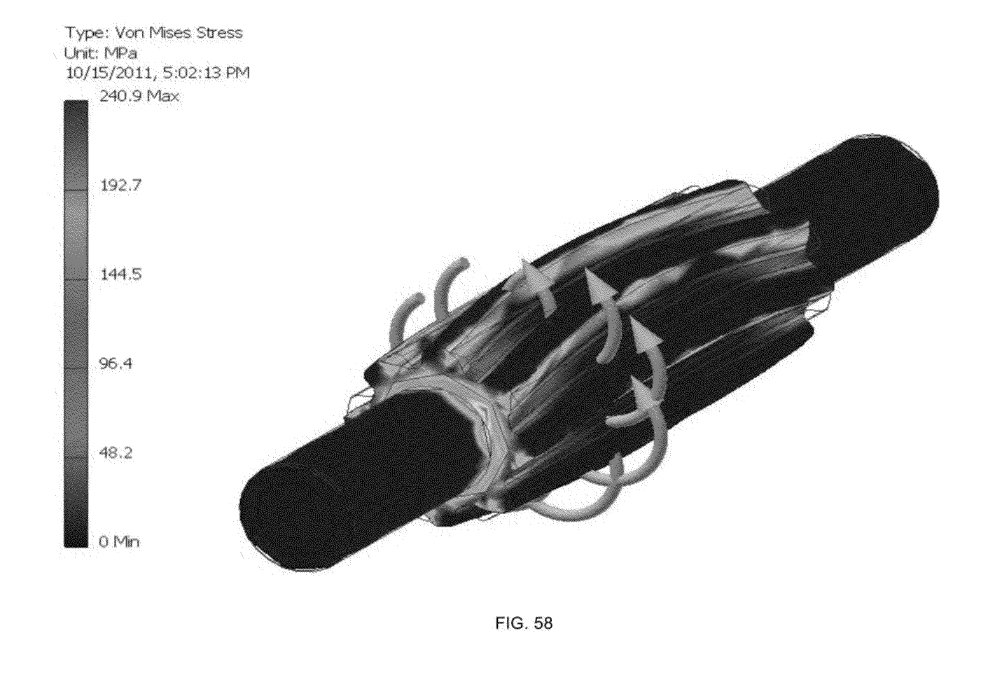

The results for the calculation of the bearings were based on the ANSI/AFBMA 9-1990 (ISO 281-1990) method, and were done in a calculation module of the CAD/CAE program, shown in tables 20 to 23 and FIG. 58.

TABLE 20
Specifications of the bearing

| Designation | | BS 292: Part 1 (V) | |
|---|---|---|---|
| | | (Metric) (N 320- | |
| | | 100 × 215 × 47) | |
| Bearing inside diameter | d | 100.000 | mm |
| Bearing outside diameter | D | 215.000 | mm |
| Bearing width | B | 47.000 | mm |
| Nominal contact angle of the | α | 0 | deg |
| bearing | | | |
| Basic dynamic load rating | C | 391000N | |
| Basic static load rating | C₀ | 440000N | |
| Dynamic radial load Factor | X | 0.60 ul/0.60 ul | |
| Dynamic axial load Factor | Y | 0.50 ul/0.50 ul | |
| Limit value of F a/Fr | e | 0.40 | ul |
| Static radial load Factor | X₀ | 0.60 | ul |
| Static axial load Factor | Y₀ | 0.50 | ul |

TABLE 21
Calculation of the bearing's life

| Calculation Method | | ANSI/AFBMA | |
|---|---|---|---|
| | | 9-1990 (ISO | |
| | | 281-1990) | |
| Required rating life | L_{req} | 8760 | hr |
| Required reliability | R_{req} | 90 | ul |
| Life adjustment factor for special | a₂ | 1.00 | ul |
| bearing properties | | | |
| Life adjustment factor for | a₃ | 1.00 | ul |
| operating conditions | | | |
| Working temperature | T | 35° | C. |
| Factor of Additional Forces | f_{d} | 1.00 | ul |

TABLE 22
Type of the bearing's lubrication

| | | |
|---|---|---|
| Friction factor | μ | 0.0011 ul |
| Lubrication | | Oil |

TABLE 23
Calculation results for the shaft bearing system transport chain

| | | | |
|---|---|---|---|
| Basic rating life | L₁₀ | 11569 | hr |
| Adjusted rating life | Lₙₐ | 11569 | hr |
| Calculated static safety factor | s_{0c} | 2.68039 | ul |
| Power lost by friction | P_{z} | 24.58212 | W |
| Necessary minimum load | Fₘᵢₙ | 8800N | |
| Static equivalent load | P₀ | 164155N | |
| Dynamic equivalent load | P | 164155N | |
| Over-revolving factor | kₙ | 0.000 | ul |
| Life adjustment factor for reliability | a₁ | 1.00 | ul |
| Temperature factor | fₜ | 1.00 | ul |
| Equivalent speed | nₑ | 26 | rpm |
| Minimum speed | nₘᵢₙ | 26 | rpm |
| Maximum speed | nₘₐₓ | 26 | rpm |

| | |
|---|---|
| Strength Check | Positive |

Selection of the Electric Motor for the Lift System:

For the selection of the electric motor the power required to move the chain conveyor system equal to 86 hp, will be considered, an angular velocity of 26 rpm will also be considered. See calculation table's number3 [P/E (Kw) and EP (Hp)].

Lift System Spheres Per Second Volume Calculation.

$${\dot{V}}_{lift} = \frac{{N}_{buckets \text{/} rev} * {Vol}_{efect . bucket \text{-} elev} * {rpm}_{sprocket}}{60}$$

$${\dot{V}}_{lift} = \frac{9 buckets * 0.013 {m}^{3} \text{/} bucket * 26 rev \text{/} min}{60}$$

$${\dot{V}}_{lift} = 0.0507 {m}^{3} \text{/} s$$

### Volume of Spheres Runs in the Rotor Per Second Calculation

$${\dot{V}}_{rotor} = \frac{{N}_{buckets} * {Vol}_{bucket} * {rpm}_{rotor}}{60}$$

$${\dot{V}}_{rotor} = \frac{756 bucket * 0.00032 {m}^{3} \text{/} bucket * 48.60 rev \text{/} min}{60}$$

$${\dot{V}}_{rotor} = 0.1959 {m}^{3} \text{/} s$$

### Number of Required Lift Systems Calculation

$${N}_{lift . system} = \frac{{\dot{V}}_{rotor}}{{\dot{V}}_{lift}}$$

$${N}_{lift . system} = \frac{0.1959 {m}^{3} \text{/} s}{0.0507 {m}^{3} \text{/} s}$$

$${N}_{lift . system} = 3.86 \approx 4 lift systems$$

With the calculations shown above it was determined that the number of lift systems required for the 1.7 MW system equals to 4, counting on a motor reductor of 118.98 KW (86 hp) to 26 rpm each.

Calculation of the Efficiency of the 1.7 MW System

$$Supplied power = generated power - utilized power$$

$$Utilized power = motor power * {N}_{lift . system}$$

$$Utilized power = 118.98 KW * 4$$

$$Utilized power = 462.10 KW$$

$$Supplied power = 1702.08 KW - 462.10 KW$$

$$Supplied power = 1239.97 KW$$

$${η}_{sist} = \frac{Supplied power}{Generated power} * 100 \%$$

$${η}_{sist} = \frac{1239.97 KW}{1702.08 KW} * 100 \%$$

$${η}_{sist} = 72.85 \%$$

While the preferred embodiments of the invention have been described above, it will be recognized and understood that various modifications can be made in the invention and the appended claims are intended to cover all such modifications which may fall within the spirit and scope of the invention

1. APPARATUS FOR GENERATING ELECTRICITY, comprising three interrelated systems: a supply system, a power generating system, and a feedback system; the supply system comprises a container arranged at a high elevated position into which a solid particulate material is stored, the power generating system comprises a rotor located at ground level; a downpipe duct puts in fluid communication the interior of said silo with the interior of said power generating system; to the outer surface of said rotor a set of buckets are affixed; to said rotor a generator responsible for generating the electricity of the system is coupled; the feedback system comprises a chain conveyor assembly in fluid communication with the power generating system.

2. The apparatus of claim 1, wherein the container is a silo.

3. The apparatus of claim 1, wherein the rotor is placed at the downstream end of the downpipe duct for the buckets to receive the material falling from the downpipe duct.

4. The apparatus of claim 1, wherein the solid particulate material is one of the following: metal spheres, stones, glass spheres.

5. The apparatus of claim 2, wherein the silo is a cylindrical metal container including an internal spiral shaped platform.

6. The apparatus of claim 1, wherein at the outlet of said container a guillotine valve is included capable of regulating the container's flow of material to the downpipe duct and the inlet flow of material to the power generating system.

7. The apparatus of claim 1, wherein said downpipe duct includes a guillotine valve capable of regulating the flow of particulate material to the power generating system.

8. The apparatus of claim 1, wherein said rotor comprises a core with a central mounting and a peripheral surface; to said central mounting a shaft is mounted which in turn is mounted to an external casing.

9. The apparatus of claim 8, wherein on said peripheral surface of the rotor a set of radial buckets are affixed.

10. The apparatus of claim 9, wherein each bucket comprises a spoon-shaped receptacle with an attaching base, attached to the outer surface of the core by rivets.

11. The apparatus of claim 1, wherein the chain conveyor assembly includes a supporting frame with an upper end and a lower end; and respective sprockets each rotatable mounted to said upper end and a lower end; to said sprockets a chain in mounted, and to which a set of buckets are installed capable of receiving the material from the power generating system and lifting it back to the storage container of the supply system.

12. The apparatus of claim 11, wherein the chain is a mono-track chain.

13. The apparatus of claim 11, wherein the chain is a multi-track chain.

14. The apparatus of claim 12, wherein to the external links of said chain extensions are affixed and onto which the buckets are attached.

15. The apparatus of claim 14, wherein each extension is a flat metal piece that projects perpendicularly to the direction of the chain.

16. The apparatus of claim 15, wherein on the flat surface of the extension orifices are included.

17. The apparatus of claim 14, wherein the base portion of each bucket includes orifices to attached the bucket to the orifices of the extensions of the chain using rivets.

18. A METHOD FOR GENERATING ELECTRICITY, comprising the steps of:
a mass “M” of solid particulate material that is placed into a container at an elevated place separated at a distance “H” from ground level so that the potential energy of this material equals to M*H*g (gravity);
a free fall of this particulate material until it tangentially impacts the radial buckets of a rotor installed at ground level so as to transform the potential energy into kinetic energy equal to ½*M V2: V being the final velocity of the particulate material when it impacts the buckets;
the kinetic energy of said impact makes the rotor rotate and drives a generator coupled thereto;
the particulate material is collected and returned to the container by a feedback system.
